(19) United States
(12) Patent Application Publication
(10) Pub. No.: US 2024/0117786 A1
(43) Pub. Date: Apr. 11, 2024

(54) FLUID FLOW DRIVEN ELECTRICAL POWER GENERATING TENSION TURBINE SYSTEM

(71) Applicant: Alfred FINNELL, Loxahatchee, FL (US)

(72) Inventor: Alfred FINNELL, Loxahatchee, FL (US)

(21) Appl. No.: 18/376,816

(22) Filed: Oct. 4, 2023

Related U.S. Application Data
(60) Provisional application No. 63/414,647, filed on Oct. 10, 2022.

(51) Int. Cl. F03D 1/06; F03D 9/25; F03D 15/00

(52) U.S. Cl. CPC F03D 1/0687; F03D 9/25; F03D 15/205; F05B 2220/706; F05B 2260/402

(57) ABSTRACT

A fluid flow powered system for generating electrical power including a rotating turbine blade assembly comprising an outer rim, a tension airfoil central hub assembly, tension elements extending between the outer rim and the tension airfoil central hub assembly, and a plurality of turbine blades secured to the tension elements. A rim engagement wheel is rotationally driven by the outer rim. Rotation of the wheel drives an electric power generator. The turbine blade assembly can be rotationally driven by at least one of wind and water. The wheel, independently or in conjunction with additional wheels can provide at least one of axial support and radial support to the turbine blade assembly during operation.

### RELATED APPLICATIONS

This Non-Provisional Application claims the benefit of the following:
A) United States Provisional Patent Application Ser. No. 63/414,647, filed on Oct. 10, 2022,
wherein the entire contents are incorporated by reference herein in its entirety.

### FIELD OF THE INVENTION

The present disclosure generally relates to an apparatus and method for converting wind or water flow to electrical energy. More particularly, the present disclosure relates to a turbine wheel having a plurality of blades disposed about an internal edge of a peripheral rim.

### BACKGROUND OF THE INVENTION

Windmills and other wind driven turbines generally comprise a series of blades projecting radially from a centrally located hub. This configuration provides several limitations. A first limitation is efficiency. The energy utilized to turn an object is referred to as torque. The torque is calculated at a force times a distance from the center of rotation. The force applied near the center of rotation has a significantly lower impact than a force applied towards the outer edge of the blades, although resistance is created along the entire length of the blade. A second limitation is the potential injury or death to birds. Turbines of common windmills have a plurality of cantilevered blades, which are spatially configured, allowing birds to fly between the swirling turbines. The birds are unable to see the narrow, cantilevered blades when the blade assembly is rotating. This poses a risk whereby one of the blades could collide with the passing bird.

A first known blade discloses a rotor blade, which includes a main blade and an extension nap, which is translationally moveable relative to the main blade. The main blade and transition blade at least form an airfoil lifting surface of the entire blade. The dimension of the airfoil lifting surface is variable by translationally moving the extension flap relative to the main blade.

A second known reference discloses self starting vertical-axis wind turbine, for economically competitive power production by driving large grid-corrected AC generators. The wind turbine includes a variable blade pitch-angle from 0 to 60 degrees, wherein the blades following variable wind speed for maximum efficiency and to keep constant turbine speed; a variable blade camber to optimize lift-to-drag ratio, controlled by pitch and cyclical variation of incidence-angle; improved airfoil shape of cambered blades; low cost automatic gear-train for two constant turbine speeds; protection against overload and prevention of power surge during wind gusts; low stress three-legged high tower assembled with nacelle and tail structure on ground level. This enables a tower to be built to any height required to harness maximum wind energy.

Yet another known embodiment discloses a wind or water flow energy converter that includes a wind or water flow actuated rotor assembly. The rotor includes a plurality of blades; the blades of are variable in length to provide a variable diameter rotor. The rotor diameter is controlled to fully extend the rotor at low flow velocity and to retract the rotor, as flow velocity increases such that the loads delivered by or exerted upon the rotor do not exceed set limits.

While another known embodiment discloses a rotation shaft which is installed in the center of a wind turbine. Blades are secured to the rotation shaft to be circumferentially spaced apart one from another. Each blade has a lattice composed of transverse lattice elements and longitudinal lattice elements which are plaited to cooperatively define a plurality of spaces. In each space, a rotation adjustment piece is coupled to a first portion of a lattice element to be capable of rotating between a closing position where it closes a predetermined number of the spaces and an opening position where it opens a predetermined number of the spaces, so that the blades as a whole can be rotated irrespective of a wind direction. Electricity is generated using wind applied to the rotation shaft through rotation adjustment pieces.

And another known embodiment discloses a multi-axis turbine with an external upper covering, a tower structure with a plurality of vertical elongated members connected to each other with supporting horizontal elongated members, and a plurality of smaller blades on a rotation connected to a tower structure with a plurality of the rotation. One embodiment includes impact impellers connected to a rotation creating a swept area with a height to diameter ratio of greater than four. In one embodiment the impact impellers are connected to a rotation means thereby creating a swept area with a height to diameter ratio of greater than ten.

While another embodiment discloses a power plant which extracts energy from a free flowing fluid by means of a transverse mounted generator with its rotor extending downward into the flow. Runner blades with hinges attain the greatest surface area when the flow is tangent to and in the same direction as the rotor rotation. The hinges fold the runner blades to minimize the surface area proportional to drag when the blades oppose the flow. The generator with feedback control charges batteries, produces hydrogen fuel by electrolysis of water, or further couples to a DC motor coupled to an AC generator. Other features optionally perform such tasks as adaptively locating the generator in the maximum velocity flow, controlling and communicating the state of charge of the battery, or gauging and controlling the electrolysis process and communicating the fullness of the hydrogen gas output tanks.

Yet another embodiment discloses a design of a wind turbine blade and a wind turbine by which the power, loads and/or stability of a wind turbine may be controlled by typically fast variation of the geometry of the blades using active geometry control (e.g. smart materials or by embedded mechanical actuators), or using passive geometry control (e.g. changes arising from loading and/or deformation of the blade) or by a combination of the two methods. A method of controlling the wind turbine is also disclosed.

While another embodiment discloses a wind turbine system, which incorporates a variable blade assembly including adjustable sails and wing shaped masts expanding the wind velocity capture envelope. The blade assembly turns a hydraulic pump, which pressurizes fluid and stores the pressurized fluid in a chamber in the support tower. Pressurized fluid is directed via an electronically controllable proportioning valve to a hydraulic motor, which is coupled to an electric generator. A computer control module operates the proportioning valve regulating pressure to the hydraulic motor, maintaining generator rotational speed, and providing consistent output frequency to the power grid. Stored energy in the high pressure tank is used to continue generator operation after the winds cease, allowing early warning notification to the power management system of impending power loss. Residual pressure maintained in the high pressure tank allows restart operations via hydraulic pressure rather than power grid energy drain. On site high energy capacitors store additional energy.

And another embodiment discloses a wind turbine capable of varying active annular plane area by composing such that blades are attached to a cylindrical rotor movable in the radial direction of the rotor, the blades being reciprocated in the radial direction by means of a blade shifting mechanism connected to the root of each blade, or the blade itself is divided so that the outer one of the divided blade is movable in the radial direction. With this construction, the: wind turbine can be operated with a maximum output within the range of evading fatigue failure of the blades and rotor by adjusting the active annular plane area in accordance with wind speed.

Common windmills comprise a plurality (generally three) of masts or blades extending from a central hub. The design of the blades must be structurally sound to accommodate the applied forces. This requirement dictates a heavier construction to the masts or blades. The heavy construction increases the inertial force, which reduces the rotational speed of the turbine assembly. The mass of material increases the cost of fabrication, transport, and the like to the site. Alternately, exotic materials and structural designs can be used to reduce the weight, while increasing cost and complexity of fabrication.

Wind studies show that as the velocity of the wind doubles, the power of the wind or water is cubed. Thus, if a turbine at 12 MPH wind generates 10 watts of power, at 24 MPH it will produce 1,000 watts of power.

A turbine will increase speed as the velocity of the air or water is sped up. The power of a generator is also increased as the rotational speed is increased. The power of the generator is not necessarily the same power curve of the turbine driving the generator. Therefore, losses can be expected because of the power mismatch between turbine and generator.

The described device monitors the rpm of a generator either directly or indirectly and provides a value, which corresponds to the rpm of the turbine. This in turn, is used to determining the amount of load (power) to be generated.

The angle difference of turbine blade and wind is known as the Angle Of Attack (AOA). Experiments have determined that the optimum AOA is approximately 28° in a “climb angle” for the turbine blade. The closer the AOA can be to the 28°, the more power that can be generated. Two methods can be used to keep this angle of attack (AOA) constant. One is to pivot the blades to make the proper angle. This would keep the RPM of the turbine rather constant. The changing of the blade angle is used on large turbines. The other method to have the AOA stable is to change the rpm of the turbine.

The currently utilized cantilevered blade wind turbines are limited in size. The cantilevered blade design limits the diameter of the turbine blade assembly. As the length of each cantilevered blades increases, the stress and strain of each blade increases exponentially. The diameter of the turbine blade assembly affects the rotational tip speed. The greater the diameter of the turbine blade assembly, the faster the tip speed for the same rotational rate. Alternatively, the greater the diameter of the turbine blade assembly, the slower the rotational speed when maintaining a constant tip speed. What is desired is a turbine blade design that reduces stress and strain upon each blade, while enabling a turbine blade assembling having a larger diameter.

Therefore, a wind driven turbine wheel with improved efficiency and a focus on bird safety is needed. The larger blade surface area provides a visual deterrent for birds, thus eliminating any danger to birds.

Rotational rates of the wind turbine blade assembly can affect the efficiency of the electrical power generating system. What is desired is a system that optimizes the efficiency of the electrical power generating system.

### SUMMARY OF THE INVENTION

The present disclosure is generally directed to a wind driven turbine, and more specifically to a turbine blade having a peripheral rim assembled to a central hub via a plurality of spokes. A series of airfoil blades are disposed along an interior edge of the peripheral rim, being rotationally attached to the plurality of spokes. The blades leave an airflow breach between an interior edge of the blade and the central hub.

On any circle, thirty percent (30%) of a circle on the outer portion of the circle will have fifty percent (50%) of the volume of the circle. On a propeller, the outer thirty percent (30%) has the fastest moving part of the propeller. Thus, by combining the area and the velocity of the propeller, the outer thirty percent (30%) of the circle will provide most of the possible lift made. If the outer fifty percent (50%) of the propeller blade can be made larger than most propellers, additional lift provided can be substantial.

The problem is that as a lever is made longer, the shear forces become too large for the propeller to bear.

The tension turbine assembly provides answers to all of the above as follows:
1. Multiple turbine blades are placed only on the outer portion of the tension turbine assembly.
2. The outer portion of the circle provides the velocity to provide the maximum lift or generating a maximum torsional force.
3. No change is necessary on optimum shape of the turbine blades, so existing wing shape technology can be used.
4. A bicycle wheel is the lightest, strongest, most efficient rotating device known. The tension turbine assembly uses this embodiment of proven engineering to make a more efficient, lighter, more powerful rotating turbine assembly.

In some embodiments, the wind turbine apparatus may include:
a peripheral rim having a rim radius defined from a rim center to an interior edge of the rim;
a central hub having a hub radius defined from a hub center to an exterior edge of the hub;
a radial span dimension being defined as rim radius minus the hub radius;
a plurality of spokes assembling the central hub to a rotationally centralized position within the peripheral rim; and
a series of blades having a radial length being significantly less than the radial span dimension;
wherein the each of the blades is assembled to the wind turbine apparatus positioning the blades within the peripheral ring and proximate the interior edge of the rim, leaving an airflow gap between an interior edge of the blades and the exterior edge of the hub.

In a second aspect, a leading edge of the blade is rotationally assembled to a spoke.

In another aspect, a trailing edge is assembled to the spoke via an adjusting mechanism.

In yet another aspect, the adjusting mechanism is operationally controlled via a feature within the respective spoke.

In yet another aspect, the adjusting mechanism is operationally controlled via a feature within the respective spoke by rotating the spoke or a member within the spoke.

In yet another aspect the plurality of spokes is configured having two adjacent spokes overlapping.

In yet further aspect, the adjusting mechanism is operationally controlled via a tension member, which is provided through a hollow portion of the spoke and controlled via a winding mechanism located proximate or within the central hub.

In yet another aspect, the trailing edge is assembled to a spoke via a breakaway mechanism.

In yet another aspect, the breakaway mechanism further comprises a means for automatically restoring the trailing edge to an operable configuration.

In yet aspect, breakaway mechanism is integrated with the adjusting mechanism.

In yet another aspect, the turbine wheel engages with an electrical power generator, with the assembly being positioned upon a vertical riser support.

In yet another aspect, the turbine wheel engages with an electrical power generator, wherein the electrical power generator is rotationally coupled to the turbine blade assembly by engagement between the outer rim of the turbine blade assembly and a rotating power transfer member arranged to rotationally drive the electrical power generator.

In yet another aspect, the turbine wheel engages with an electrical power generator, wherein the electrical power generator is rotationally coupled to the turbine blade assembly by engagement between an annular ring assembled to the turbine blade assembly and the rotating power transfer member arranged to rotationally drive the electrical power generator.
wherein the electrical power generator is rotationally coupled to the turbine blade assembly by engagement between an annular ring assembled to the turbine blade assembly and the rotating power transfer member arranged to rotationally drive the electrical power generator, wherein the annular ring is assembled to the outer ring of the turbine blade assembly.

In yet another aspect, the turbine wheel engages with an electrical power generator, wherein the rotating power transfer member of the electrical power generator is oriented to rotate about an axis that is substantially parallel with a rotational axis of the turbine blade assembly.

In yet another aspect, the turbine wheel engages with an electrical power generator, wherein the rotating power transfer member of the electrical power generator is oriented to rotate about an axis that is substantially perpendicular with a rotational axis of the turbine blade assembly.

In yet another aspect, the rotating power transfer member is a wheel.

In yet another aspect, the rotating power transfer member includes a tire.

In yet another aspect, the rotating power transfer member includes a previously used tire.

In yet another aspect, the rotating power transfer member includes a recycled tire.

In yet another aspect, a power transfer subassembly includes a first power transfer wheel and a second power transfer wheel, wherein the first power transfer wheel is arranged to drive the electric power generator and the second power transfer wheel is arranged to provide a compression force to ensure adequate engagement between the first power transfer wheel and the turbine blade assembly.

In yet another aspect, a power transfer subassembly includes a first power transfer wheel and a second power transfer wheel, wherein the first power transfer wheel is arranged to drive the electric power generator and the second power transfer wheel is arranged to provide a compression force to ensure adequate engagement between the first power transfer wheel and the turbine blade assembly, wherein the first power transfer wheel and the second power transfer wheel are located to contact opposite sides of the drive element of the turbine blade assembly.

In yet another aspect, a power transfer subassembly includes a first power transfer wheel and a second power transfer wheel, wherein the first power transfer wheel is arranged to drive the electric power generator and the second power transfer wheel is arranged to provide a compression force to ensure adequate engagement between the first power transfer wheel and the turbine blade assembly, wherein the first power transfer wheel and the second power transfer wheel are located to contact opposite sides of the drive element of the turbine blade assembly, wherein the drive element of the turbine blade assembly is an annular ring.

In yet another aspect, the power transfer subassembly includes the first power transfer wheel and the second power transfer wheel, wherein the first power transfer wheel and the second power transfer wheel are arranged in radial alignment with one another.

In yet another aspect, the power transfer subassembly includes the first power transfer wheel and the second power transfer wheel, wherein the first power transfer wheel and the second power transfer wheel are arranged being radially offset from one another.

In yet another aspect, the power transfer subassembly includes the first power transfer wheel and at least one second power transfer wheel, wherein the first power transfer wheel and each of the at least one second power transfer wheel are arranged being radially offset from one another.

In yet another aspect, the power transfer subassembly further comprising a tension adjusting mechanism, wherein the tension adjusting mechanism adjusts the compression between the first power transfer wheel and the second power transfer wheel.

In yet another aspect, the power transfer subassembly further comprising a tension adjusting mechanism, wherein the tension adjusting mechanism is a rotational member.

In yet another aspect, the power transfer subassembly further comprising a tension adjusting mechanism, wherein the tension adjusting mechanism includes a frame comprising a plurality of movable members.

In yet another aspect, the power transfer subassembly further comprising a tension adjusting mechanism, wherein the tension adjusting mechanism includes a frame comprising a plurality of pivotally movable members.

In yet another aspect, the power transfer subassembly further comprising a tension adjusting mechanism, wherein the tension adjusting mechanism includes a tension spring.

In yet another aspect, the power transfer subassembly further comprising a tension adjusting mechanism, wherein the tension adjusting mechanism includes a compression spring.

In yet another aspect, the wind operated electrical power generating system includes at least one power transfer subassembly and at least one turbine blade subassembly stabilization subassembly.

In yet another aspect, the wind operated electrical power generating system includes a plurality of power transfer subassemblies.

In yet another aspect, the wind operated electrical power generating system includes a plurality of turbine blade subassembly stabilization subassemblies.

In yet another aspect, a power transfer subassembly includes a first power transfer wheel arranged to rotate about a second rotational axis and a second power transfer wheel arranged to rotate about a second rotational axis, the first rotational axis and the second rotational axis are substantially perpendicular to one another.

In yet another aspect, aerodynamics of the turbine blade can be adjusted by an introduction of a lift adjusting airflow bypass passageway.

In yet another aspect, aerodynamics of the turbine blade can be adjusted by an introduction of a lift adjusting airflow bypass passageway and a lift adjusting airflow bypass passageway restriction control panel.

In yet another aspect, aerodynamics of the turbine blade can be adjusted by an introduction of a lift adjusting airflow bypass passageway and a lift adjusting airflow bypass passageway restriction control panel, wherein the lift adjusting airflow bypass passageway restriction control panel adjusts an amount of airflow flowing through an opening of the lift adjusting airflow bypass passageway.

In yet another aspect, aerodynamics of the turbine blade can be adjusted by an introduction of a lift adjusting airflow bypass passageway and a lift adjusting airflow bypass passageway restriction control panel, wherein the lift adjusting airflow bypass passageway restriction control panel moves along a track carried by the turbine blade to adjust the amount of airflow flowing through the opening of the lift adjusting airflow bypass passageway.

In yet another aspect, aerodynamics of the turbine blade can be adjusted by an introduction of a lift adjusting airflow bypass passageway and a lift adjusting airflow bypass passageway restriction control panel, wherein the lift adjusting airflow bypass passageway restriction control panel moves along a track carried along a lower surface of the turbine blade to adjust the amount of airflow flowing through the opening of the lift adjusting airflow bypass passageway.

In yet another aspect, aerodynamics of the turbine blade can be adjusted by an introduction of a lift adjusting airflow bypass passageway and a lift adjusting airflow bypass passageway restriction control panel, wherein the lift adjusting airflow bypass passageway restriction control panel moves along a track carried within the turbine blade proximate the lower surface of the turbine blade to adjust the amount of airflow flowing through the opening of the lift adjusting airflow bypass passageway.

In yet another aspect, the deployed turbine wheel can include a counterbalance assembly.

In yet another aspect, the deployed assembly can additionally include a rotational means, rotating about a vertical axis to reduce the frontal area respective to the airflow.

In yet another aspect, the turbine wheel comprises a plurality of masts extending radially from an axle, each mast comprising a blade. The masts are supported via a planar tension cable spanning between distal ends of adjacent masts and a radial tension cable spanning between the distal end of each mast and each of the two ends of the axle.

In yet another aspect, the blades can be replaceable with one's having different shapes, sizes, surface areas, and aerodynamic characteristics.

In another embodiment, the wind turbine apparatus may include:
a rotating turbine blade assembly comprising an outer rim, a tension airfoil central hub assembly, tension elements extending between the outer rim and the tension airfoil central hub assembly, and a plurality of turbine blades secured to the tension elements;
a rotating turbine blade assembly support structure, the rotating turbine blade assembly arranged to rotationally support the rotating turbine blade assembly enabling rotation of the rotating turbine blade assembly;
an electric power generator; and
an electric generator turbine rim engagement wheel,
wherein the rotating turbine blade assembly is arranged to be rotationally driven by at least one of wind and water during operation,
wherein the electric generator turbine rim engagement wheel is arranged to be rotationally driven by the outer rim of the rotating turbine blade assembly during operation,
wherein the electric generator turbine rim engagement wheel is arranged to rotationally drive the electric power generator during operation.

In yet another aspect, the electric generator turbine rim engagement wheel is arranged to provide support to the rotating turbine blade assembly in at least one of an axial direction and a radial direction.

In yet another aspect, the electric generator turbine rim engagement wheel is located to engage with a first position on an outer rim assembly of the rotating turbine blade assembly, the fluid flow power system further comprising a second rim engagement wheel located to engage with a second position on the outer rim assembly of the rotating turbine blade assembly, the outer rim assembly including the outer rim.

In yet another aspect, the fluid flow power system further comprising a wheel compression adjusting system designed to adjust a compression applied to the outer rim assembly by each of the electric generator turbine rim engagement wheel and the second rim engagement wheel.

In yet another aspect, the electric generator turbine rim engagement wheel is oriented to rotate about an axis that is parallel to a rotational axis of the rotating turbine blade assembly.

In yet another aspect, the electric generator turbine rim engagement wheel is oriented to rotate about an axis that is non-parallel to a rotational axis of the rotating turbine blade assembly.

In yet another aspect, the electric generator turbine rim engagement wheel and the second rim engagement wheel are arranged to maintain at least one of axial stability and radial stability of the rotating turbine blade assembly.

In another embodiment, the wind turbine apparatus may include:
a rotating turbine blade assembly comprising an outer rim, a tension airfoil central hub assembly, tension elements extending between the outer rim and the tension airfoil central hub assembly, and a plurality of turbine blades secured to the tension elements;
a power transfer annular ring carried by the outer rim;
an electric generator turbine rim engagement wheel arranged to drive an electric power generator, wherein the electric generator turbine rim engagement wheel engages with the power transfer annular ring,
wherein the rotating turbine blade assembly rotates about a first axis,
wherein the electric generator turbine rim engagement wheel rotates about a second axis,
wherein the first axis and the second axis are non-parallel to one another.

In yet another aspect, the first axis and the second axis are substantially perpendicular to one another.

In another embodiment, the wind turbine apparatus may include:
a rotating turbine blade assembly comprising an outer rim, a tension airfoil central hub assembly, tension elements extending between the outer rim and the tension airfoil central hub assembly, and a plurality of turbine blades secured to the tension elements;
a power transfer annular ring carried by the outer rim;
an electric generator turbine rim engagement wheel arranged to drive an electric power generator, wherein the electric generator turbine rim engagement wheel engages with the power transfer annular ring,
a turbine rim compression applying wheel engaging with the power transfer annular ring,
wherein the electric generator turbine rim engagement wheel and the turbine rim compression applying wheel are located to contact generally opposite sides of the power transfer annular ring.

In another embodiment, the wind turbine apparatus may include:
a vertical riser support extending upward from a supporting surface;
a turbine housing carried by the vertical riser support;
a wind driven turbine blade subassembly in operational communication with a turbine shaft;
a hydraulic pump carried by the turbine housing and in operational communication with the turbine shaft;
a hydraulic motor comprising a hydraulic motor drive shaft, wherein the hydraulic motor is distally located from the turbine housing and in hydraulic communication with the hydraulic pump through hydraulic lines; and
an electrical power generator comprising a generator drive shaft in rotational communication with the hydraulic motor drive shaft,
wherein rotation of the wind driven turbine blade subassembly rotationally drives the hydraulic pump,
wherein the hydraulic pump flows hydraulic fluid through the hydraulic lines to the hydraulic motor,
wherein the hydraulic fluid flowing through the hydraulic lines drives rotation of the hydraulic motor;
wherein the hydraulic motor drives rotation of the electric power generator, which outputs electric power.

In yet another aspect, the electrical output of the electric power generator is governed by an electric power output controller module.

In yet another aspect, the electric power output controller module varies a resistance of a current flow.

In yet another aspect, the electric power output controller module varies a resistance of a current flow, optimizing power generation efficiency and power output.

In yet another aspect, the electric power output controller module identifies a rotational speed of the hydraulic motor drive shaft and varies a resistance of a current flow based upon a predetermined rotational speed of the hydraulic motor drive shaft.

In yet another aspect, the electric power output controller module identifies a rotational speed of the generator drive shaft and varies a resistance of a current flow based upon a predetermined rotational speed of the generator drive shaft.

In another arrangement, the wind operated electrical power generating system may include:
a wind turbine comprising a turbine blade assembly attached to a turbine blade subassembly shaft, the turbine blade subassembly shaft being rotationally carried by a turbine housing, the turbine housing being supported by a vertical riser support structure;
   a generator in one of direct and indirect operational communication with the turbine blade subassembly shaft, wherein rotation of the turbine blade subassembly shaft provides power to rotate an input shaft of the generator;
   a rotational speed sensor arranged to sense a rotational speed of one of the turbine blade subassembly shaft and the generator shaft;
   an electrical controller circuit in signal communication with the rotational speed sensor, wherein the electrical controller circuit identifies when a rotational speed determined by a signal from the rotational speed sensor is proximate a predetermined speed; and
   a potentiometer (variable resistor), wherein the electric potentiometer (variable resistor) increases a load upon the generator.

In yet another aspect, the system further comprises a power control module, wherein the power control module contains the electrical controller circuit and the potentiometer (variable resistor), wherein the potentiometer (variable resistor) is a manually adjusted potentiometer (variable resistor).

In yet another aspect, the electrical controller circuit further comprising at least one speed indicator, wherein each of the at least one speed indicator alerts a user when the electrical controller circuit identifies when a rotational speed determined by a signal from the rotational speed sensor is proximate a predetermined speed associated with each of the at least one speed indicator.

In yet another aspect, the electrical controller circuit further comprises a plurality of speed indicators, wherein one of the plurality of speed indicators alerts a user when the electrical controller circuit identifies when a rotational speed determined by a signal from the rotational speed sensor is proximate a predetermined speed associated with the one of the plurality of speed indicators.

In yet another aspect, the electrical controller circuit further comprises:
a power control module, wherein the power control module contains:
the electrical controller circuit, which further includes a plurality of speed indicators, wherein one of the plurality of speed indicators alerts a user when the electrical controller circuit identifies when a rotational speed determined by a signal from the rotational speed sensor is proximate a predetermined speed associated with the one of the plurality of speed indicators; and
a plurality of the potentiometers (variable resistors), wherein each of the plurality of potentiometers (variable resistors) is associated with a respective speed indicator of the plurality of speed indicators.

In yet another aspect, the electrical controller circuit further comprises a transformer integrated in electric communication between the potentiometer (variable resistor) and a grid tie.

In yet another aspect, the system can include a rotational speed control module.

In yet another aspect, the rotational speed control module can include a computing device.

In yet another aspect, the rotational speed control module can include a computing device, the computing device comprising a microprocessor, digital memory in signal communication with the microprocessor, and a digital data storage device in signal communication with the microprocessor.

In yet another aspect, the rotational speed control module can include a computing device, the computing device further comprising a user interface in signal communication with the microprocessor.

In yet another aspect, the user interface of the rotational speed control module can include a keyboard.

In yet another aspect, the user interface of the rotational speed control module can include a keyboard, wherein the keyboard is at least one of a wired keyboard, a wireless keyboard, a virtual keyboard, a laser operated keyboard, a programmed keyboard integral with a touch screen display, or any other suitable keyboard.

In yet another aspect, the user interface of the rotational speed control module can include a pointer device.

In yet another aspect, the user interface of the rotational speed control module can include a pointer device, wherein the pointer device is one of a mouse, a trackball, a tablet device, a track pad, and the like.

In yet another aspect, the user interface of the rotational speed control module can include a monitor.

In yet another aspect, the user interface of the rotational speed control module can include a monitor, wherein the monitor is a flat panel display, a projection display, a touch screen display, or any other suitable display monitor.

In yet another aspect, the rotational speed control module can include a computing device, the computing device further comprising a communication and/or network circuit in signal communication with the microprocessor.

In yet another aspect, the communication and/or network circuit of the rotational speed control module can employ at least one of: a wired communication link and a wireless communication link.

In yet another aspect, the communication and/or network circuit of the rotational speed control module can include a computing device, can employ at least one of: Transmission Control Protocol Internet Protocol (TCPIP), hyper text transfer protocol (HTTP), User Datagram Protocol (UDP) Internet Relay Chat (IRC), Simple Network Management Protocol (SNMP), Internet Control Message Protocol (ICMP) and any other suitable network protocol.

In yet another aspect, the communication and/or network circuit of the rotational speed control module can include a computing device, can employ Ethernet protocol, Wi-Fi protocol, Bluetooth protocol, a serial communication protocol (such as USB-A, USB-B, USB-C and the like), a parallel communication protocol, or any other communication protocol.

In yet another aspect, a sensor system is installed in an arrangement to acquire at least one of a wind speed, a wind direction, a rotational speed (RPM) of the turbine blade assembly, a direction of the turbine blade assembly, and a power output.

In yet another aspect, a sensor system can additionally be arranged to acquire an operating temperature of the alternator/generator and/or an ambient air temperature.

In yet another aspect, a sensor system can additionally be arranged to acquire a relative humidity.

In yet another aspect, the sensor system includes a communication and/or network circuit.

In yet another aspect, the communication and/or network circuit of the sensor system employs a protocol that is compatible with the protocol of the rotational speed control module enabling communication between the sensor system and the rotational speed control module.

In a system for generating electrical power, the method comprising steps of:
rotating a turbine blade assembly of a wind turbine, wherein the rotation of the turbine blade assembly is driven by one of wind or water;
generating electrical power by rotating an electrical power generating machine, wherein the rotation of the electrical power generating machine is driven by a rotation of the turbine blade assembly;
determining a rotational rate of the turbine blade assembly that would encounter stall based upon a wind velocity subjected to the turbine blade assembly, wherein stall is a minimum rotational rate to maintain lift when subjected to the current wind velocity;
calculating a load rate that would maintain the rotational rate of the turbine blade assembly slightly faster than a rotational rate that would cause the turbine blade assembly to stall at one of the currently known wind velocity or an anticipated wind velocity, where the rotational rate slightly faster than the rotational rate that would cause the turbine blade assembly to stall accommodates a predetermined fluctuation in the wind velocity used to determine the stall;
changing a state of at least one relay to apply a load to an electrical power circuit, wherein the electrical power circuit is in electrical communication with the electrical power generating machine, wherein the applied load creates a resistance to the electrical power generating machine, thus reducing the rotational rate of the turbine blade assembly.

In a second aspect, the process of calculating the load rate that would maintain the rotational rate of the turbine blade assembly slightly faster than the rotational rate that would cause the turbine blade assembly to stall would be accomplished using historical data.

In another aspect, the process of calculating the load rate that would maintain the rotational rate of the turbine blade assembly slightly faster than the rotational rate that would cause the turbine blade assembly to stall would be accomplished using engineering calculations.

In yet another aspect, the process of calculating the load rate that would maintain the rotational rate of the turbine blade assembly slightly faster than the rotational rate that would cause the turbine blade assembly to stall would be accomplished using artificial intelligence.

In yet another aspect, the process of calculating the load rate that would maintain the rotational rate of the turbine blade assembly slightly faster than the rotational rate that would cause the turbine blade assembly to stall would be accomplished using a combination of at least two of historical data, engineering calculations, and artificial intelligence.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a predetermined percent fluctuation in the wind velocity used to determine the stall.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a minimum of a 1% fluctuation in the wind velocity used to determine the stall.

In another aspect, the rotational rate of the turbine blade assembly is slightly faster than a rotational rate that would cause the turbine blade assembly to stall at one of the currently known wind velocity or an anticipated wind velocity is where the rotational rate accommodates a minimum of a 2% fluctuation in the wind velocity used to determine the stall.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a minimum of a 2.5% fluctuation in the wind velocity used to determine the stall.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a minimum of a 5% fluctuation in the wind velocity used to determine the stall.

In another aspect, the rotational rate of the turbine blade assembly is slightly faster than a rotational rate that would cause the turbine blade assembly to stall at one of the currently known wind velocity or an anticipated wind velocity is where the rotational rate accommodates a minimum of a 7.5% fluctuation in the wind velocity used to determine the stall.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a minimum of a 10% fluctuation in the wind velocity used to determine the stall.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a fluctuation in the wind velocity over a predetermined period of time.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a fluctuation in the wind velocity over a predetermined period of time, wherein the period of time is a predetermined multiple the period of time between load calculations.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a fluctuation in the wind velocity over a predetermined period of time, wherein the period of time is one (1) times a period of time between load calculations.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a fluctuation in the wind velocity over a predetermined period of time, wherein the period of time is two (2) times the period of time between load calculations.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a fluctuation in the wind velocity over a predetermined period of time, wherein the period of time is three (3) times the period of time between load calculations.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates a fluctuation in the wind velocity over a predetermined period of time, wherein the period of time is five (5) times the period of time between load calculations.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates any predetermined number of standard deviations of the fluctuation in the wind velocity.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates one standard deviation of the fluctuation in the wind velocity.

In yet another aspect, the rotational rate of the turbine blade assembly is slightly faster than a rotational rate that would cause the turbine blade assembly to stall at one of the currently known wind velocity or an anticipated wind velocity is where the rotational rate accommodates two standard deviations of the fluctuation in the wind velocity.

In yet another aspect, the time between load calculations can be increased when the wind velocity is determined to be relatively stable.

In yet another aspect, the time between load calculations can be increased when the wind velocity is determined to remain within a predetermined percentage of fluctuation over the current time between load calculations.

In yet another aspect, the time between load calculations can be increased when the wind velocity is determined to have a velocity fluctuation that is equal to or less than 1% over the current time between load calculations.

In yet another aspect, the time between load calculations can be increased when the wind velocity is determined to have a velocity fluctuation that is equal to or less than 2% over the current time between load calculations.

In yet another aspect, the time between load calculations can be increased when the wind velocity is determined to have a velocity fluctuation that is equal to or less than 2.5% over the current time between load calculations.

In yet another aspect, the time between load calculations can be increased when the wind velocity is determined to have a velocity fluctuation that is equal to or less than 5% over the current time between load calculations.

In yet another aspect, the time between load calculations would be decreased when the wind velocity is determined to be relatively unstable.

In yet another aspect, the time between load calculations would be decreased when the wind velocity is determined to fluctuate beyond a predetermined percentage of fluctuation over the current time between load calculations.

In yet another aspect, the time between load calculations would be decreased when the wind velocity is determined to have a velocity fluctuation that is equal to or greater than 1% over the current time between load calculations.

In yet another aspect, the time between load calculations would be decreased when the wind velocity is determined to have a velocity fluctuation that is equal to or greater than 2% over the current time between load calculations.

In yet another aspect, the time between load calculations would be decreased when the wind velocity is determined to have a velocity fluctuation that is equal to or greater than 2.5% over the current time between load calculations.

In yet another aspect, the time between load calculations would be decreased when the wind velocity is determined to have a velocity fluctuation that is equal to or greater than 5% over the current time between load calculations.

In yet another aspect, the system can utilize a transmission, where the system can change a gear ratio between the turbine blade assembly and the electrical power generating machine, thus changing the loading and rotational speed of the turbine blade assembly.

In yet another aspect, the tension turbine blade assembly comprising:
a peripheral rim having a rim radius defined from a rim center to an interior edge of the rim;
a central hub having a hub radius defined from a hub center to an exterior edge of the hub;
a radial span dimension being defined as rim radius minus the hub radius;
a plurality of spokes assembling the central hub to a rotationally centralized position within the peripheral rim; and
a series of turbine blades, each turbine blade having an aerodynamically lifting shape extending between a leading edge and a trailing edge,
wherein the each turbine blade of the series of turbine blades is assembled to the tension turbine blade assembly by coupling an area of the turbine blade proximate the leading edge to a leading edge spoke and an area of the turbine blade proximate the trailing edge to a trailing edge spoke,
wherein the turbine blades are arranged having a gap provided between the turbine blade trailing edge of each forward located turbine blade and the turbine blade leading edge of each trailing located turbine blade.

In yet another aspect, the leading edge spoke and the trailing edge spoke are substantially parallel to one another.

In yet another aspect, turbine blade is twisted along a transverse axis, wherein the transverse axis extends between a distal or outer edge of the turbine blade and a proximal or hub edge of the turbine blade.

In yet another aspect, each spoke can cross other spokes defining three crossover locations.

In yet another aspect, the spokes can be formed having at least one of: a circular cross section shape, an aerodynamic cross section shape, or any other suitable cross section shape.

In yet another aspect, the spokes can be arranged alternating between extending from an outer surface of each hub flange and from an inner surface of the same hub flange.

In yet another aspect, a first end of each spoke is assembled to a respective central hub flange and a second end of each spoke is assembled to an outer rim. A first spoke of the plurality of spokes is assembled to the respective central hub flange in an arrangement extending in an acute angular direction from a radial orientation in a first direction from a first side of the respective central hub flange and a second spoke of the plurality of spokes is assembled to the respective central hub flange in an arrangement extending in an acute angular direction from a radial orientation in a second direction from a second side of the respective central hub flange. One spoke of the plurality of spokes attached to the respective central hub flange crosses at least one other spoke of the plurality of spokes attached to the same respective central hub flange. Each airfoil of the series of airfoils is assembled to the tension airfoil assembly by coupling an area of the airfoil proximate the leading edge to a leading edge spoke of the plurality of spokes and an area of the airfoil proximate the trailing edge to a trailing edge spoke of the plurality of spokes.

In yet another aspect, one spoke of the plurality of spokes attached to the respective central hub flange can cross at least two another spokes of the plurality of spokes attached to the same respective central hub flange.

In yet another aspect, each leading edge spoke and each respective trailing edge spoke can be substantially parallel with one another.

In yet another aspect, the tension turbine blade assembly can include a total of 36 spokes, 18 spokes per hub flange.

In yet another aspect, each spoke would preferably be assembled to the tension turbine blade assembly having substantially equal tension.

In yet another aspect, the tension turbine blade assembly can include any number of spokes in multiples of four (4).

In yet another aspect, the tension turbine blade assembly can include thirty-six (36) spokes, wherein thirty-six (36) spokes is considered an optimal number of spokes. This is generally preferred for turbine blade assemblies that are less than 30 feet in diameter. It would be preferable to have more spokes for turbine blade assemblies that are larger than 30 feet in diameter.

In yet another aspect, tension can be applied to and retained within each spoke by a tension application system.

In yet another aspect, any suitable tensioning system or combination of tensioning systems can be employed.

In yet another aspect, one tension application system employs a spoke distal assembly tensioning nipple securing a threaded distal or rim end of the spoke to the rim.

In yet another aspect, a second tension application system employs a spoke proximal or hub assembly tensioning nipple securing a threaded proximal or hub end of the spoke to the hub. In one implementation, the proximal end of the spoke would be inserted through a hole or bore formed through a bracket or other axially extending feature. A threaded tensioning element would be threadably secured to the threaded proximal end of the spoke. The threaded tensioning element would be adjusted to increase or decrease the tension of the respective spoke.

In yet another aspect, a third tension application system employs a threaded coupling element securing a first centrally threaded section of a first segment of the spoke to a second centrally threaded section of a second segment of the spoke. The threaded segments would include threading in opposite directions. More specifically, the first centrally threaded section would including threading formed in a first rotational direction and the second centrally threaded section would including threading formed in a second, opposite rotational direction. The threaded coupling element would be formed having mating threading to each of the first centrally threaded section and the second centrally threaded section.

In yet another aspect, the spoke hub attachment holes can be even spaced about the hub flange. Alternatively, the spoke hub attachment holes can be arranged in pairs, wherein the pairs are arranged having a first spacing and each adjacent pair is arranged having a second spacing about the hub flange, wherein the first spacing and the second spacing differ from one another.

In yet another aspect, the series of spoke hub attachment holes of the turbine blade subassembly first central hub flange and the series of spoke hub attachment holes of the tension turbine blade assembly second central hub flange are offset from one another.

In yet another aspect, the thickness or axial height of the tension turbine blade assembly outer rim is determined by maximizing the desired strength of the tension turbine blade assembly outer rim, while providing sufficient area to support a connection of each spoke.

In yet another aspect, the tension turbine blade assembly outer rim is provided in a shape of an annular ring.

In yet another aspect, the tension turbine blade assembly outer rim is provided in a shape of an annular ring, the annular ring fabricated as a single element.

In yet another aspect, the tension turbine blade assembly outer rim is provided in a shape of an annular ring, the annular ring comprising a plurality of segments, wherein the segments are assembled to one another.

In yet another aspect, the tension turbine blade assembly outer rim is provided in a shape of an annular ring, the annular ring comprising a plurality of segments, wherein the segments are assembled to one another by an assembly interface.

In yet another aspect, the tension turbine blade assembly outer rim is provided in a shape of an annular ring, the annular ring comprising a plurality of segments, wherein the segments are assembled to one another by an assembly interface, the assembly interface comprising at least one bore formed in an end of each segment and an assembly insert which is inserted into each bore.

In yet another aspect, the tension turbine blade assembly outer rim is provided in a shape of an annular ring, the annular ring comprising a plurality of segments, wherein each segment comprises an inner ring including a respective bore, an outer ring including a respective bore, and a central flange extending between the inner ring and the outer ring.

In yet another aspect, the attachment locations of each spoke along an interior surface of the tension turbine blade assembly outer rim are linear with one another. Alternatively, the attachment locations of each spoke along an interior surface of the tension turbine blade assembly outer rim are located in an alternating configuration.

In yet another aspect, the tension turbine blade assembly central hub assembly is preferably substantially centered axially respective to the tension turbine blade assembly outer rim. Alternatively, the tension turbine blade assembly central hub assembly can be offset axially respective to the tension turbine blade assembly outer rim.

In yet another aspect, the angle of attack can be established by the arrangement of the, the height or span of the tension turbine blade assembly central hub assembly, or the like, or any combination thereof.

In yet another aspect, an optional feature of the tension wheel assembly is a spoke breakaway feature. The spoke breakaway feature is preferably integrated at a location along the spoke proximate the rim.

In yet another aspect, the spoke can include one or more spoke breakaway features.

In another aspect, the spoke breakaway feature retains the spoke in an assembled configuration when the spoke is subjected to a tensile force (tension).

In yet another aspect, the spoke breakaway feature releases or decouples the spoke from the assembly when the tension is removed from the spoke.

In yet another aspect, the spoke breakaway feature includes a nipple flange or spoke flange formed or provided at a breakaway end of the spoke.

In yet another aspect, the spoke breakaway feature includes a tension generating feature.

In yet another aspect, the tension generating feature is provided in a form of a nipple assembly.

In yet another aspect, the spoke breakaway feature includes a nipple assembly comprising a nipple body and a nipple flange.

In yet another aspect, the nipple body includes a threaded section (male or female threading).

In yet another aspect, the nipple body includes a threaded section (male or female threading), wherein the threading of the threaded section is sized to mate with a mating threading (female or male threading) formed on the associated end of the spoke.

In yet another aspect, the nipple body includes a threaded interior bore.

In yet another aspect, the nipple body includes a threaded interior bore, wherein the threading of the threaded interior bore is sized to mate with a mating threading formed on the associated end of the spoke.

In yet another aspect, the spoke breakaway feature includes a stud assembly comprising a stud trunk and a stud flange.

In yet another aspect, the stud trunk is mechanically coupled to the rim.

In yet another aspect, the stud trunk is mechanically affixed to the rim.

In yet another aspect, the stud trunk is mechanically coupled to the hub.

In yet another aspect, the stud trunk is mechanically affixed to the hub.

In yet another aspect, the stud trunk is mechanically coupled to at least one of the rim and the hub.

In yet another aspect, the stud trunk is mechanically affixed to at least one of the rim and the hub.

In yet another aspect, the spoke breakaway feature includes a coupling element that bridges a nipple flange and a stud flange into a single assembly while tension is applied to the spoke.

In yet another aspect, the coupling element comprises at least two separate elements.

In yet another aspect, the coupling element comprises at least two separate elements hingeably assembled with one another.

In yet another aspect, the spoke breakaway feature includes an embossed surface mating with a debossed surface to retain mechanical communication between the coupling element and the nipple flange.

In yet another aspect, the spoke breakaway feature includes an embossed surface mating with a debossed surface to retain mechanical communication between the coupling element and the stud flange.

In yet another aspect, each surface of the coupling assembly applying a compression force is formed having an embossed surface.

In yet another aspect, each surface of the coupling assembly receiving the compression force is formed having a debossed surface.

In yet another aspect, the embossed surface is convex.

In yet another aspect, the debossed surface is concave.

These and other aspects, features, and advantages of the present invention will become more readily apparent from the attached drawings and the detailed description of the preferred embodiments, which follow.

### BRIEF DESCRIPTION OF THE DRAWINGS

The invention will now be described, by way of example, with reference to the accompanying drawings, where like numerals denote like elements and in which:

FIG. 1 presents a front view of an exemplary embodiment of a turbine wheel illustrating the general components of the present invention;

FIG. 2 presents a sectional side view of the turbine wheel taken along section line 2--2 of FIG. 1;

FIG. 3 presents a sectional end view of a turbine blade taken along section line 3--3 of FIG. 1 introducing an effect of wind flow on the blade;

FIG. 4 presents a sectional end view of a series of turbine blades introducing an incident angle controlling mechanism;

FIG. 5 presents a sectional end view of a turbine blade introducing an exemplary breakaway mechanism;

FIG. 6 presents a sectional end view of a turbine blade illustrating the operation of the breakaway mechanism of FIG. 5;

FIG. 7 presents a front view of a first exemplary turbine blade shape;

FIG. 8 presents a front view of a second exemplary turbine blade shape;

FIG. 9 presents a front view of a third exemplary turbine blade shape;

FIG. 10 presents an elevation side view of a turbine wheel integrated into a wind power harnessing structure;

FIG. 11 presents an elevation front view of the wind power harnessing structure of FIG. 10;

FIG. 12 presents a partial top view of the wind power harnessing structure of FIG. 10, configured perpendicular to an airflow;

FIG. 13 presents a front view of the turbine wheel configured perpendicular to the airflow;

FIG. 14 presents a partial top view of the wind power harnessing structure of FIG. 10, rotated away from being perpendicular to the airflow;

FIG. 15 presents a front view of the turbine wheel, rotated away from being perpendicular to the airflow;

FIG. 16 presents a front view of a second exemplary embodiment of a turbine wheel assembling adjacent spokes in an overlapping configuration;

FIG. 17 presents an isometric view of an exemplary tension turbine blade assembly;

FIG. 18 presents a front view of the exemplary tension turbine blade assembly originally introduced in FIG. 17;

FIG. 19 presents a front isometric exploded assembly view of an exemplary outer ring of the exemplary tension turbine blade assembly initially introduced in FIG. 17, the illustration being an exploded assembly view of a joint between segments of the exemplary outer ring identified by circle 19 of FIG. 17;

FIG. 20 presents a cross section view of the exemplary tension turbine blade assembly originally introduced in FIG. 17, the section being taken along section line 20--20 of FIG. 18;

FIG. 21 presents a cross section view of an enhanced exemplary tension turbine blade assembly introducing several optional tension adjusting configurations;

FIG. 22 presents a cross section view of an enhanced exemplary tension turbine blade assembly introducing a spoke breakaway feature, wherein the spoke breakaway feature is shown in an assembled state, retained by tension within the spoke;

FIG. 23 presents a cross section view of the enhanced exemplary tension turbine blade assembly previously illustrated in FIG. 22, wherein the spoke breakaway feature is shown in a partially separated state, initiated by a broken spoke;

FIG. 24 presents a partially sectioned view of an exemplary wind operated electrical power generating system employing a peripheral edge of an outer rim of the exemplary turbine wheel to drive a generator;

FIG. 25 presents a front elevation view of a second exemplary wind operated electrical power generating system employing a peripheral edge of an outer rim of the exemplary turbine wheel to drive a generator;

FIG. 26 presents a partially sectioned elevation view of the second exemplary wind operated electrical power generating system employing a peripheral edge of the outer rim of the exemplary turbine wheel to drive the generator, the second exemplary wind operated electrical power generating system originally being introduced in FIG. 25;

FIG. 27 presents a front elevation view of a first variant of the second exemplary wind operated electrical power generating system originally introduced in FIG. 25;

FIG. 28 presents a front elevation view of a second variant of the second exemplary wind operated electrical power generating system originally introduced in FIG. 25;

FIG. 29 presents a front elevation view of a third variant of the second exemplary wind operated electrical power generating system originally introduced in FIG. 25;

FIG. 30 presents a partially sectioned elevation view of a third exemplary wind operated electrical power generating system employing a horizontally oriented wheel engaging with the peripheral edge of the outer rim of the exemplary turbine wheel to drive the generator;

FIG. 31 presents a partially sectioned elevation view of a first variant of the third exemplary wind operated electrical power generating system employing a horizontally oriented wheel engaging with the peripheral edge of the outer rim of the exemplary turbine wheel to drive the generator, the third exemplary wind operated electrical power generating system originally being introduced in FIG. 30;

FIG. 32 presents a sectioned elevation view of an exemplary lift adjusting turbine blade, wherein the amount of lift provided by the turbine blade is adjusted by positioning of a lift adjusting panel that increases or reduces airflow through a lift adjusting airflow passageway, the illustration presenting the lift adjusting panel in a closed position;

FIG. 33 presents a sectioned elevation view of the exemplary lift adjusting turbine blade originally introduced in FIG. 32, the illustration presenting the lift adjusting panel in a partially opened position;

FIG. 34 presents a sectioned elevation view of the exemplary lift adjusting turbine blade originally introduced in FIG. 32, the illustration presenting the lift adjusting panel in a substantially opened position;

FIG. 35 presents a sectioned elevation view of the exemplary lift adjusting turbine blade originally introduced in FIG. 32, the illustration presenting the lift adjusting panel in a fully opened position;

FIG. 36 presents a partially sectioned view of an exemplary wind operated electrical power generating system employing a hydraulic power transfer system and a power optimizing controller;

FIG. 37 presents an enlarged view of the power optimizing controller introduced in FIG. 36;

FIG. 38 presents an exemplary schematic diagram illustrating operational interactions between various components of the exemplary wind operated electrical power generating system introduced in FIG. 36;

FIG. 39 presents an exemplary power output chart illustrating a power output to rotational speed relationship;

FIG. 40 presents an exemplary power output chart illustrating benefits of the power optimizing controller introduced in FIG. 36;

FIG. 41 presents a partially sectioned view of an exemplary wind operated electrical power generating system employing a power optimizing controller;

FIG. 42 presents a chart illustrating effects of applying a load to a wind turbine to optimize efficiency during varying wind speeds for use with the power optimizing controller introduced in FIG. 41;

FIG. 43 presents a flow diagram presenting an exemplary wind turbine optimization process;

FIG. 44 presents a partially sectioned isometric view of an exemplary power optimizing controller that operates based upon the chart illustrated in FIG. 41; and

FIG. 45 presents a transparent isometric view of an exemplary load applying arrangement that operates in conjunction with the power optimizing controller that operates based upon the chart illustrated in FIG. 41.

Like reference numerals refer to like parts throughout the several views of the drawings.

### DETAILED DESCRIPTION OF THE PREFERRED EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description.

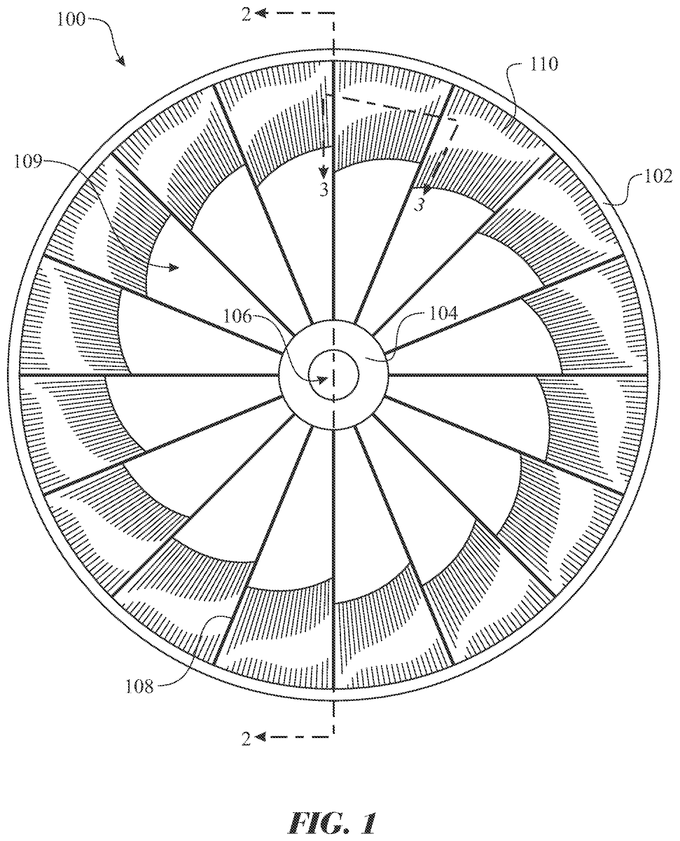

For purposes of description herein, the terms “upper”, “lower”, “left”, “rear”, “right”, “front”, “vertical”, “horizontal”, and derivatives thereof shall relate to the invention as oriented in FIG. 1, where applicable. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present disclosure is generally directed to a turbine wheel 100 and the integration of the turbine wheel 100 onto a turbine deployment assembly 200. The turbine wheel 100 and the respective application are detailed hereinafter.

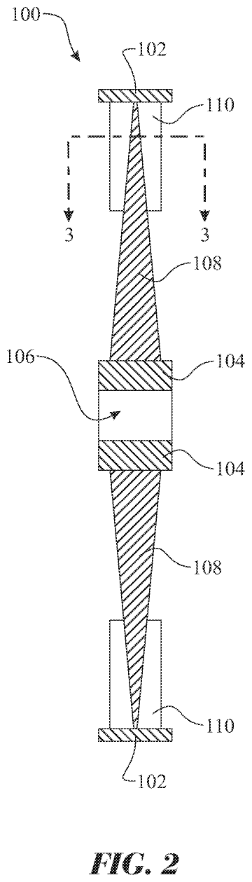

Referring initially to FIGS. 1 through 3 of the drawings, an illustrative embodiment of a turbine wheel, hereinafter apparatus is generally indicated by reference numeral 100 in FIG. 1. The turbine wheel assembly 100 includes a turbine central hub 104 being centrally assembled to a turbine outer rim 102 via a plurality of turbine spokes 108. The turbine central hub 104 includes an axle bearing 106, which is centrally assembled, allowing the turbine central hub 104 to rotate about an axle that would be assembled to the axle bearing 106. The axle and axle bearing 106 can be of any known rotational interface capable of supporting the forces exerted by the wind and respective motion of the turbine wheel assembly 100 about the axle. The turbine spokes 108 are preferably assembled having a tensile force. The distributed tensile force ensures the turbine outer rim 102 remains in the circular shape, while reinforcing the assembly.

A series of turbine blades 110 are provided, having a blade leading edge 112 and a blade trailing edge 114. The distance between the blade leading edge 112 and the blade trailing edge 114 is preferably equal to or greater than a span between two adjacent spokes 108. This shape allows for the blade leading edge 112 to be assembled to a respective lead turbine spoke 108 and the blade trailing edge 114 to be assembled to the respective trailing turbine spoke 108. It would be preferable that the blade leading edge 112 be pivotally assembled to a blade leading edge pivot 120, wherein the blade leading edge pivot 120 can be utilized as the lead turbine spoke 108. The blade leading edge pivot 120 can include a hollow centerline, allowing the turbine spoke 108 to be inserted therethrough. A plurality of anti-slip interface 122 can be included ensuring the blade leading edge pivot 120 rotates in conjunction with the turbine blades 110, or excluded allowing the blade leading edge pivot 120 to rotate independently respective to the turbine blades 110.

The turbine blades 110 has a length parallel to the turbine spoke 108 that is significantly shorter than the distance between the exterior of the turbine central hub 104 and the interior of the turbine outer rim 102. This provides an airflow interior region 109 within an interior of the turbine outer rim 102 allowing airflow 198 to pass through the turbine wheel assembly 100. This configuration provides a centroid of the effective force closer to the turbine outer rim 102, thus increasing the generated torque, reduces the rotational resistance, thus increasing the efficiency.

The trailing edge can include an incident angle control mechanism, including an incident angle controller 130, an angle control cleat 132 and an angle control tether 134. In the exemplary embodiment, the turbine blade 110 pivots about the blade leading edge pivot 120 and is retained at an incident angle via the angle control tether 134. The angle control tether 134 is a cabling, which is released or retracted via an incident angle controller 130. The incident angle controller 130 can either rotate to adjust a released length of the angle control tether 134, or the angle control tether 134 can be routed through the incident angle controller 130 and released or retracted via a remotely located winding mechanism (not shown, but well understood as a motor, gearing and spool). The angle control tether 134 is secured to the turbine blades 110 via an angle control cleat 132 located proximate the blade trailing edge 114 of the turbine blades 110.

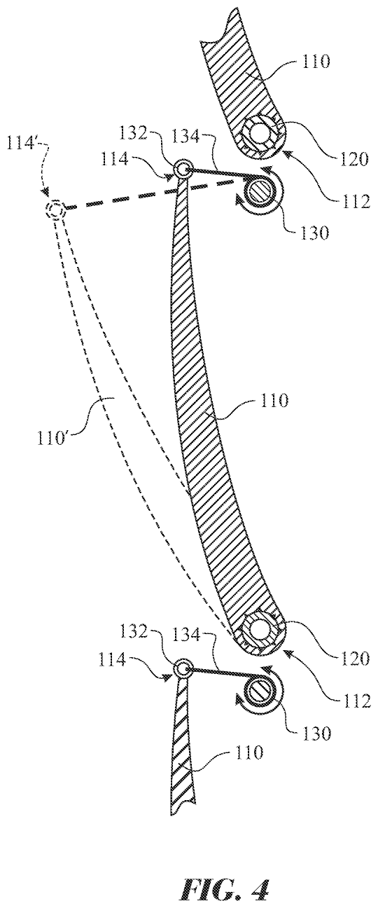

As the incident angle controller 130 releases the angle control tether 134, a wind flow 198 applies a force to the facing side of the turbine blades 110 allowing the turbine blades 110 to rotate into position turbine blades 110′ and repositioning the blade trailing edge 114 to position blade trailing edge 114′ as shown in FIG. 4. The illustration presents an embodiment where the incident angle controller 130 is solid and rotates to release or retract the angle control tether 134 to adjust the released length. The angle of incident changes the resultant rotational speed of the turbine blades 110, as referenced as a resultant blade motion 199. The turbine blades 110 are positioned having the blade leading edge 112 overlapping the blade trailing edge 114, with the blade leading edge 112 being arranged on the wind receiving side of the turbine blades 110.

It is understood that other incident angle control mechanisms can be used, including a cam and respective control arm, and the like.

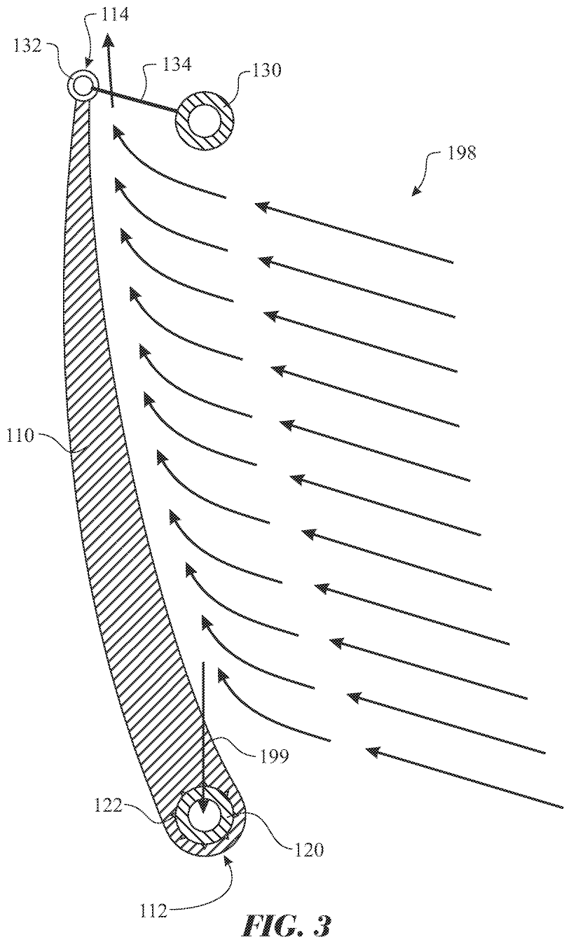

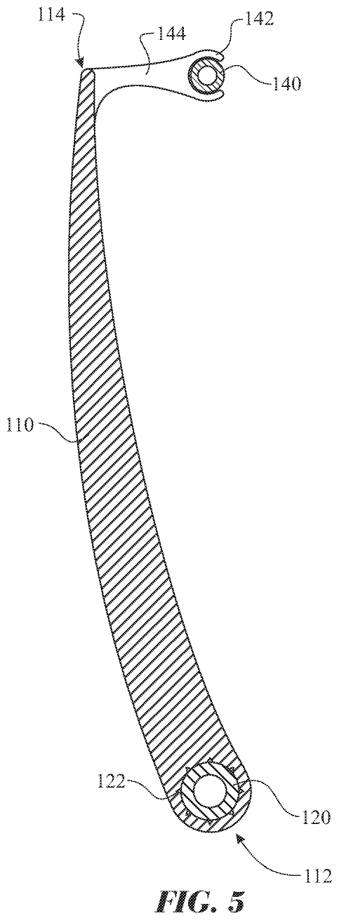

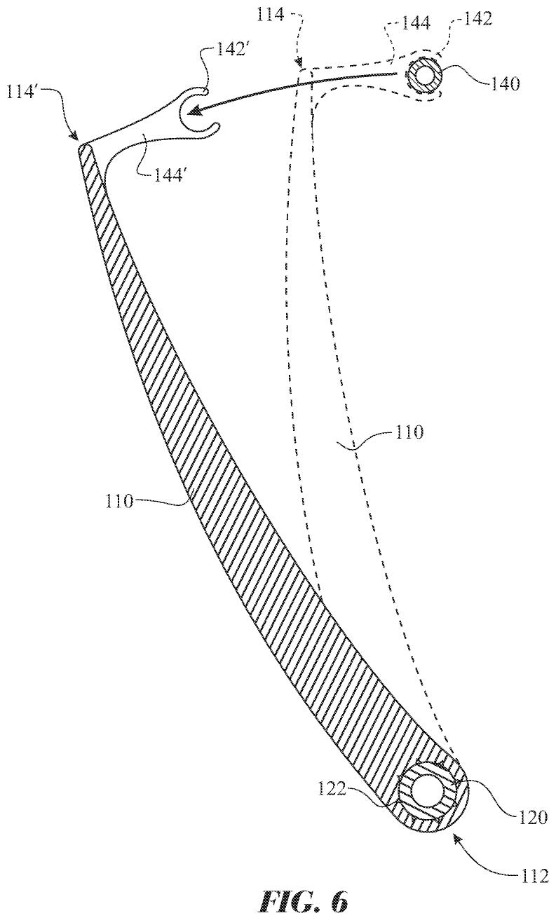

A breakaway mechanism can be incorporated to compensate when the turbine wheel assembly 100 encounters any unexpected excessive wind forces 198. One exemplary embodiment is presented in FIGS. 5 and 6. The breakaway mechanism detachably engages a breakaway clip 142 with a breakaway anchor 140. The breakaway clip 142 is secured to the blade trailing edge 114 via a breakaway frame 144. The breakaway clip 142 would detach from the breakaway anchor 140 when subjected to a predetermined force. An alternate configuration would utilize the incident angle mechanism of FIGS. 3 and 4. The incident angle controller 130 would include a ratcheting mechanism, which releases or free spools the angle control tether 134 when subjected to a predetermined force. It is understood that other configurations known by those skilled in the art can be integrated with the turbine wheel assembly 100, providing a breakaway mechanism.

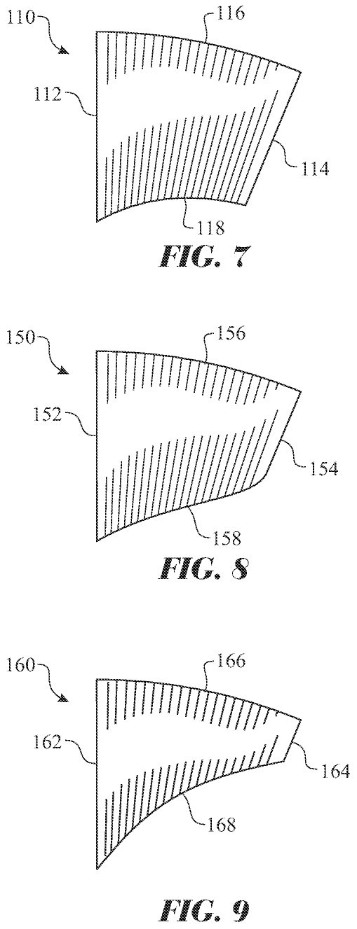

The turbine blades can be configured in a variety of shapes, as illustrated in FIGS. 7 through 9. A planar view of the turbine blades 110 is presented in FIG. 7, having an airfoil cross sectional shape bounded by a blade leading edge 112, a blade trailing edge 114, a posterior edge 116 and an interior edge 118. The turbine blades can be configured of a variety of cross sectional and peripheral shapes. The configuration defines the total surface area. The surface area, cross sectional shapes and peripheral shape all affect the efficiency of the turbine blades 110. The interior edge 118 provides an arched lower edge wherein the blade trailing edge 114 is equal to or slightly shorter than the blade leading edge 112. A planar view of a turbine blade 150 is presented in FIG. 8, having an airfoil cross sectional shape bounded by a blade leading edge 152, a blade trailing edge 154, a posterior edge 156 and an interior edge 158. The interior edge 158 provides an “S” shaped lower edge having a continuous line blending into the blade trailing edge 114, and wherein the blade trailing edge 114 is shorter than the blade leading edge 112. A planar view of a turbine blade 160 is presented in FIG. 9, having an airfoil cross sectional shape bounded by a blade leading edge 162, a blade trailing edge 164, a posterior edge 166 and an interior edge 168. The interior edge 168 provides an arched shaped lower edge wherein the blade trailing edge 164 is significantly shorter than the blade leading edge 162.

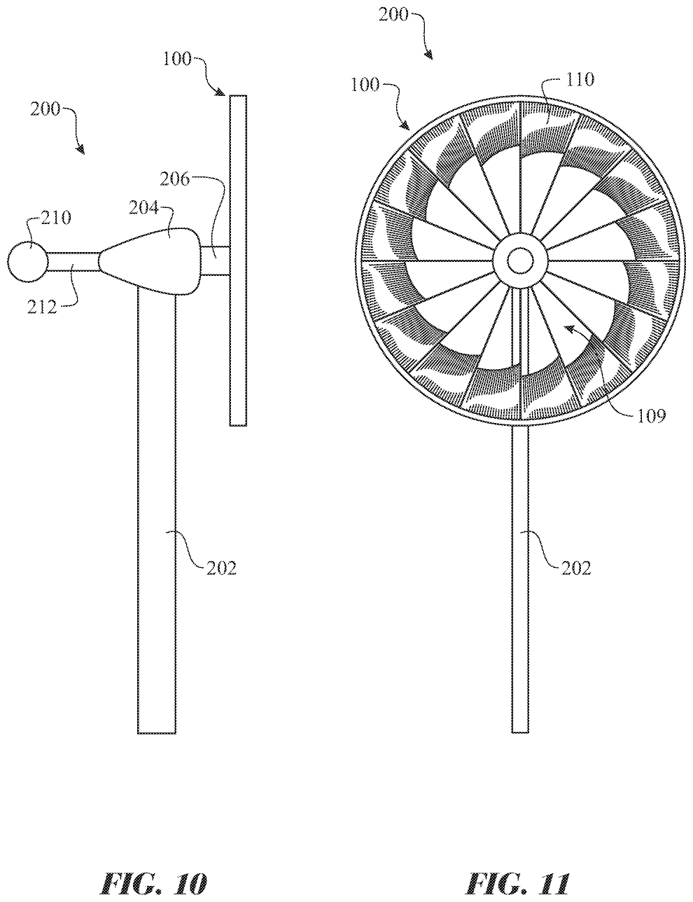

A turbine deployment assembly 200 is illustrated in FIGS. 10 through 15. A vertical riser support 202 provides a base member for the turbine deployment assembly 200. An electrical power generator 204 is pivotally assembled to the upper portion of the vertical riser support 202. The turbine wheel assembly 100 is in rotational communication with the electrical power generator 204 via a turbine wheel shaft 206. A counterbalance 210 can be incorporated providing a counterbalance to the turbine wheel assembly 100. The counterbalance 210 would be assembled to the turbine deployment assembly 200 via a counterbalance support beam 212.

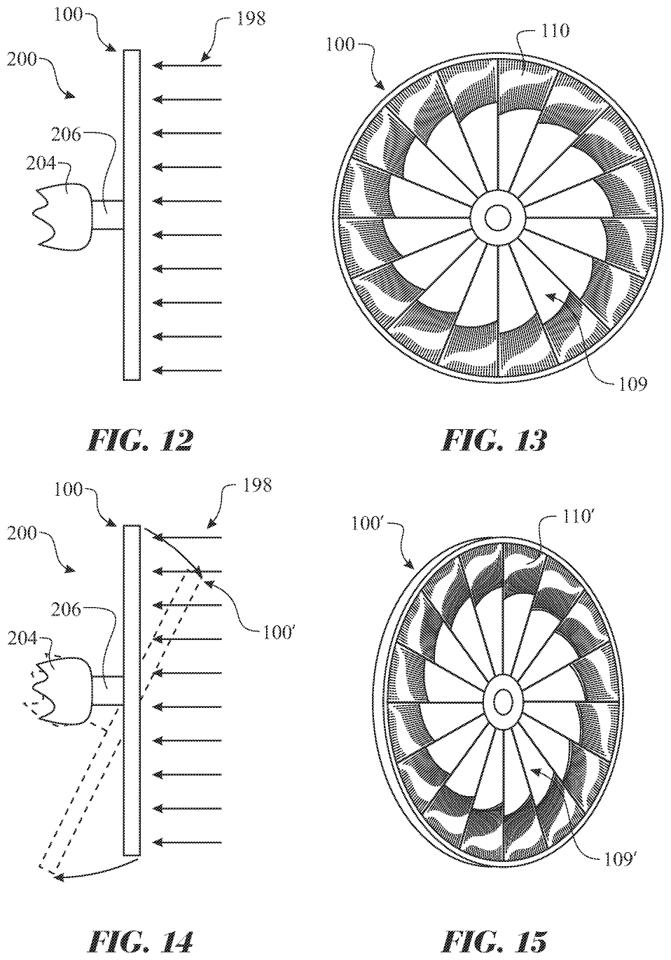

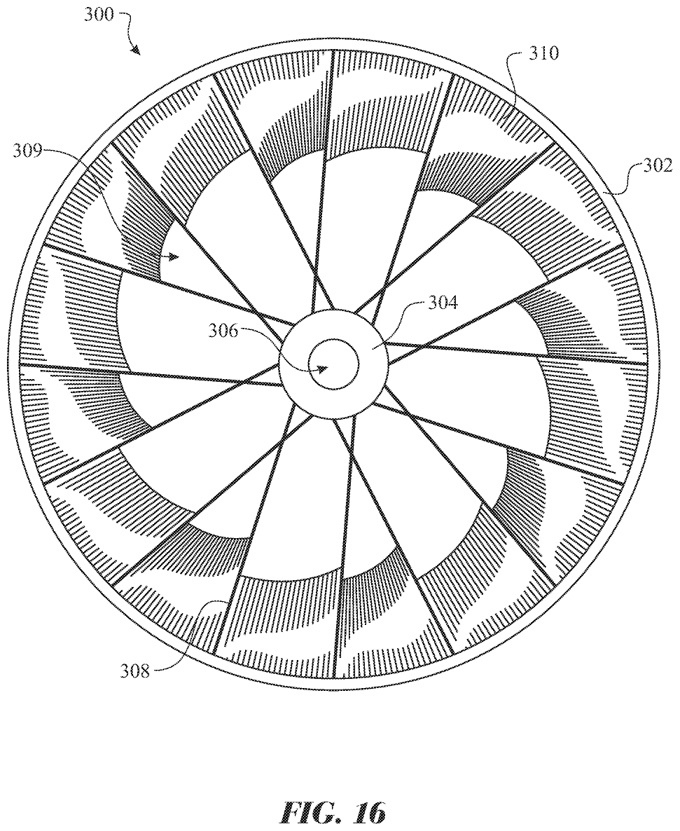

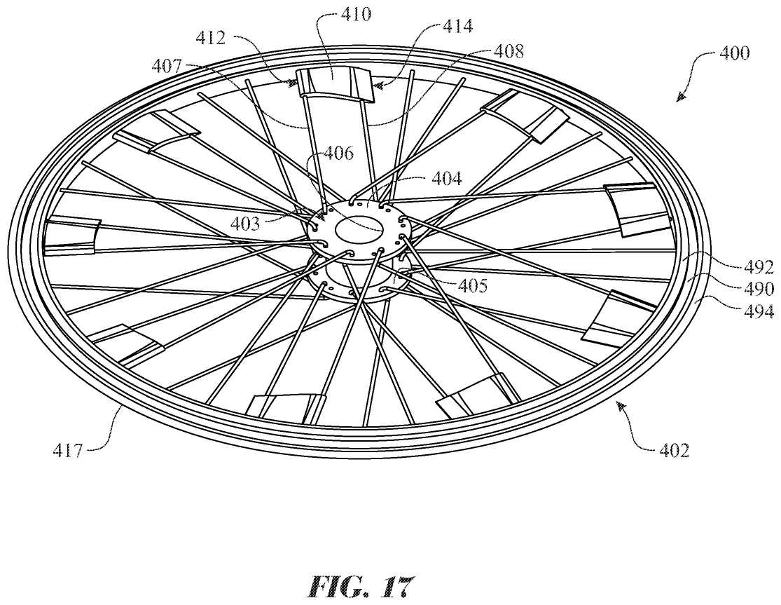

The electrical power generator 204 is designed to rotate about a vertical axis parallel to a longitudinal axis of the vertical riser support 202 as shown in the top views of FIG. 14. The rotation positions the turbine wheel assembly 100 to rotated position turbine wheel assembly 100′. The rotation allows for several capabilities. The first, being positioning the turbine wheel assembly 100 perpendicular to the wind flow 198 as shown in FIG. 12, thus maximizing the frontal surface area as illustrated in FIG. 13. The second, being positioning the turbine wheel assembly 100 at an angle that is not perpendicular to the wind flow 198 as shown in FIG. 14, thus reducing the frontal surface area exposed to the wind flow 198 as illustrated in FIG. 15. This reduces any potential damage from excessive winds. The incident angle mechanism and the breakaway mechanism both additionally contribute to efficiency, reliability, and protection of the turbine deployment assembly 200.

An alternate spoke configuration is presented in the exemplary embodiment referred to as a crossover spoke turbine wheel assembly 300, illustrated in FIG. 16. The crossover spoke turbine wheel assembly 300 is similar to the turbine wheel assembly 100. Like features of crossover spoke turbine wheel assembly 300 and turbine wheel assembly 100 are numbered the same except preceded by the numeral ‘3’. The turbine spokes 308 are arranged being fixed to the central hub 304 offset from the radial centerline. The turbine spokes 308 are configured whereby adjacent turbine spokes 308 overlap. The overlap between the spokes 308 occurs proximate the central hub 304.

The turbine assemblies 100 can be utilized for gas flow, such as gaseous flows, such as wind, or fluid flows, such as wave motion, currents, tidal flow, and the like. It is also understood that the turbine assembly 100 can be attached to a moving object. The turbine assembly 100 creates an output power based upon the relative motion between the turbine assembly 100 and a fluid (either gaseous or liquid).

The previously described embodiment integrates the electric power generator 204 into the power generating central hub assembly 204 of the turbine assembly 200. Electric power generators 204 are generally heavy, wherein the weight impacts the structural design and directional rotatability of the turbine assembly 200.

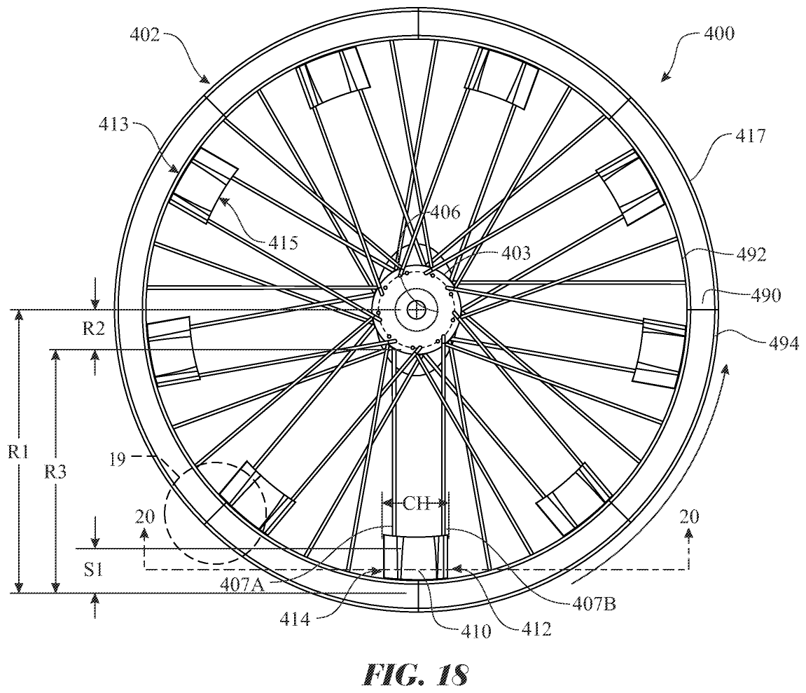

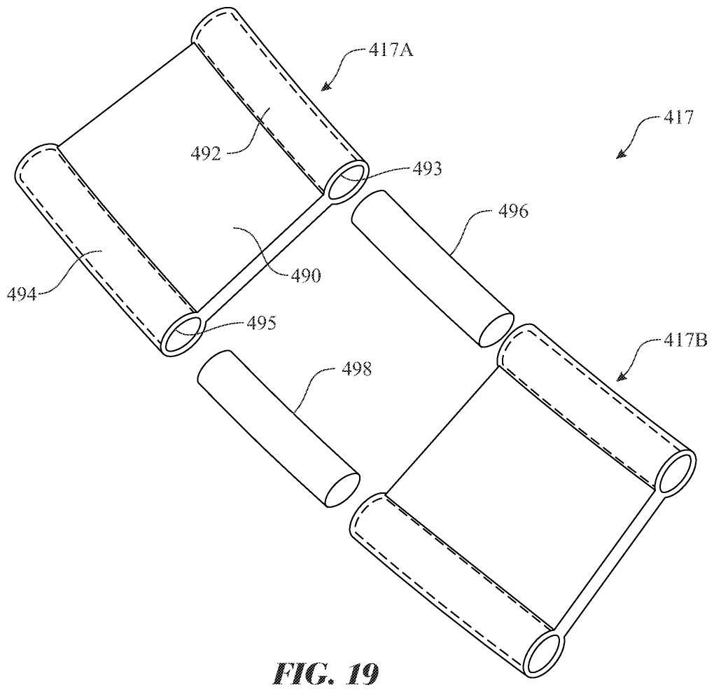

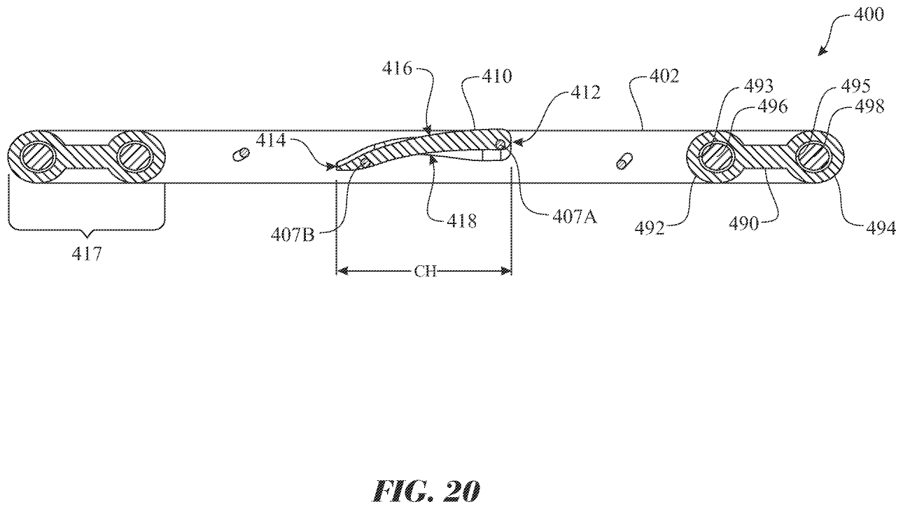

The turbine wheel assembly 100 can be modified and adapted for other applications. A tension airfoil turbine 400, illustrated in FIGS. 17 and 18, is another adaptation of the tension wheel assembly 100. The tension airfoil turbine 400 and the turbine wheel assembly 100 comprise a number of like features. Like features of the tension airfoil turbine 400 and the turbine wheel assembly 100 are numbered the same except preceded by the numeral ‘4’. The tension airfoil turbine 400 is an assembly comprising a tension airfoil outer rim 402 assembled to a tension airfoil central hub assembly 403 by a series of spokes 407A, 407B. The tension airfoil central hub assembly 403 includes a tension airfoil first central hub flange 404 and a tension airfoil second central hub flange 405 extending radially outward from opposite ends of an axle bearing 406. The outer edge of the tension airfoil outer rim 402 is preferably shaped having a tension airfoil outer rim aerodynamic surface 482, as illustrated. The tension airfoil outer rim 402 is designed having an internal radius R1. The central hub flanges 404, 405 are designed having an external radius R2. The hub external radius R2 is defined as a distance between the rotational axis of the hub 406 and a ring defined by the centers of the spoke hub attachment holes or other spoke attachment features. A different between the radii R1 and R2 (R1-R2) defines an effective length (radial span of each spoke) R3 of each spoke 407A, 407B. The optimal design would include a R1 to R2 ratio of 6:1. The optimal ratio provides a configuration where the tension airfoil leading spoke 407A and the tension airfoil trailing spoke 407B are substantially parallel with one another and run parallel to a radial axis extending outward from a central point of the axle bearing 406. Although the optimal ration is 6:1, it is recognized that the ratio can vary between 4:1 and 8:1.

As illustrated, a first end of each spoke 407A is assembled to a respective central hub flange 404, 405 and a second end of each spoke is assembled to the outer rim 402. A first spoke 407A of the plurality of spokes 407A, 407B is assembled to the respective central hub flange 404, 405 in an arrangement extending in an acute angular direction from a radial orientation in a first direction from a first side of the respective central hub flange 404, 405 and a second spoke 407B of the plurality of spokes 407A, 407B is assembled to the respective central hub flange 404, 405 in an arrangement extending in an acute angular direction from a radial orientation in a second direction from a second side of the respective central hub flange 404, 405. One spoke 407A of the plurality of spokes 407A, 407B attached to the respective central hub flange 404, 405 crosses at least one another spoke 407B of the plurality of spokes 407A, 407B attached to the same respective central hub flange 404, 405. Each airfoil 410 of the series of airfoils 410 is assembled to the tension airfoil assembly 400 by coupling an area of the airfoil 410 proximate the leading edge 412 to a leading edge spoke 407A of the plurality of spokes 407A, 407B and by coupling an area of the airfoil 410 proximate the trailing edge 414 to a trailing edge spoke 407B of the plurality of spokes 407A, 407B. In the exemplary illustrations, one spoke 407A of the plurality of spokes 407A, 407B attached to the respective central hub flange 404, 405 crosses at least two another spokes 407 of the plurality of spokes 407 attached to the same respective central hub flange 404, 405. This arrangement of the spokes dramatically increases the strength of the assembly. Radially arranged spokes are susceptible to non-radial forces and are known to bend, this reducing the integrity of the tension airfoil turbine 400. Conversely, having spokes 407 arranged at acute angles from a radial orientation, and more so, having the first spoke 407 of the plurality of spokes 407 assembled to the respective central hub flange 404, 405 in an arrangement extending in the acute angular direction from the radial orientation in the first direction from the first side of the respective central hub flange 404, 405 and the second spoke 407 of the plurality of spokes 407 assembled to the respective central hub flange 404, 405 in the arrangement extending in the acute angular direction from the radial orientation in the second direction from the second side of the respective central hub flange 404, 405 provides an increase in strength when the tension airfoil turbine 400 is subjected to a force that is not in a radial direction respective to the tension airfoil outer rim 402.

It is preferred that the airfoil 410 be assembled to the tension airfoil turbine 400 having an airfoil outer edge 413 being located proximate an inner surface of the tension airfoil outer rim 402. Dimensions of the airfoil 410 are defined by an airfoil span S1 and an airfoil chord CH. The airfoil span S1 refers to a distance between the airfoil outer edge 413 and an airfoil inner edge 415 of the airfoil 410. The airfoil chord CH refers to a distance between the leading edge 412 and the trailing edge 414 of the airfoil 410. The airfoil span S1 is preferably equal to or less than fifty percent (50%) of the effective length R3 of each spoke 407A, 407B. The airfoil span S1 is more preferably equal to or less than thirty three percent (33%) of the effective length R3 of each spoke 407A, 407B. The airfoil span S1 is even more preferably equal to or less than thirty percent (30%) of the effective length of each spoke 407A, 407B. The airfoil span S1 is even more preferably equal to or less than twenty-five percent (25%) of the effective length of each spoke 407A, 407B.

Other design features of the tension airfoil turbine 400 include:
a. Each spoke 407A, 407B can cross other spokes defining three crossover locations.
b. The spokes 407A, 407B can include a circular cross section shape, an aerodynamic cross section shape, or any other suitable cross section shape.
c. Spokes can be arranged to alternate between extending from an outer surface of each hub flange 404, 405 and from an inner surface of the same hub flange 404, 405.
d. It is preferred that the tension airfoil turbine 400 includes a total of 36 spokes, 18 per hub flange 404, 405. In an alternative, the tension airfoil turbine 400 can include any multiple of four (4) spokes per hub assembly 403 or any multiple of two (2) spokes per hub flange 404, 405.
e. Each spoke 407A, 407B would preferably be assembled having substantially equally tension.
f. The spoke hub attachment holes can be even spaced about the hub flange 404, 405. Alternatively, the spoke hub attachment holes can be arranged in pairs, wherein the pairs are arranged having a first spacing and each adjacent pair is arranged having a second spacing about the hub flange 404, 405, wherein the first spacing and the second spacing differ from one another.
g. The series of spoke hub attachment holes of the tension airfoil first central hub flange 404 and the series of spoke hub attachment holes of the tension airfoil second central hub flange 405 are offset from one another.
h. The axial height of the tension airfoil outer rim 402 is determined by maximizing the desired strength of the tension airfoil outer rim 402, while providing sufficient area to support a connection of each spoke 407A, 407B.
i. The attachment locations of each spoke 407A, 407B along an interior surface of the tension airfoil outer rim 402 are either linear with one another or located in an alternating configuration.
j. The tension airfoil central hub assembly 403 is preferably substantially centered axially respective to the tension airfoil outer rim 402. Alternatively, the tension airfoil central hub assembly 403 can be offset axially respective to the tension airfoil outer rim 402.

The tension airfoil turbine 400 includes a series of airfoils 410. Each airfoil 410 has an airfoil or lifting shape, where a length of an airfoil upper surface 416, extending from an airfoil leading edge 412 to an airfoil trailing edge 414, is longer than a length of an airfoil lower surface 418, extending from the airfoil leading edge 412 to the airfoil trailing edge 414. The airfoil upper surface 416 is a preferably a convex surface. The airfoil lower surface 418 is preferably a planar or a concave surface. The airfoil 410 can be a solid assembly or hollowed to reduce weight. The airfoil 410 can be of any suitable shape such as a Clarke airfoil shape. The exemplary airfoil 410 is rectangular or square in shape. The airfoil leading edge 412 preferably is formed having a rounded edge. The airfoil trailing edge 414 preferably is formed having a tapering edge. Each airfoil 410 is preferably located proximate the outer region of the tension airfoil turbine 400, or proximate the interior surface of the tension airfoil outer rim 402.

The outer rim tension airfoil outer rim 402 can be provided as a tension airfoil outer rim assembly 417. Segmenting of the tension airfoil outer rim 402 to create the tension airfoil outer rim assembly 417 improves shipping transportation capabilities to support a tension airfoil outer rim 402 having a larger diameter, such as up to and over 1,000 feet. The exemplary tension airfoil outer rim assembly 417 is segmented into eight (8) segments having an equal arched radius and length. Assembly between segments can be accomplished using any suitable assembly technique. One exemplary assembly technique is illustrated in exploded assembly view shown in FIG. 19. The exemplary tension airfoil outer rim assembly 417 includes a tension airfoil first outer rim segment 417A and a mating end of a tension airfoil second outer rim segment 417B being assembled to one another. Each of the tension airfoil first outer rim segment 417A and the tension airfoil second outer rim segment 417B includes a tension airfoil outer rim segment inner annular assembly member 492 and a tension airfoil outer rim segment outer annular assembly member 494. A tension airfoil outer rim segment inner annular assembly bore 493 is formed in the tension airfoil outer rim segment inner annular assembly member 492 of each segment of the tension airfoil outer rim assembly 417. Similarly, a tension airfoil outer rim segment outer annular assembly bore 495 is formed in the tension airfoil outer rim segment outer annular assembly member 494 of each segment of the tension airfoil outer rim assembly 417. A tension airfoil outer rim segment inner annular assembly insert 496 is partially inserted into the tension airfoil outer rim segment inner annular assembly bore 493 of each mating segment of the tension airfoil outer rim assembly 417. A tension airfoil outer rim segment outer annular assembly insert 498 is partially inserted into the tension airfoil outer rim segment outer annular assembly bore 495 of each mating segment of the tension airfoil outer rim assembly 417. The tension airfoil outer rim segment inner annular assembly insert 496 and the tension airfoil outer rim segment outer annular assembly insert 498 can be secured in position using any suitable pinning or other securing interface, such as screws, nuts and bolts, welding, and the like.

In one configuration, the airfoil 410 would be sized to extend along approximately thirty percent (30%) of the outermost or distal portion of the spoke 407A, 407B. In an alternate configuration, the airfoil 410 would be sized to extend along between twenty percent (20%) and forty percent (40%) of the outermost or distal portion of the spoke 407A, 407B. In another alternate configuration, the airfoil 410 would be sized to extend along between ten percent (10%) and fifty percent (50%) of the outermost or distal portion of the spoke 407A, 407B. The outermost portion of the tension airfoil turbine 400 travels at the greatest linear velocity. Lift is a function of velocity.

Each airfoil 410 is assembled to a pair of spokes 407A, 407B using any suitable mechanical assembly configuration. In the exemplary embodiment, the airfoil 410 is assembled to the pair of spokes 407A, 407B by inserting each spoke through a respective bore formed through the airfoil 410. The airfoils 410 are spatially arranged about the tension airfoil turbine 400. A space or gap is provided between the airfoil trailing edge 414 of a forward located airfoil 410 and an airfoil leading edge 412 of a trailing located airfoil 410. The airfoil 410 can be formed having a slight twist, as illustrated, to accommodate the respective angles of the respective spokes 407A, 407B. Alternatively, the airfoil 410 can have a greater thickness. The twisted blade shape of the airfoil 410 produces more power or lift compared to straight airfoils. This is because as the airfoil 410 gets closer to the hub 403, the wind speed becomes less, requiring more a greater angle of attack to produce lift.

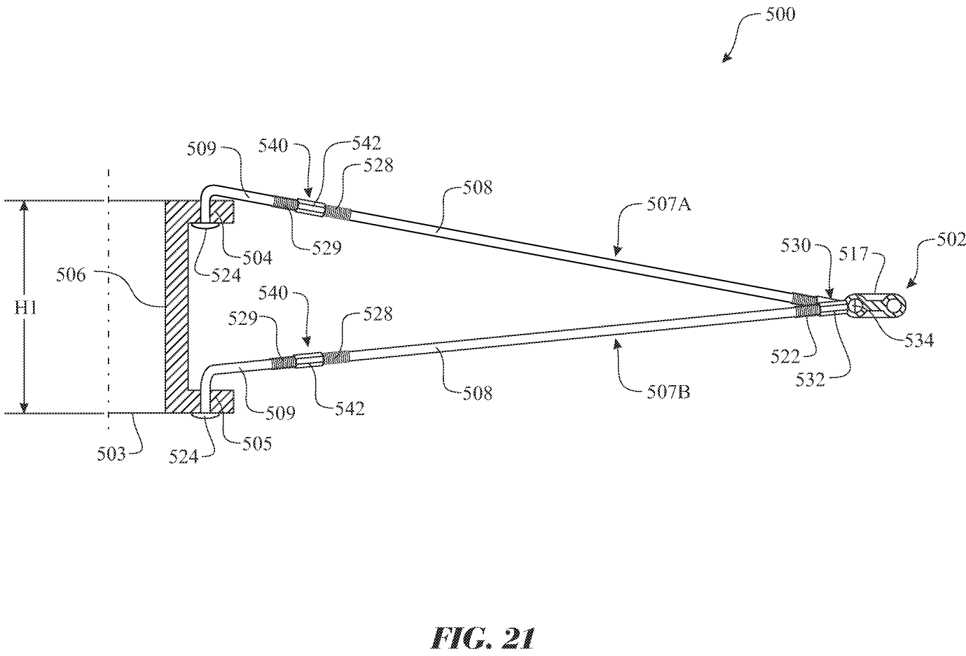

The angle of attack can be established by the arrangement of the spokes 407A, 407B, the height H1 (identified in FIG. 21) of the tension airfoil central hub assembly 403, or the like, or any combination thereof. The greater the height of hub H1 or the span between the hub flanges 404, 405, the greater the angle of attack. The height of hub H1 can be determined based upon the application of the exemplary tension airfoil turbine assembly 400. For example, when the exemplary tension airfoil turbine assembly 400 is intended for use with air, the H1 can be relatively small. When the exemplary tension airfoil turbine assembly 400 is intended for use with water or any other liquid, the H1 can be significantly larger to provide a greater angle between spokes 407A, 407B. The greater angle increases the support to the airfoil 410 of the exemplary tension airfoil turbine assembly 400 when subjected to the denser water compared to air.

The tension airfoil turbine 400 is designed to be implemented to provide lift. The tension airfoil turbine 400 includes features to drive a rotational motion. For example, the axle bearing 406 can include one or more features which would engage with a rotating shaft of a drive system, such as a motor. In another example, one or both hub flanges 404, 405 can be fixed to the rotating shaft of a drive system. In yet another example, the tension airfoil central hub assembly 403 can include a unidirectional drive mechanism, wherein the drive system drives a rotation in a lifting direction, but when necessary, the tension airfoil turbine 400 can rotate freely in a reverse direction.

It is understood that the tension airfoil turbine 400 would be rotationally balanced. Rotational balancing can be accomplished by any known method of balancing a rotating assembly, including by design, balancing of components, balancing of the assembly, and the like, or any combination thereof.

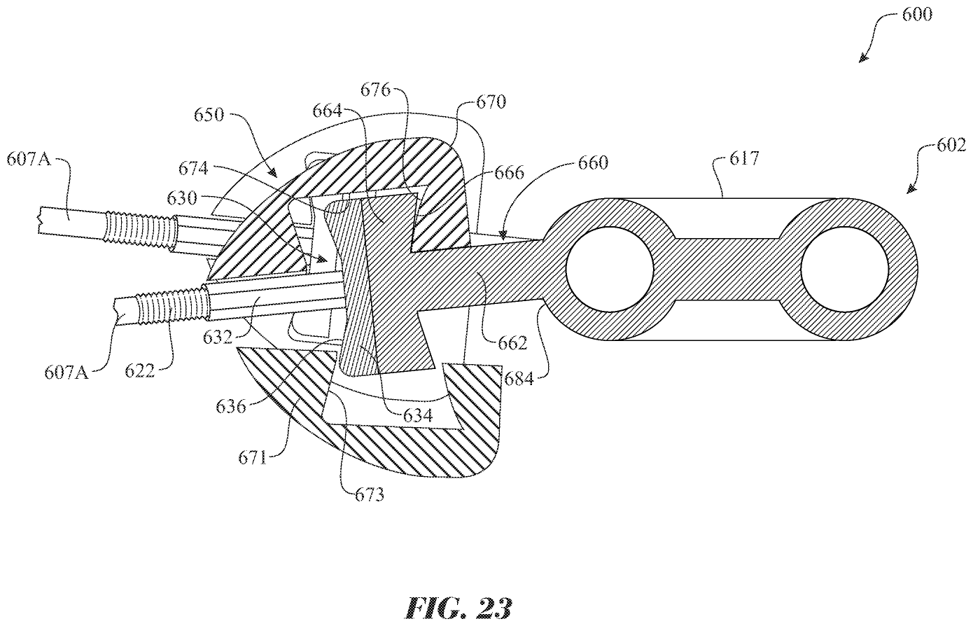

The spokes are assembled having a tension. The tension can be created by any suitable tension generating system or any combination of suitable tension generating systems. Examples of various suitable tension generating systems, including a spoke distal assembly tensioning nipple 530, a spoke distal assembly central tensioning system 540, and a hub located spoke tensioning system 550, are illustrated being employed on a tension airfoil turbine assembly 500, as presented in FIG. 23. Like features of the tension airfoil turbine assembly 500 and the tension airfoil turbine 400 are numbered the same except preceded by the numeral ‘5’. One or more of the spoke distal assembly tensioning nipple 530, the spoke distal assembly central tensioning system 540, and the hub located spoke tensioning system 550 would be integrated into the tension airfoil turbine 400, providing to and retaining tension in the spokes 407A, 407B.

The spoke distal assembly tensioning nipple 530 includes a spoke distal assembly tensioning nipple body 532 formed at a distal end of a spoke distal assembly tensioning nipple flange 534. The spoke distal assembly tensioning nipple body 532 is sized and shaped to adequately support tension applied to the spoke 507A, 507B against a mating surface of a tension airfoil outer rim 502. The tension airfoil outer rim 502 can be a turbine blade outer rim assembly 517 comprising multiple components assembled together, similar to the turbine blade outer rim assembly 417 and assembly as described in FIG. 19. The spoke distal assembly tensioning nipple body 532 can be of a fixed size and shape or capable of changing shape after being inserted through a respective receiving aperture formed through the tension airfoil outer rim 502. For example, the spoke distal assembly tensioning nipple body 532 can be shaped and function similar to a wall molly, a rivet, or the like. A spoke distal threading 522 is formed at a distal end of each spoke 507A, 507B. Threading (not shown, but well understood) is formed within an interior cylindrical surface of a cavity of each spoke distal assembly tensioning nipple flange 534, wherein the threading has the same thread size and pitch to mate with the spoke distal threading 522.

In the exemplary tension airfoil turbine assembly 500, the tension airfoil trailing spoke 407B is represented by a spoke segmented into a tension airfoil trailing spoke distal segment 507B and a tension airfoil trailing spoke proximal segment 509; the segments 508, 509 being assembled by the spoke distal assembly central tensioning system 540. A spoke distal segment proximal threading 528 is formed at a proximal end of the tension airfoil trailing spoke distal segment 508. A spoke proximal segment distal threading 529 is formed at a distal end of the tension airfoil trailing spoke proximal segment 509. The spoke distal segment proximal threading 528 and the spoke proximal segment distal threading 529 would have counter rotating threading, wherein a rotational direction the spoke distal segment proximal threading 528 is formed having a first rotational direction and the rotational direction of the spoke proximal segment distal threading 529 is formed having an opposite rotational direction. A spoke distal assembly central tensioning element 542 of the spoke distal assembly central tensioning system 540 would include a central bore having threaded ends. The threaded ends would also include counter rotating threading to mate with the spoke threading 528, 529. Tension can be adjusted by rotating the spoke distal assembly central tensioning element 542 in a first rotational direction to increase tension or rotating the spoke distal assembly central tensioning element 542 in a second rotational direction to decrease tension. The tensioning element 542 can be any suitable component or series of components enabling creation and/or adjustment of a tension of the respective spoke 507A, 507B.

A proximal or hub end of each spoke, such as the exemplary tension airfoil trailing spoke proximal segment 509 can be bent and formed creating a spoke anchor flange 524. The spoke anchor flange 524 engages with a mating surface of the hub flange 504, 505 to adequately support the tension generated along the spoke 507A, 507B. The bend in the tension airfoil trailing spoke proximal segment 509, when inserted through the spoke hub attachment hole, also refrains the tension airfoil trailing spoke proximal segment 509 from rotating.

The hub located spoke tensioning system 550 employs an alternative assembly configuration compared to the bend and formation of the spoke anchor flange 524 of the tension airfoil trailing spoke proximal segment 509. The hub located spoke tensioning system 550 includes a spoke proximal threading 527 formed at a proximal or hub end of the tension airfoil leading spoke 507. A hub located spoke tensioning bracket 556 would be integrally formed with or assembled to the tension airfoil first central hub flange 504. The tension airfoil leading spoke 507 would be inserted through an aperture formed through the hub located spoke tensioning bracket 556. A hub located spoke tensioning element 552 would be threadably secured to the proximal end of the spoke proximal threading 527 on a hub side of the hub located spoke tensioning bracket 556 and adjusted to generate and retain a tension along the tension airfoil leading spoke 507. An optional tensioning bracket cavity 557 can be formed within the hub located spoke tensioning bracket 556 to seat the hub located spoke tensioning element 552 accordingly.

It is understood that the spoke distal assembly tensioning nipple 530, the spoke distal assembly central tensioning system 540, and the hub located spoke tensioning system 550 can be used individually, or in any suitable combination thereof. The spoke distal assembly tensioning nipple 530, the spoke distal assembly central tensioning system 540, and the hub located spoke tensioning system 550 are only exemplary and any suitable tension generating system or systems can be integrated into the tension airfoil turbine 400, 500.

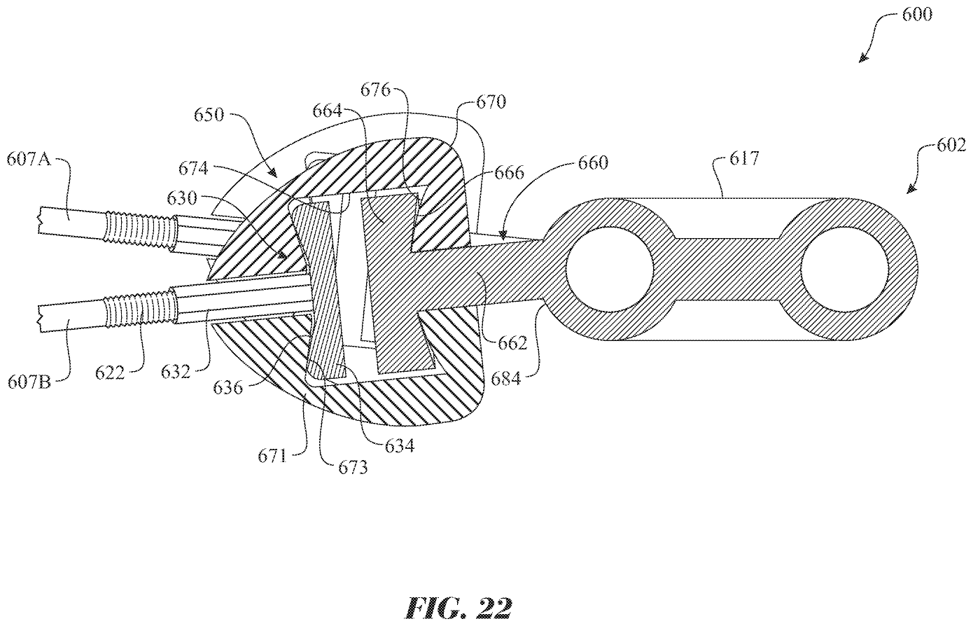

The spoke assembly configuration can be adapted to include a spoke breakaway feature 650. An exemplary spoke breakaway feature 650 is introduced in FIGS. 22 and 23. The spoke tensioning breakaway assembly 650 is integrated into a tension airfoil turbine assembly 600, wherein the tension airfoil turbine assembly 600 is a modified variant of the tension airfoil turbine 400 and/or tension airfoil turbine assembly 500. Like elements of the tension airfoil turbine assembly 600 and the tension airfoil turbine assembly 500 are numbered the same, except preceded by a numeral “5”. The exemplary illustration integrates the spoke tensioning breakaway assembly 650 at an end of each spoke 607A, 607B located proximate a tension airfoil outer rim 602. It is understood that the spoke tensioning breakaway assembly 650 can be integrated at a location proximate the turbine wheel assembly 100 or the hub (not shown). In another alternative configuration, the spoke tensioning breakaway assembly 650 can be integrated at any position along a length of the spoke.

The concept behind operation of the spoke tensioning breakaway assembly 650 is that while a tension is applied along a length of the spoke 607A, 607B, at least one tensioning assembly coupling element 670 retains a coupling between a tensioning nipple assembly 630 and a tensioning stud 660. In a preferred configuration, the spoke tensioning breakaway assembly 650 employs at least two tensioning assembly coupling elements 670.

The tensioning nipple assembly 630 includes a spoke tensioning nipple flange 634 extending radially outward from a distal end of a spoke tensioning nipple body 632, as shown, or from a distal end of a segment of the respective spoke. The spoke tensioning nipple body 632 can include a threaded surface to matingly engage with a mating threaded portion 622 of the spoke 607A, 607B, as illustrated. In the exemplary embodiment, the spoke tensioning nipple body 632 includes a female threaded bore and the spoke distal threading 622 is formed having male threading. It is understood that the spoke tensioning nipple body 632 can comprise male threading and the spoke distal threading 622 can be formed as female threading. Inclusion of threaded mating surfaces enables the tensioning nipple assembly 630 to be used to generate tension along the spoke 607A, 607B. It is understood that alternate configurations, such as those included in the tension airfoil turbine assembly 500 can be employed to create and maintain tension within the spoke 607A, 607B.

The tensioning stud 660 includes a tensioning stud flange 664 extending radially outward from a distal end of a tensioning stud trunk 662. The tensioning stud trunk 662 can be attached to a tension airfoil rim inner surface 684 of the tension airfoil outer rim 602, an end of a segment of the spoke 607A, 607B, a flange of the hub (not shown), or any other suitable element of the tension airfoil turbine assembly 600. The tensioning stud 660 can be mechanically assembled to the respective element of the tension airfoil turbine assembly 600 using a permanent assembly method or a temporary mechanical interface. The tensioning stud 660 can be welded to the respective element of the tension airfoil turbine assembly 600, bolted to the respective element of the tension airfoil turbine assembly 600, or any other permanent assembly method. Alternatively, the tensioning stud 660 can include a suitable flange, wherein the flange would be larger than a respective aperture formed through the respective element of the tension airfoil turbine assembly 600, or any other temporarily assembly configuration. In another alternate configuration, the tensioning stud 660 can be integrally formed with the respective element of the tension airfoil turbine assembly 600, such as by machining, casting, and the like. In yet another configuration, the tensioning stud 660 can be integrated into an end of a segment of the spoke 607A, 607B using any suitable manufacturing process.

A tensioning assembly coupling element connection cavity 674 is formed within the tensioning assembly coupling element 670. The tensioning assembly coupling element connection cavity 674 is sized and shaped to enclose each of the spoke tensioning nipple flange 634 and the tensioning stud flange 664, as illustrated in FIG. 22. Additionally, the tensioning assembly coupling element connection cavity 674 is sized to enable the spoke tensioning nipple flange 634 and the tensioning stud flange 664 to become dislodged from within the tensioning assembly coupling element connection cavity 674, freeing a broken spoke 607A, 607B from the tension airfoil turbine assembly 600, as illustrated in FIG. 23. Details of the operation of the spoke tensioning breakaway assembly 650 are described later within this disclosure.

A tensioning stud flange assembly retention surface 666 is formed within the tensioning stud flange 664. The tensioning stud flange assembly retention surface 666 is formed having a debossed or inwardly extending shape. The debossed surface can be of any suitable shape, including a concave surface, as illustrated, a conically shaped surface, a “V” shaped surface, and the like. A tensioning coupling element stud flange retention surface 676 is formed within the tensioning assembly coupling element 670. The tensioning coupling element stud flange retention surface 676 is shaped to matingly engage with the tensioning stud flange assembly retention surface 666. The tensioning coupling element stud flange retention surface 676 of the tensioning assembly coupling element 670 would have a shape that mirrors that of the tensioning stud flange assembly retention surface 666. More specifically, the tensioning coupling element stud flange retention surface 676 would have a bossed or outwardly extending surface. The shape of the tensioning coupling element stud flange retention surface 676 is preferably exaggerated compared to the shape of the surface of the tensioning stud flange assembly retention surface 666, as illustrated. This differential in shapes of the mating surfaces focusing the contacting surfaces towards the centers accordingly.

Similarly, a spoke tensioning nipple spoke assembly retention surface 636 is formed within the spoke tensioning nipple flange 634. The spoke tensioning nipple spoke assembly retention surface 636 is formed having a debossed or inwardly extending shape. The debossed surface can be of any suitable shape, including a concave surface, as illustrated, a conically shaped surface, a “V” shaped surface, and the like. A tensioning coupling element nipple flange retention surface 673 is formed within the tensioning assembly coupling element 670. The tensioning coupling element nipple flange retention surface 673 is shaped to matingly engage with the spoke tensioning nipple spoke assembly retention surface 636. The tensioning coupling element nipple flange retention surface 673 would have a shape that mirrors that of the spoke tensioning nipple spoke assembly retention surface 636. More specifically, the tensioning coupling element nipple flange retention surface 673 would have a bossed or outwardly extending surface. The shape of the tensioning coupling element nipple flange retention surface 673 is preferably exaggerated compared to the shape of the surface of the spoke tensioning nipple spoke assembly retention surface 636, as illustrated. This differential in shapes of the mating surfaces focusing the contacting surfaces towards the centers accordingly.

As a tension is applied to the respective spoke 607A, 607B, the tension separates the spoke tensioning nipple flange 634 and the tensioning stud flange 664 from one another. During the separation between the spoke tensioning nipple flange 634 and the tensioning stud flange 664, the spoke tensioning nipple spoke assembly retention surface 636 engages with the tensioning coupling element nipple flange retention surface 673, pulling the tensioning assembly coupling element 670, causing the tensioning coupling element stud flange retention surface 676 to engage with the tensioning stud flange assembly retention surface 666. The shape of the tensioning stud flange assembly retention surface 666 and the tensioning coupling element stud flange retention surface 676 draws the tensioning assembly coupling element 670 to center along the tensioning stud trunk 662. Similarly, the shape of the spoke tensioning nipple spoke assembly retention surface 636 and the tensioning coupling element nipple flange retention surface 673 draws the tensioning assembly coupling element 670 to center along the spoke tensioning nipple body 632. It is preferred to employ a pair of tensioning assembly coupling elements 670 (identified as a 670 and a 671), thus balancing the spoke tensioning breakaway assembly 650. The pair of tensioning assembly coupling elements 670 can be independent of one another or hingeably coupled to one another.

When a spoke 607A, 607B breaks, as illustrated in FIG. 23, the centrifugal force draws the spoke tensioning nipple flange 634 towards the tensioning stud flange 664. This enables the tensioning assembly coupling element 670 to separate from the tensioning nipple assembly 630 and the tensioning stud 660. The tensioning assembly coupling element connection cavity 674 is shaped and sized to allow each tensioning assembly coupling element 670 to separate from the tensioning nipple assembly 630 and the tensioning stud 660. Once separated, the associated section of the spoke 607A, 607B becomes free from the tension airfoil turbine assembly 600. The exemplary configuration locates the spoke tensioning breakaway assembly 650 proximate or integral with the tension airfoil outer rim 602. A second spoke tensioning breakaway assembly 650 can be integral with the hub. The inclusion of the pair of spoke tensioning breakaway assemblies 650 enables complete release of an entire broken spoke 607A, 607B.

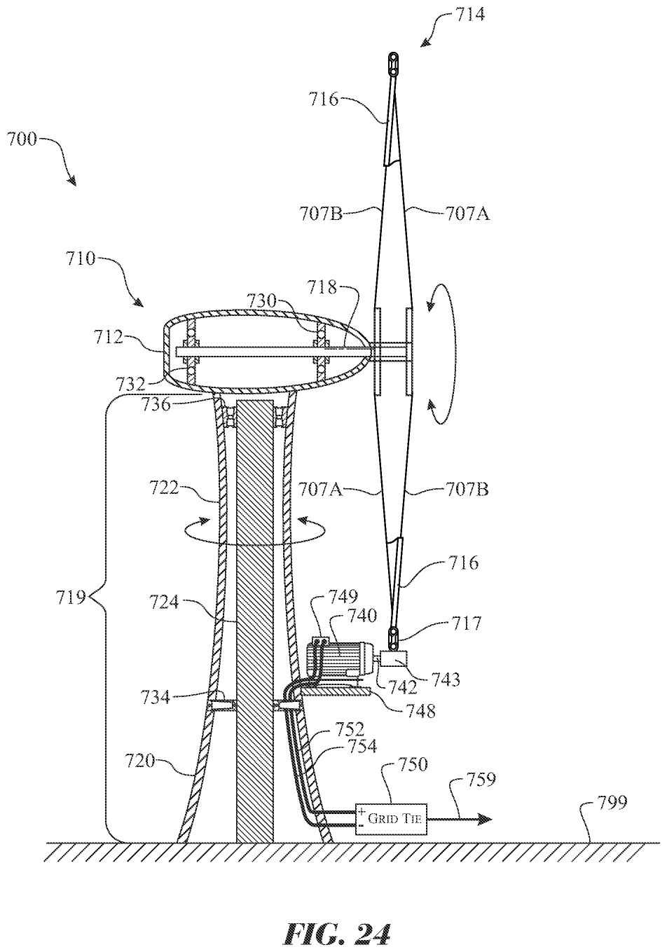

A wind operated electrical power generating system 700, as shown in an exemplary illustration presented in FIG. 24, introduces an alternative configuration for transferring wind energy to an electric generator 740. In the exemplary illustration, a turbine blade subassembly 714 is rotationally supported by a turbine housing 712 via a turbine blade subassembly shaft 718. The turbine blade subassembly shaft 718 is rotationally assembled to the turbine housing 712 by a turbine blade shaft supporting forward bearing assembly 730 and a turbine blade shaft supporting rear bearing assembly 732.

The turbine housing 712 of the wind operated turbine assembly 710 is carried by a vertical riser support structure 719. The vertical riser support structure 719 is structurally supported by a system supporting surface 799. In a preferred configuration, the vertical riser support structure 719 is rigidly mounted to the system supporting surface 799. The system supporting surface 799 can be a cement slab; a natural earth surface, such as dirt, rocks, and the like; a wooden structure, a mobile vehicle, a floating vessel, and the like. The mounting configuration would be determined based upon the selected supporting material. The turbine housing 712 is preferably located atop a distal end of the vertical riser support structure 719. The turbine housing 712 includes various features required for operation of the wind operated turbine assembly 710. A turbine blade subassembly 714 is rotationally assembled to the turbine housing 712 using a turbine blade subassembly shaft 718. The turbine blade subassembly 714 can be of any suitable design, including the turbine wheel assembly 100, the crossover spoke turbine wheel assembly 300, a tension airfoil assembly 400 (oriented in a horizontal arrangement for lift, and referred to as a tension airfoil lifting assembly 400 as introduced in FIG. 17 and oriented in a vertical orientation for use as a wind collecting device and referred to as a tension airfoil turbine assembly 400) (and any of the associated variants), and any other suitable wind power collecting design comprising a peripheral annular ring.

The turbine blade subassembly shaft 718 can be supported by a series of bearing assemblies, such as a turbine blade shaft supporting forward bearing assembly 730 and a turbine blade shaft supporting rear bearing assembly 732 illustrated in FIG. 24. The bearing assemblies 730, 732 can employ spherical bearings, cylindrical rolling elements, tapered rolling elements, barrel shaped rolling elements, and the like. Each bearing assembly 730, 732 would include an inner ring and an outer ring (not identified but well known by description by those skilled in the art). The bearing assemblies 730, 732 enable rotation of the turbine blade subassembly shaft 718 with minimal friction. It is understood that any arrangement can be utilized to enable rotation of the turbine blade subassembly 714 about a substantially horizontal axis.

In the exemplary illustration, the electric generator 740 engages with a peripheral surface or of a turbine blade outer rim surface 717 of the turbine blade subassembly 714. More specifically, an electric generator turbine rim engagement wheel 743 is secured to a distal or free end of an electric generator shaft 742 of the electric generator 740. The electric generator turbine rim engagement wheel 743 can be directly engaging with the peripheral surface of an electric generator turbine rim engagement wheel 743, engaging via a gearing arrangement or a transmission, engaging using a belt that partially circumscribes the peripheral surface of an electric generator turbine rim engagement wheel 743, engaging using a belt that partially circumscribes the turbine blade subassembly shaft 718, or any other suitable arrangement to transfer a rotational motion caused by the turbine blade subassembly 714 to the electric generator shaft 742 of a distally mounted electric generator 740. The electric generator 740 is preferably supported by an electric generator support component 748, where the electric generator 740 is mechanically coupled to the electric generator support component 748 and the electric generator support component 748 is mechanically assembled to a vertical riser support structure rotating section 722 of the vertical riser support structure 719.

In the arrangement of the wind operated electrical power generating system 700, the electric generator 740 should remain in alignment with rotational transferring element of the turbine blade subassembly 714. In order to accomplish this, the vertical riser support structure 719 is arranged in at least two sections: a vertical riser support structure rotating section 722 rotationally assembled to a vertical riser support structure base section 720. Rotation and support between the vertical riser support structure rotating section 722 and the vertical riser support structure base section 720 can be provided by a vertical riser support structure base bearing assembly 734. The vertical riser support structure base bearing assembly 734 would be arranged similar to any rotating mechanism that rotates an upper element respective to a lower element about a vertical axis. The rotation can be provided by a powered arrangement or a free motion, where wind could orient the direction of the vertical riser support structure rotating section 722. In the exemplary illustration, tapered rolling elements are contained between an outer ring and an inner ring forming the vertical riser support structure base bearing assembly 734. An inner diameter of one of the bearing assembly rings can be assembled to a vertical riser support structure stabilizing column 724, where the vertical riser support structure stabilizing column 724 provides support along a length of the vertical riser support structure 719. A vertical riser support structure upper stabilizing bearing assembly 736 can be assembled at an upper end of the vertical riser support structure 719 to provide additional support of the vertical riser support structure rotating section 722. The vertical riser support structure upper stabilizing bearing assembly 736 could be arranged having an inner ring assembled to the vertical riser support structure stabilizing column 724 and an outer ring assembled to the vertical riser support structure rotating section 722. In the exemplary illustration, the vertical riser support structure upper stabilizing bearing assembly 736 employs pairs of tapered rolling elements to maintain support of the bearing elements in a vertical direction, while stabilizing the vertical riser support structure rotating section 722 in a horizontal direction.

The turbine housing 712 can be rigidly fixed to the vertical riser support structure 719 or rotationally carried by the vertical riser support structure 719. In a configuration where the turbine housing 712 is rotationally carried by the vertical riser support structure 719, the turbine housing 712 would rotate to optimize the directional relationship between the turbine blade subassembly 714 and the direction of the wind. In the exemplary embodiment, the vertical riser support structure rotating section 722 would rotate respective to the vertical riser support structure base section 720. The combination of the vertical riser support structure base section 720 and the vertical riser support structure stabilizing column 724 provides support to the vertical riser support structure rotating section 722.

Electrical power generated by the electric generator 740 would be collected and transferred to a grid tie 750 by an electric output panel 749, a positive electrical output cable 752, and a negative electrical output cable 754. The grid tie 750 would, in turn, transfer the generated electrical power to a power grid 759 for collection and use.

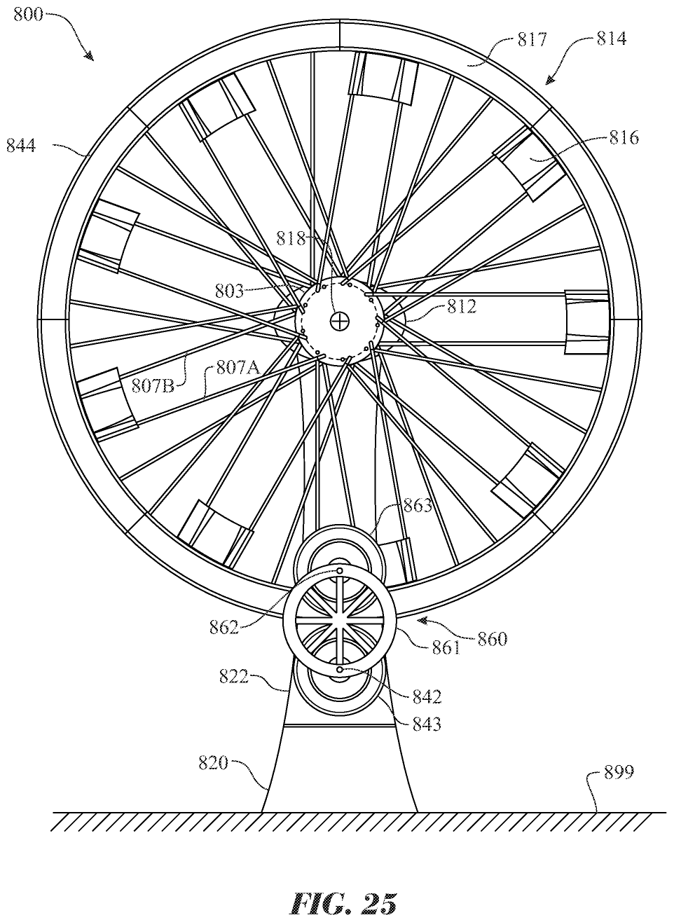

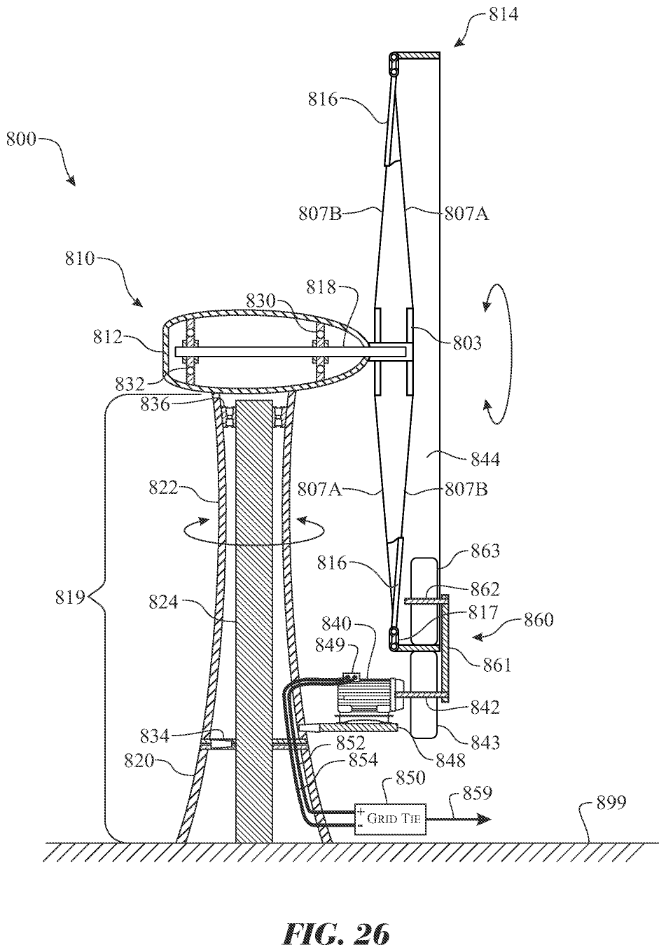

The wind operated electrical power generating system 700 illustrated in FIG. 24 relies upon friction between the turbine blade outer rim assembly 717 and the electric generator turbine rim engagement wheel 743. The interface between the turbine blade outer rim assembly 717 and the electric generator turbine rim engagement wheel 743 can encounter slippage reducing the efficiency of the wind operated electrical power generating system 700 to generate power and increase wear upon the turbine blade outer rim assembly 717 and the electric generator turbine rim engagement wheel 743. A wind operated electrical power generating system 800, illustrated in FIGS. 25 and 26, introduces a power transfer interface that improves the power transfer interface between the turbine blade outer rim assembly 717 and the electric generator turbine rim engagement wheel 743 of the wind operated electrical power generating system 700.

The wind operated electrical power generating system 800 includes a number of elements that similar to the elements of the wind operated electrical power generating system 700. Like elements of the wind operated electrical power generating system 800 and the wind operated electrical power generating system 700 are numbered the same, while elements of the wind operated electrical power generating system 800 are preceded by the numeral “8”. A turbine blade subassembly 814 of the wind operated electrical power generating system 800 can be any of the turbine wheel assembly 100, the crossover spoke turbine wheel assembly 300, the tension airfoil turbine 400, or any variation thereof, while introducing a power transfer annular ring 844). The power transfer annular ring 844 is an annular ring that extends outward axially from the turbine blade outer rim assembly 817. A power transfer subassembly 860 includes elements providing a power transfer interface between the turbine blade subassembly 814 and the electric generator 840. The power transfer subassembly 860 includes elements to support an electric generator turbine rim engagement wheel 843 and a turbine rim compression applying wheel 863. The electric generator turbine rim engagement wheel 843 is rotationally coupled to an electric generator shaft 842, wherein the electric generator shaft 842 directly or indirectly drives an electric generator 840 to generate electrical power. The turbine rim compression applying wheel 863 is introduced to retain adequate friction between the power transfer annular ring 844 and the electric generator turbine rim engagement wheel 843. The turbine rim compression applying wheel 863 is rotationally supported by a compression applying wheel shaft 862. The compression applying wheel shaft 862 extends outward from a power transfer support frame 861. It is preferred that a radial position of at least one of the electric generator turbine rim engagement wheel 843 and the turbine rim compression applying wheel 863 is adjustable, enabling radially positional adjustment between the electric generator turbine rim engagement wheel 843, the turbine rim compression applying wheel 863, and the respective contacting surfaces of the power transfer annular ring 844. One method of adjusting the radial position of the electric generator turbine rim engagement wheel 843 and the turbine rim compression applying wheel 863 is to rotate the power transfer support frame 861. Rotation of the power transfer support frame 861 (or any other method of maintaining opposing forces applied by each of the electric generator turbine rim engagement wheel 843 and the turbine rim compression applying wheel 863 can be provided by at least one biasing element, such as a spring.

The electric generator turbine rim engagement wheel 843 and the turbine rim compression applying wheel 863 can be any suitable circularly shaped elements having a high friction circumferential surface. In one solution, each of the electric generator turbine rim engagement wheel 843 and the turbine rim compression applying wheel 863 can be tires; preferably recycled tires. Each tire would be mounted upon a wheel or other tire supporting component. The power transfer subassembly 860 is preferably designed for servicing of the electric generator turbine rim engagement wheel 843 and the turbine rim compression applying wheel 863.

As the turbine blade subassembly 814 rotates, friction between an exterior surface of the power transfer annular ring 844 and the electric generator turbine rim engagement wheel 843 drives a rotation of the components of the electric generator 840 creating an electric power output, similar to the description of the wind operated electrical power generating system 700.

Although the preferred arrangement of the electric generator turbine rim engagement wheel 843 is towards an exterior surface of the power transfer annular ring 844, the power transfer subassembly 860 can be arranged having the electric generator turbine rim engagement wheel 843 contacting an interior surface of the power transfer annular ring 844. The electric generator 840 would be located on a side of the turbine blade subassembly 814 to avoid interference with the tension members 807, 808 and the turbine blades 816.

Additionally, the sidewall of the turbine rim compression applying wheel 863 can rest against a contacting surface of the turbine blade outer rim assembly 817. This provides a lateral stability to the turbine blade subassembly 814 during rotation.

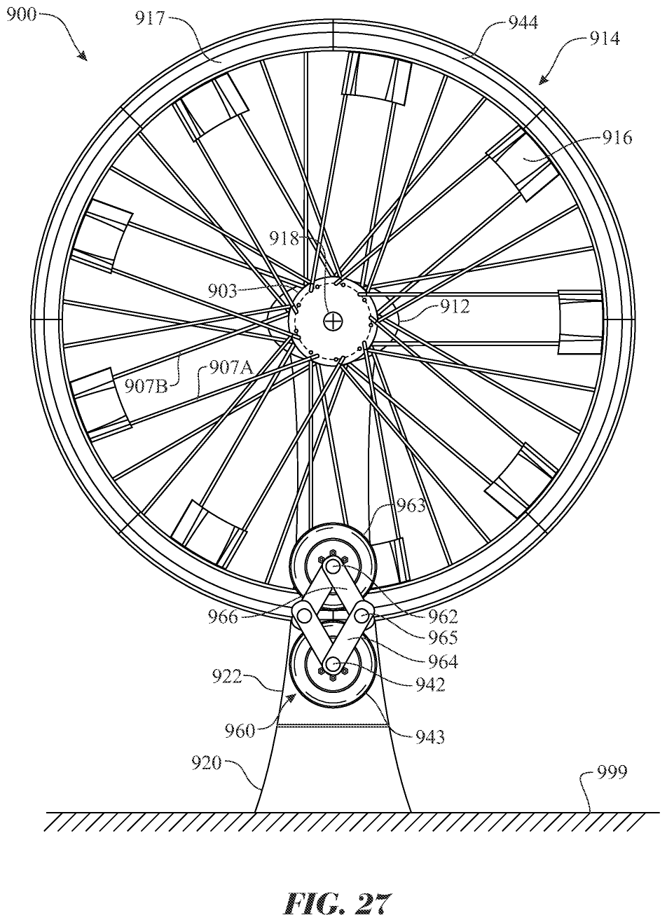

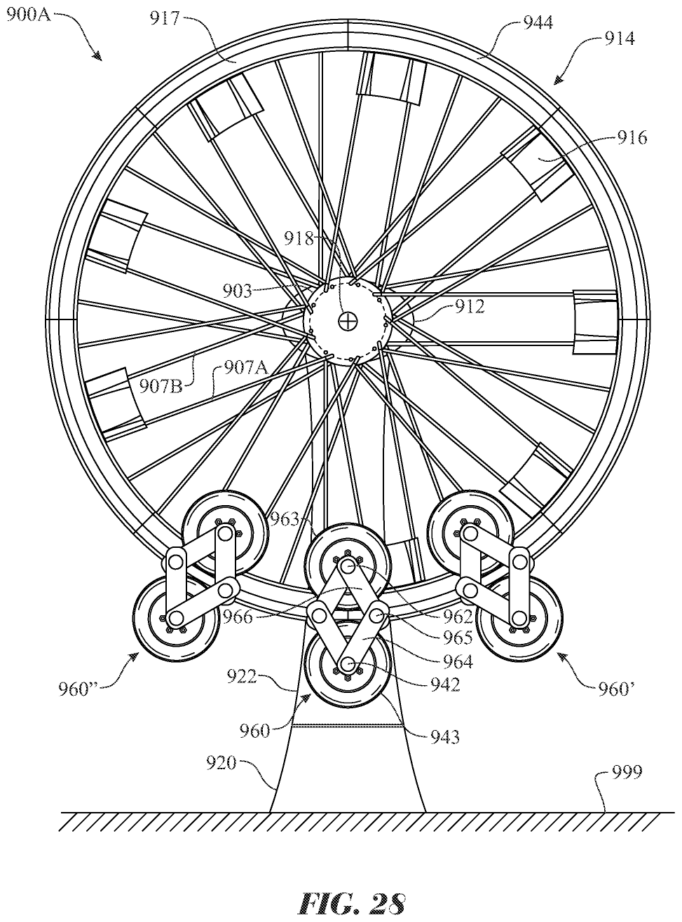

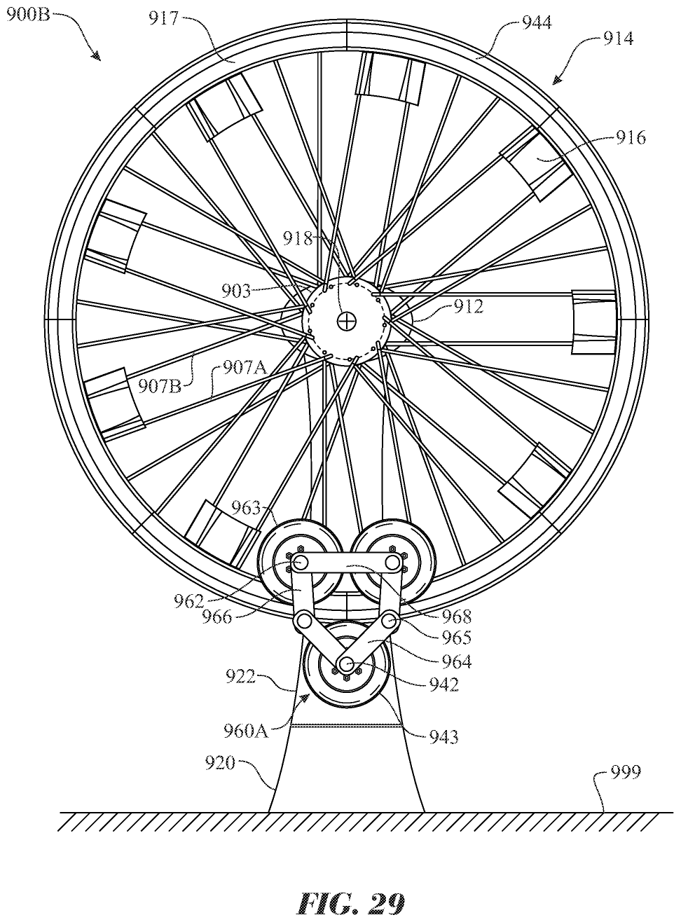

The wind operated electrical power generating system 800 illustrates a first exemplary arrangement employing a power transfer subassembly 860. As discussed above, the tensioning system can be of any suitable configuration. The power transfer subassembly 860 can utilize a rotational arrangement to adjust the applied compression. A wind operated electrical power generating system 900, illustrated in FIG. 27, is a second exemplary arrangement employing a friction compression subassembly, referred to as a power transfer subassembly 960. The wind operated electrical power generating system 900 and the wind operated electrical power generating system 800 are essentially the same with the exception of differences between the power transfer subassembly 860 and the power transfer subassembly 960. In the wind operated electrical power generating system 800, the power transfer support frame 861 is a rigid member. In the wind operated electrical power generating system 900, the power transfer subassembly 960 includes a scissor style frame support enabling an adjustable tension between an electric generator turbine rim engagement wheel 943 and a turbine rim compression applying wheel 963. The power transfer subassembly 960 includes a pair of power transfer support assembly lower arms 964 and a pair of power transfer support assembly upper arms 966. Like the power transfer subassembly 860, the power transfer subassembly 960 can be supported by an electric generator shaft 942 rotationally secured to the electric generator (see electric generator 840 in FIG. 26). One end of each of the pair of power transfer support assembly lower arms 964 are rotationally pinned together by the electric generator shaft 942. Each set of power transfer support assembly lower arms 964 and power transfer support assembly upper arms 966 are pinned together by a power transfer support assembly central support pin 965. A second end of each of the pair of power transfer support assembly upper arms 966 are rotationally pinned together by the compression applying wheel shaft 962. The turbine rim compression applying wheel 963 is rotationally assembled to the scissor style frame support by the compression applying wheel shaft 962.

Compression between the electric generator turbine rim engagement wheel 943 and the turbine rim compression applying wheel 963 against opposite sides of the power transfer annular ring 944 can be controlled by any of a variety of implementations. A first exemplary implementation is simply utilizing a weight of the turbine rim compression applying wheel 963. A second exemplary implementation can employ a tensioning member extending between the electric generator shaft 942 and the compression applying wheel shaft 962. A third exemplary implementation can employ a compression member extending between the pair of the power transfer support assembly central support pins 965. Although several exemplary implementations are described herein, any arrangement drawing the electric generator shaft 942 and the compression applying wheel shaft 962 towards one another can be integrated into the power transfer subassembly 960.

The wind operated electrical power generating system 900 includes a single power transfer subassembly 960. The power transfer subassembly 960 can be replicated, providing additional energy conversion stations and/or stability services. A wind operated electrical power generating system 900A includes a plurality of power transfer subassemblies 960, identified as a power transfer subassembly 960, a first angled power transfer subassembly 960′ and a second angled power transfer subassembly 960″. The power transfer subassembly 960, the first angled power transfer subassembly 960′ and the second angled power transfer subassembly 960″ are preferably equally spaced from one another. The power transfer subassembly 960, the first angled power transfer subassembly 960′ and the second angled power transfer subassembly 960″ can be supported by the same support structure or independent support structures. The wind operated electrical power generating system 900A is only exemplary, including three power transfer subassemblies 960. The wind operated electrical power generating system 900A can include any reasonable number of power transfer subassemblies 960.

A wind operated electrical power generating system 900B, illustrated in FIG. 29, is a third exemplary arrangement employing a friction compression subassembly, referred to as a power transfer subassembly 960A. The wind operated electrical power generating system 900A and the wind operated electrical power generating system 900B are essentially the same with the exception of differences between the power transfer subassembly 960 and the power transfer subassembly 960A. The power transfer subassembly 960 is assembled having a diamond shape. The power transfer subassembly 960A is assembled having a pentagon shape. A pair of power transfer support assembly lower arms 964 are pivotally assembled together at a lower end by the electric generator shaft 942. A lower end of each of a power transfer support assembly upper arm 966 and the respective power transfer support assembly lower arm 964 are pivotally assembled to one another by a power transfer support assembly central support pin 965. Each end of a power transfer support assembly upper arm 966 is pivotally assembled to respective end of a power transfer support assembly upper arm 966 by a compression applying wheel shaft 962. The power transfer subassembly 960A includes an electric generator turbine rim engagement wheel 943 and a pair of turbine rim compression applying wheels 963. The electric generator turbine rim engagement wheel 943 is assembled to the power transfer subassembly 960A by the electric generator shaft 942. Each of the turbine rim compression applying wheels 963 are assembled to the power transfer subassembly 960A by the respective compression applying wheel shaft 962. Collectively, the pair of power transfer support assembly lower arms 964, the pair of power transfer support assembly upper arms 966 and the power transfer support assembly upper arm 966 form the pentagon shape. Although the power transfer subassembly 960A is illustrated having the electric generator turbine rim engagement wheel 943 at the lower portion of the power transfer subassembly 960A, the power transfer subassembly 960A can be inverted where the pair of turbine rim compression applying wheels 963 are located at the lower portion of the power transfer subassembly 960A. In one arrangement, each turbine rim compression applying wheel 963 can be connected to a respective electric generator (similar to the electric generator 740 of the wind operated electrical power generating system 700). In another arrangement, each turbine rim compression applying wheel 963 can be connected to a coupler that collectively transfers rotation of the pair of turbine rim compression applying wheels 963 to a single electric generator (similar to the electric generator 740 of the wind operated electrical power generating system 700).

Any suitable arrangement of one or more biasing elements can be integrated into the power transfer subassembly 960A to retain a compression between the electric generator turbine rim engagement wheel 943 and each of the pair of turbine rim compression applying wheels 963 against the respective contacting surfaces of the power transfer annular ring 944. In a first example, a compression spring can be installed between each of the pair of power transfer support assembly central support pins 965. In a second example, a tensile spring can be installed between the electric generator shaft 942 and the central region of the power transfer support assembly upper arm 966. In a third example, a tensile spring can be installed between the electric generator shaft 942 and each respective compression applying wheel shaft 962. In a fourth example, a tensile spring can be installed between the power transfer support assembly central support pin 965 and each diagonally located compression applying wheel shaft 962.

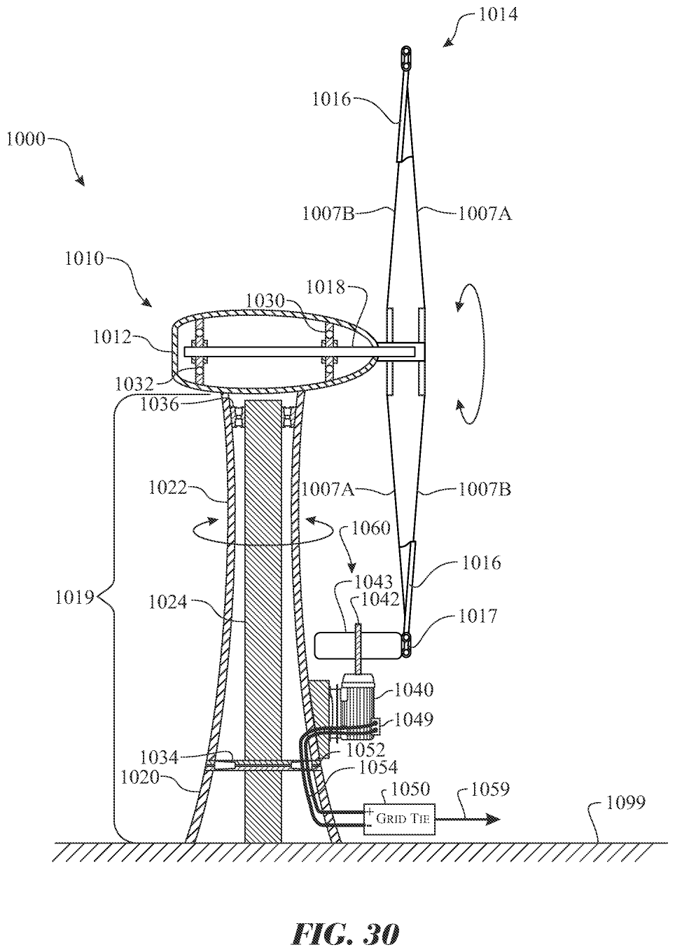

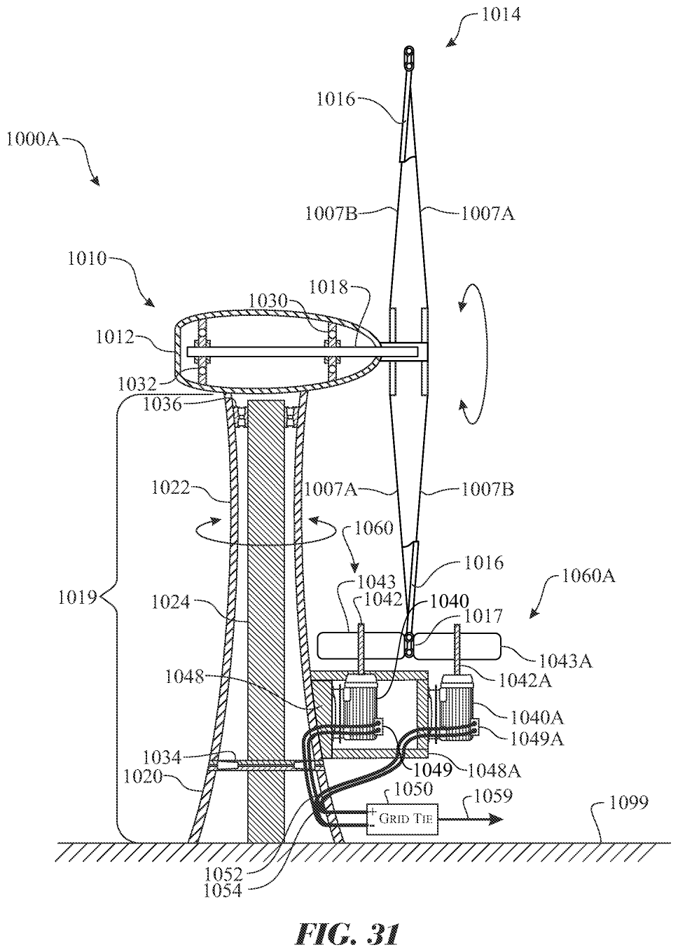

Each of the above exemplary arrangements orient the electric generator turbine rim engagement wheel 743, 843, 943 to rotate about a horizontally extending axis. A wind operated electrical power generating system 1000, illustrated in FIG. 30, introduces an arrangement of a power transfer subassembly 1060 orientating an electric generator turbine rim engagement wheel 1043 to rotate about a vertical axis. The wind operated electrical power generating system 900 and the wind operated electrical power generating system 1000 include a number of like elements with the distinction being in the arrangement of the power transfer design. Like elements of the wind operated electrical power generating system 1000 and the wind operated electrical power generating system 900 are numbered the same, wherein elements of the wind operated electrical power generating system 1000 are preceded by the numeral “10”.

A contacting surface of the electric generator turbine rim engagement wheel 1043 is preferably in horizontal registration with a generally vertical surface of a turbine blade outer rim assembly 1017 of a turbine blade subassembly 1014. The turbine blade subassembly 1014 would be oriented facing the wind. The wind would push the turbine blade subassembly 1014 towards the electric generator turbine rim engagement wheel 1043, thus providing sufficient friction between contacting surfaces of the turbine blade outer rim assembly 1017 and the electric generator turbine rim engagement wheel 1043. Conversely, the electric generator turbine rim engagement wheel 1043 provides a supporting force to the turbine blade subassembly 1014.

One possible consequence of the introduction of the electric generator turbine rim engagement wheel 1043 is that the upper end of the turbine blade subassembly 1014 might flex with the wind. A wind operated electrical power generating system wind operated electrical power generating system 1000′, introduced in FIG. 31, is an enhanced version of the wind operated electrical power generating system 1000 originally introduced in FIG. 30. The wind operated electrical power generating system 1000′ introduces a second power transfer subassembly 1060A, which essentially replicates the elements of the power transfer subassembly 1060. Each of the elements of the second power transfer subassembly 1060A are identified by a suffix “A”. The power transfer subassembly 1060 is supported by an electric generator support component 1048, which is supported by a rotating portion of a vertical riser support structure 1019. The second power transfer subassembly 1060A is supported by a second electric generator support component 1048A, preferably extending horizontally from the rotating portion of a vertical riser support structure 1019. The electric generator turbine rim engagement wheel 1043 and the second electric generator turbine rim engagement wheel 1043A are located on opposite sides of the turbine blade outer rim assembly 1017. The second electric generator turbine rim engagement wheel 1043A provides a responsive force to a force resulting from a torque generated by the wind pushing the upper region of the turbine blade subassembly 1014 towards the electric generator turbine rim engagement wheel 1043. The second electric generator turbine rim engagement wheel 1043A addresses any forces that might be drawing a lower region of the turbine blade subassembly 1014 from the electric generator turbine rim engagement wheel 1043.

The exemplary wind operated electrical power generating systems 700, 800, 900 1000 each include a power transfer subassembly 760, 860, 960, 1060. Each exemplary power transfer subassembly 760, 860, 960, 1060 includes at least one electric generator turbine rim engagement wheel 943 oriented to rotate above an axis that is parallel to a rotational axis of each turbine rim compression applying wheel 963. It is understood that the exemplary power transfer subassembly 760, 860, 960, 1060 can additionally include at least one other rim engaging wheel that rotated about an axis that is substantially perpendicular to the axis of rotation of the at least one electric generator turbine rim engagement wheel 943 and/or the axis of rotation of the each turbine rim compression applying wheel 963.

Each turbine blade 1016 has a significantly longer chord compared to a tri-blade wind turbine. This aids in providing lift in slower winds. In higher winds, this advantage can become detrimental to the overall structure of the wind turbine 200, 700, 800, 900, 1000, as the larger turbine blade area can increase a rotational speed of the turbine wheel assembly 100, 300, 400, 714, 814, 914, 1014; apply an excessive force to the vertical riser support 202, 719, 819, 919, 1019, and cause other undesirable affects on the overall structure of the wind turbine 200, 700, 800, 900, 1000. One suggested solution is to introduce a system that rotates each of the turbine blades 110, as illustrated in FIGS. 3 and 4. Another suggested solution is to include a breakaway feature which allows a trailing edge of the turbine blade turbine blades 110 to temporarily separate from the breakaway anchor 140, as illustrated in FIGS. 5 and 6. This would be included to address a scenario where the turbine wheel assembly is subjected to a significantly excessive wind condition. The breakaway solution can include a tether, wherein the tether keeps each turbine blades 110 from getting damaged. The tether can also be utilized to return the turbine blades 110 to an operating position.

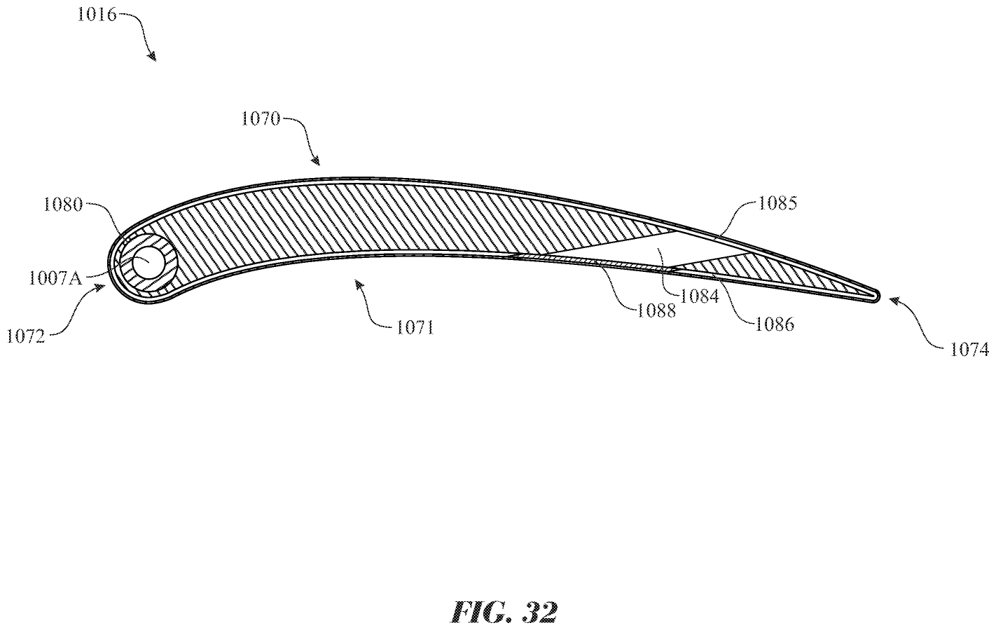

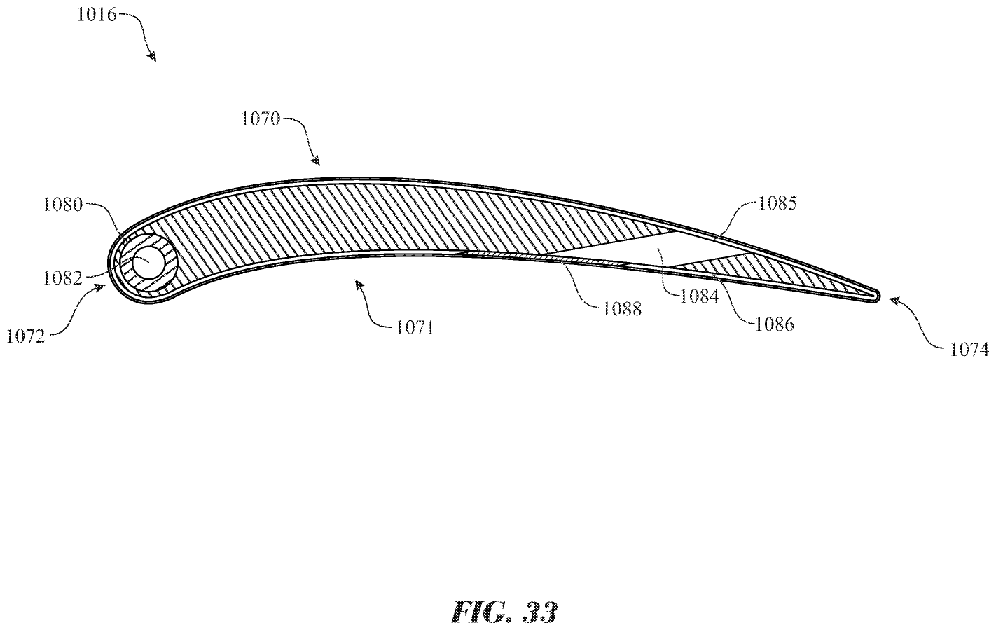

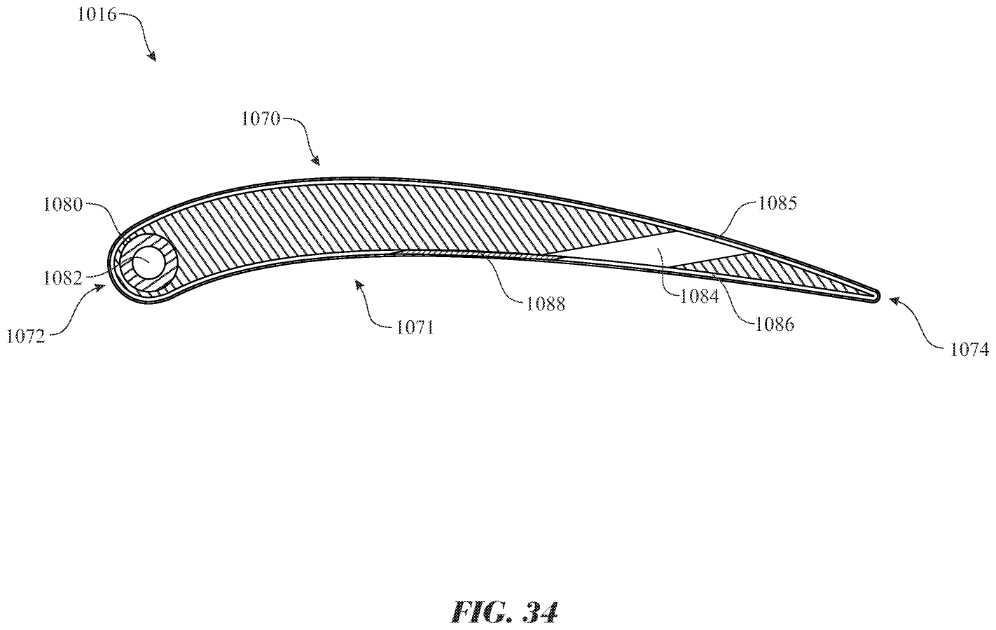

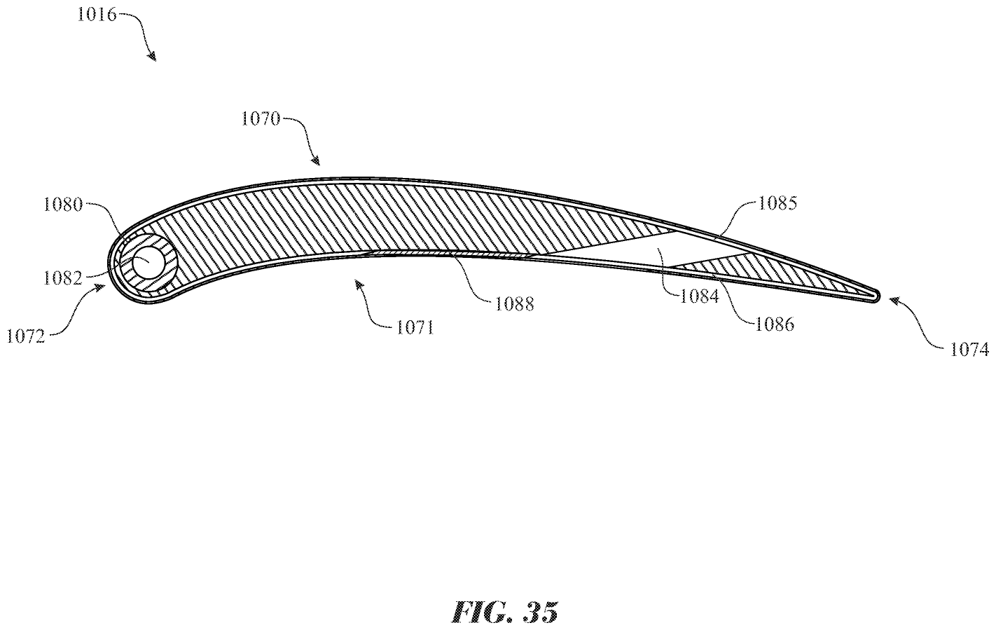

Yet another exemplary solution is illustrated in FIGS. 32 through 35, using the turbine blade 1016 as an exemplary turbine blade, wherein the exemplary solution would be applicable to all of the designs described herein. Orientation of each turbine blade 1016 can be described by defining several characteristics of the turbine blade 1016, including an airfoil leading edge 1072, an airfoil upper surface 1070, an airfoil lower surface 1071, and an airfoil trailing edge 1074. A lift adjusting airflow bypass passageway 1084 would be integrated into the turbine blade 1016, wherein the lift adjusting airflow bypass passageway 1084 passes between the airfoil lower surface 1071 and the airfoil upper surface 1070. The airfoil leading edge 1072 of the turbine blade 1016 can be assembled to the turbine blade subassembly 1014 by inserting the tension airfoil leading spoke 1007A through an airfoil leading edge mount 1080 of the turbine blade 1016. The turbine blade 1016 can preferably pivot about the 1007A via the airfoil leading edge mount 1080. The airfoil trailing edge 1074 of the turbine blade 1016 can be assembled to the turbine blade subassembly 1014 by joining the tension airfoil trailing spoke 1007B to the turbine blade 1016 at a location proximate the airfoil trailing edge 1074. The lift adjusting airflow bypass passageway 1084 is preferably designed having an opening through the airfoil lower surface 1071 is closer to the airfoil leading edge 1072 compared to an opening through the airfoil upper surface 1070. An airfoil upper support 1085 is installed along the airfoil upper surface 1070. An airfoil lower support 1086 is installed along the airfoil lower surface 1071. At least one lift adjusting airflow bypass passageway restriction control panel 1088 is installed to adjust an opening dimension of at least one of the opening through the airfoil lower surface 1071 and the opening through the airfoil upper surface 1070. In the exemplary illustrations, the lift adjusting airflow bypass passageway restriction control panel 1088 is slideably assembled to a track formed in the airfoil lower support 1086. The lift adjusting airflow bypass passageway restriction control panel 1088 would be slideably positioned by any operable device, such as a motor, a motor driving a cable, a motor driving a gear set, a hydraulic piston, a spring compressed/expanded by inertia generated by a rate of rotation of the turbine wheel assembly, or any other suitable operable system. As the wind increases, the lift adjusting airflow bypass passageway restriction control panel 1088 can be repositioned increasing an exposed area of the opening in the respective surface 1070, 1071 of the turbine blade 1016. The lift adjusting airflow bypass passageway restriction control panel 1088 is illustrated in a closed position in FIG. 32. As the wind speed increases, the lift adjusting airflow bypass passageway restriction control panel 1088 is repositioned into a position that partially exposes or opens a small percentage of the opening in the respective surface 1070, 1071 of the turbine blade 1016, as illustrated in FIG. 33, thus reducing the lift generated by the turbine blade 1016. As the wind speed continues to increase, the lift adjusting airflow bypass passageway restriction control panel 1088 is repositioned into a position that exposes or opens a larger percentage of the opening in the respective surface 1070, 1071 of the turbine blade 1016, as illustrated in FIG. 34, thus further reducing the lift generated by the turbine blade 1016. As the wind speed continues to increase more, the lift adjusting airflow bypass passageway restriction control panel 1088 is repositioned into a position that exposes or opens the entire opening in the respective surface 1070, 1071 of the turbine blade 1016, as illustrated in FIG. 35, thus maximizing the reduction in the lift generated by the turbine blade 1016. The process would be reversed to reduce the exposed area of the opening when the wind speed decreases.

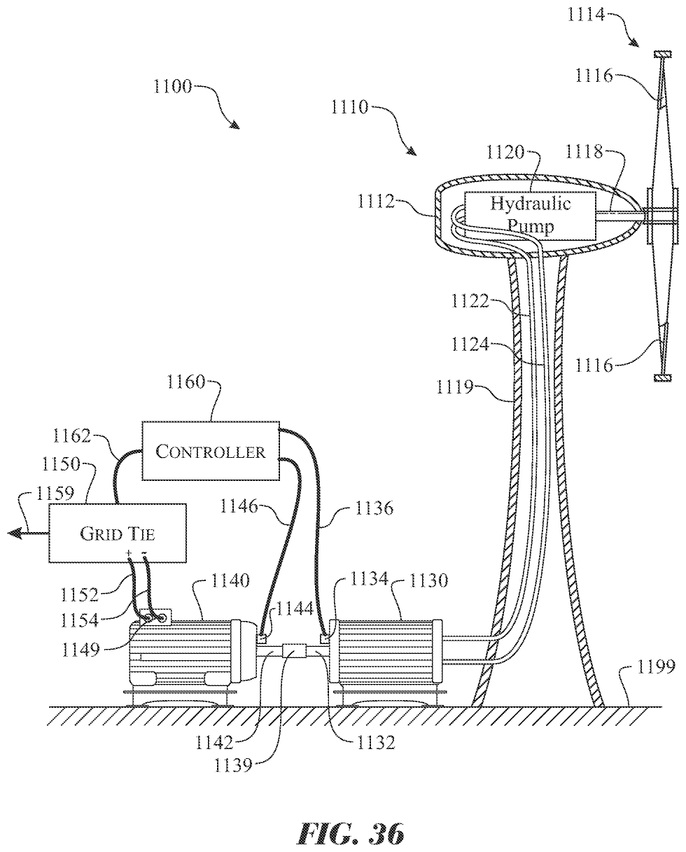

A wind operated electrical power generating system 1100, as shown in an exemplary illustration presented in FIG. 36, introduces another alternative configuration for transferring wind energy to an electric generator 1140. The wind operated electrical power generating system 1100 and the wind operated electrical power generating system 700 include a number of like elements. Like elements of the wind operated electrical power generating system 1100 and the wind operated electrical power generating system 700 are numbered the same, where elements associated with the wind operated electrical power generating system 1100 are preceded by the numeral “11”, except where disclosed herein. The wind operated electrical power generating system 1100 employs a hydraulic system for transferring energy collected from wind to the electric generator 1140. In the exemplary configuration, the vertical riser support structure 1119 is rigidly mounted to the system supporting surface 1199 (similar to the system supporting surface 799). The turbine housing 1112 is preferably located atop a distal end of the vertical riser support structure 1119. The turbine housing 1112 includes various features required for operation of the wind operated turbine assembly 1110. The turbine housing 1112 can be rigidly fixed to the vertical riser support structure 1119 or rotationally carried by the vertical riser support structure 1119. In a configuration where the turbine housing 1112 is rotationally carried by the vertical riser support structure 1119, the turbine housing 1112 would rotate to optimize the directional relationship between the turbine blade subassembly 1114 and the direction of the wind. In the exemplary illustration, the turbine housing 1112 would be rotationally assembled to a distal, free end of the vertical riser support structure 1119.

The hydraulic system includes a hydraulic pump 1120 carried by the turbine housing 1112, a hydraulic motor 1130 distally located from the turbine housing 1112 and preferably carried by the system supporting surface 1199. A pair of hydraulic pipes, tubes or lines 1122, 1124 extends fluid communication between the hydraulic pump 1120 and the hydraulic motor 1130. The hydraulic lines 1122, 1124 can be routed within an interior of the vertical riser support structure 1119, along an interior surface of the vertical riser support structure 1119, along an exterior surface of the vertical riser support structure 1119, or along any other supporting structure. The hydraulic lines 1122, 1124 can be fabricated of any suitable material. The hydraulic lines 1122, 1124 can be fabricated of a rigid material, such as PVC, copper, and the like, of a flexible material, such as plastic, nylon, rubber, and the like, or any combination thereof. The structure of the hydraulic lines 1122, 1124 can be rigid or include features to introduce flexure.

The hydraulic motor 1130 is assembled in rotational communication with an electric generator 1140. The hydraulic motor 1130 includes a hydraulic motor shaft 1132 that is rotationally driven by fluid flowing through the hydraulic lines 1122, 1124. The electric generator 1140 includes an electric generator shaft 1142, which is arranged in rotational communication with the hydraulic motor shaft 1132 of the hydraulic motor 1130. The hydraulic motor 1130 and electric generator 1140 are preferably rigidly mounted in a manner that provides and maintains dynamic alignment between the hydraulic motor shaft 1132 and the electric generator shaft 1142. In the exemplary embodiment, the hydraulic motor shaft 1132 and the electric generator shaft 1142 are coupled to one another using a shaft coupling 1139. It is understood that the operational engagement can transfer a rotational force from the hydraulic motor shaft 1132 to the electric generator shaft 1142 using any suitable interface, including one or more gears, a clutch, a transmission, and the like.

A power control module 1160 can be integrated into the wind operated electrical power generating system 1100 to optimize power. The power control module 1160 monitors the rotational speed of either shaft 1132, 1142. The wind operated electrical power generating system 1100 can include at least one of a hydraulic motor shaft rotational speed sensor 1134 and an electric generator shaft rotational speed sensor 1144. The hydraulic motor shaft rotational speed sensor 1134 would be arranged to monitor the rotational speed of the hydraulic motor shaft 1132. A hydraulic motor shaft rotational speed sensor signal communication link 1136 provides signal communication between the hydraulic motor shaft 1132 and the power control module 1160. The electric generator shaft rotational speed sensor 1144 would be arranged to monitor the rotational speed of the electric generator shaft 1142. An electric generator shaft rotational speed sensor signal communication link 1146 provides signal communication between the electric generator shaft 1142 and the power control module 1160. The power control module 1160 can operate using the hydraulic motor shaft rotational speed sensor 1134, the electric generator shaft rotational speed sensor 1144 or both. It is understood that the power control module 1160 can include compensation information when gears, a transmission, or any other ratio translating interface is integrated between the hydraulic motor shaft 1132 and the electric generator shaft 1142. The components of the power control module 1160 can be assembled into and/or onto a power controller enclosure 1164.

The controller governs the power output from the electric generator 1140 to a grid tie 1150. The power control module 1160 is in electric communication with the grid tie 1150 using a power control module electrical communication link 1162. Alternatively, the power control module 1160 can be in electric communication with the electric generator 1140 to accomplish the same end result using an alternate power control module electrical communication link 761.

Electrical power generated during operation of the electric generator 1140 is transferred from the electric generator 1140 through an electric output panel 1149. In the exemplary embodiment, a pair of electrical output cables (a positive electrical output cable 1152 and a negative electrical output cable 1154) is used to provide electric communication between the electric generator 1140 and the grid tie 1150. The grid tie 1150 provides electrical communication between at least one of the controller 1160 and the generator 1140 and an electric power grid 1159. The generated electric power is transferred to a power grid 1159 for use.

In operation, rotation of the turbine blade subassembly 1114 is transferred to the hydraulic pump 1120 by the turbine blade subassembly shaft 1118. The rotational input to the hydraulic pump 1120 generates a hydraulic fluid flowing down the first hydraulic line 1122 and returning through the second hydraulic line 1124. The hydraulic fluid flows through the hydraulic motor 1130 causing the hydraulic motor 1130 to rotate. The rotational motion of the hydraulic motor shaft 1132 created by the hydraulic fluid flow drives a rotation of the electric generator shaft 1142. The rotational motion of the electric generator shaft 1142 powers the electric generator 1140 to generate electric power. The electric power is fed to the electric output panel 1149, which distributes the generated electric power through any number of electrical output cables 1152, 1154. It is understood that a grounding connection can be provided through a casing, frame, or other electrically conductive component of the electric generator 1140.

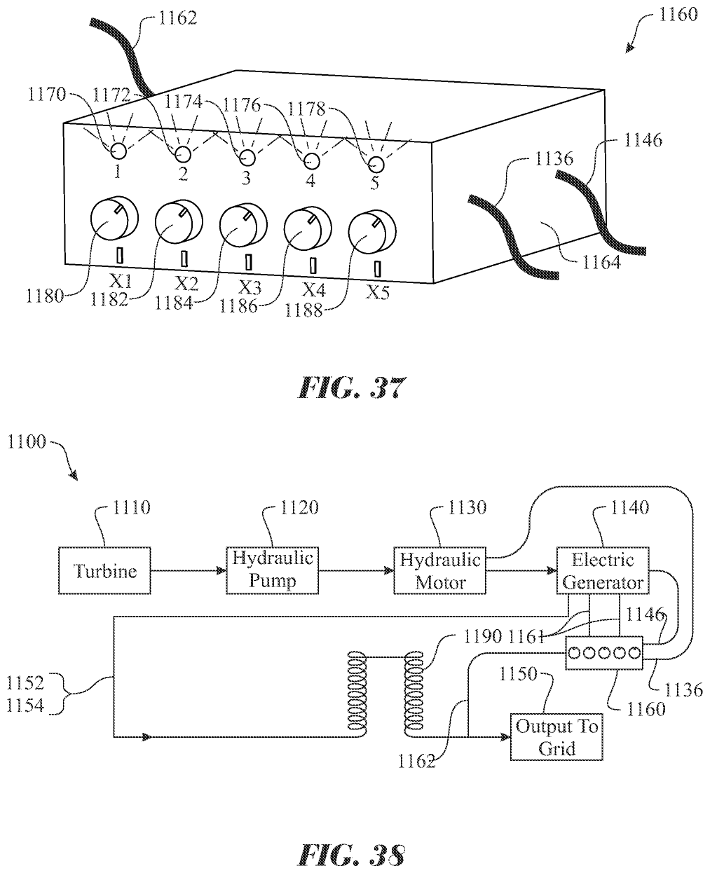

The power control module 1160 is integrated into the wind operated electrical power generating system 1100 to optimize or maximize electric output. Details of the power control module 1160 are provided in FIG. 37. Integration of the power control module 1160 is illustrated in an exemplary schematic diagram shown in FIG. 38.

The power control module 1160 includes a circuit that monitors the rotational speed of either or both of the hydraulic motor shaft 1132 and electric generator shaft 1142 using the hydraulic motor shaft rotational speed sensor 1134 and/or the electric generator shaft rotational speed sensor 1144. The circuit includes a microprocessor, a digital memory device, at least one rotational speed indicator and at least one potentiometer (variable resistor) 1180, 1182, 1184, 1186, 1188, wherein each of the at least one potentiometer (variable resistor) 1180, 1182, 1184, 1186, 1188 is associated with a respective rotational speed indicator 1170, 1172, 1174, 1176, 1178 of the at least one rotational speed indicator 1170, 1172, 1174, 1176, 1178. The rotational speed indicator can be any suitable alert, including an audible alert, a visual alert, a transmitted message, a tactile alert, and the like, and any combination thereof. The audible alert can be a continuous audible signal, a cyclical or pulsed audible signal, a siren, and the like. The visual alert can be a continuously illuminated light, a flashing light, a light changing color, and the like. The light can be a Light Emitting Diode (LED), an incandescent bulb, a fluorescent bulb, and the like. A transmitted message can be a text message, an email, a broadcast message, an audible or recorded message, an audible message transmitted to a cellular phone, and the like.

Each employed rotational speed sensor 1134, 1144 is in signal communication with the microprocessor by any suitable communication element, including hardwired, wireless, magnetic communication, and the like, and any combination thereof. As the rotational speed of the shafts 1132, 1142 approach a predetermined rotational speed, the associated rotational speed indicator 1170, 1172, 1174, 1176, 1178 changes state to alert an individual monitoring the system. The individual monitoring the system would subsequently adjust the associated potentiometer (variable resistor) 1180, 1182, 1184, 1186, 1188 to optimize the electric power output. Each of the rotational speed indicators 1170, 1172, 1174, 1176, 1178 is associated with a specific predetermined rotational speed. It is understood that the predetermined rotational speed can be programmable, adjustable, or automatically determined by an algorithm programmed into the microprocessor/memory. The change in resistance is conveyed through the power control module electrical communication link 1162. It is understood that any suitable circuitry can be employed to introduce the variable resistance from the associated potentiometer (variable resistor) 1180, 1182, 1184, 1186, 1188 into the electric circuit of the electric generator 1140 and/or the grid tie 1150, such as integration of a transformer 1190. Although the exemplary power control module 1160 presents a manual implementation, it is understood that the process can be automated.

The exemplary schematic diagram shown in FIG. 38 additionally illustrates the interaction between each of the primary components, as previously described herein.

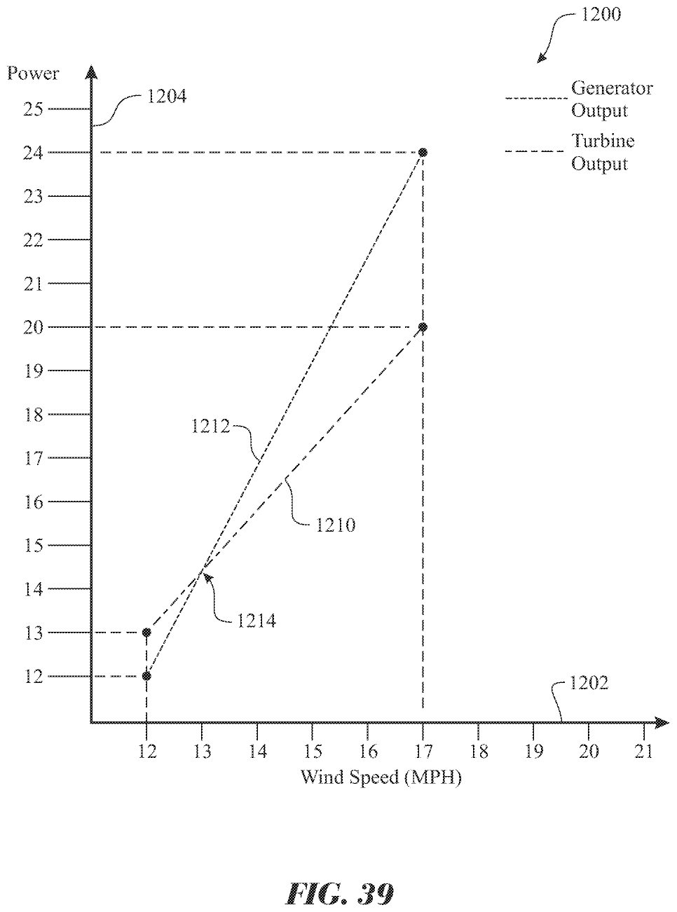

An exemplary power output chart 1200 is presented in FIG. 39. The power output chart 1200 plots a power output based upon a rotational speed of each of a generator (illustrated as a turbine theoretical output power curve 1210) and a wind turbine (illustrated as a generator theoretical output power curve 1212). The rotational speed of the associated element is referenced along a rotational speed axis 1202. The output power of the associated element is referenced along a power output axis 1204. The power output of the generator increases at a greater rate compared to the output of the turbine. The speed in which the generator theoretical output power curve 1212 crosses over the turbine theoretical output power curve 1210 defines a stall point 1214. It is desired to optimize the electric power output by the generator, wherein the electric power output by the generator remains slightly below the power output by the turbine.

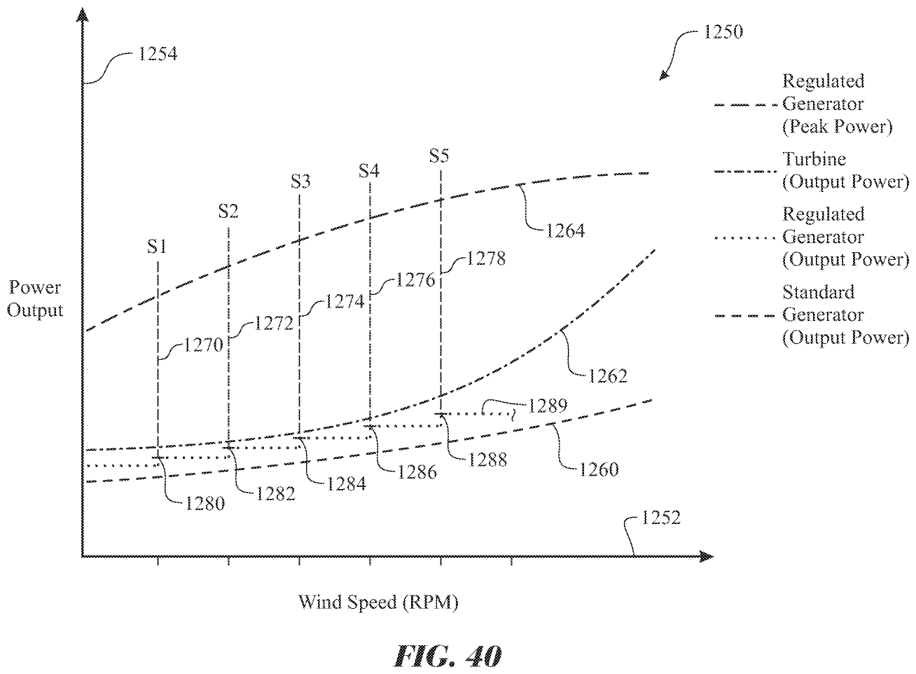

An exemplary power output chart 1250 is presented in FIG. 40 by plotting a power output (that is associated with a wind speed. The wind or associated rotational speed is referenced along a wind speed generated RPM axis 1252. The output power of the associated element is referenced along a power output axis 1254.

The current technology employs a generator that has a lower output than the power captured by the wind operated turbine assembly 1110. The infrastructure is configured in this manner to avoid overpowering the turbine, where a larger or excessive generator would overdrive the turbine. Alternatively stated, if the power extracted from the wind operated turbine assembly 1110 is greater than the 100% of the power allowed by the wind operated turbine assembly 1110, the wind operated turbine assembly 1110 stalls. Therefore, it had been established that the generators should remain below the stall point of the associated turbine 1110. This principle was understood to be a fundamental requirement, thus limiting the power output to the maximum capabilities of the currently utilized generators. An exemplary input, or power captured by the wind operated turbine assembly 1110, is represented by a turbine power curve 1262. The associated power output using currently deployed generators is represented by a current generator curve 1260. The vertical gap between the turbine power curve 1262 and the current generator curve 1260 depicts losses.

Conversely, implementation of a larger generator in conjunction with the power control module 1160 enables optimization of the power output while avoiding overpowering or governing the wind operated turbine assembly 1110. The associated power output using a regulated generator is represented by a regulated generator curve 1264, wherein the regulated generator creates excessive power or power greater than the power obtained by the turbine 1110. Power optimization is accomplished by introducing a variable resistance into the electric network. The process is further optimized by monitoring for predetermined rotational speeds 1270, 1272, 1274, 1277, 1278 of the electric generator 1140 (or calibrated to determine an associated rotational speed) and adjusting the resistance accordingly by adjusting an associated potentiometer (variable resistor) 1180, 1182, 1184, 1186, 1188. The goal is to maintain or govern a power output, identified as an adjusted power output 1280, 1282, 1284, 1286, 1288 at a level slightly less than the power obtained by the wind operated turbine assembly 1110. The power output chart 1250 illustrates the small gap between each adjusted power output point 1280, 1282, 1284, 1286, 1288 and the associated curve of the turbine power curve 1262. The power output remains constant, independent of the speed of rotation of the turbine blade assembly 1114, as illustrated by the regulated power output curve 1289. The resulting regulated power output curve 1289 has a step curve shape. The exemplary power output chart 1250 illustrates the additional electric power output at each respective rotational speed 1270, 1272, 1274, 1277, 1278 compared to the power output from the standard generator 1260. The gap parallel to the power output axis 1254 between each adjusted power output level 1280, 1282, 1284, 1286, 1288 and the associated power output level of the standard generator 1260 defines the increase in power output, based upon the same energy created by the wind operated turbine assembly 1110. Those skilled in the art would understand that the number of predetermined rotational speeds 1270, 1272, 1274, 1277, 1278 and the number of associated potentiometer (variable resistor) 1180, 1182, 1184, 1186, 1188 can vary based upon the characteristics and engineering of the system.

In operation, as the rotational speed approaches each predetermined rotational speed, the respective rotational speed indicator 1170, 1172, 1174, 1176, 1178 converts to a notification state. The service person adjusts the associated potentiometer (variable resistor) 1180, 1182, 1184, 1186, 1188 to optimize the power output to the desired level of slightly lower than the turbine power curve 1262. The associated potentiometer (variable resistor) is in electrical communication 761 with the electric generator 760, providing a varied resistance or load to the electric generator 760. The increased load acts as a brake and decreases the rotational speed of the turbine blade subassembly 1114. By varying the electric load, the rotational speed of the turbine blade subassembly 1114 changes to optimize the power generated across many different bands of rotational speeds.

Although the exemplary embodiment integrates a controller 1160 into a system employing a hydraulically driven system, it is understood that the power control module 1160 can be integrated into any system employing a wind driven turbine used to power an electric generator.

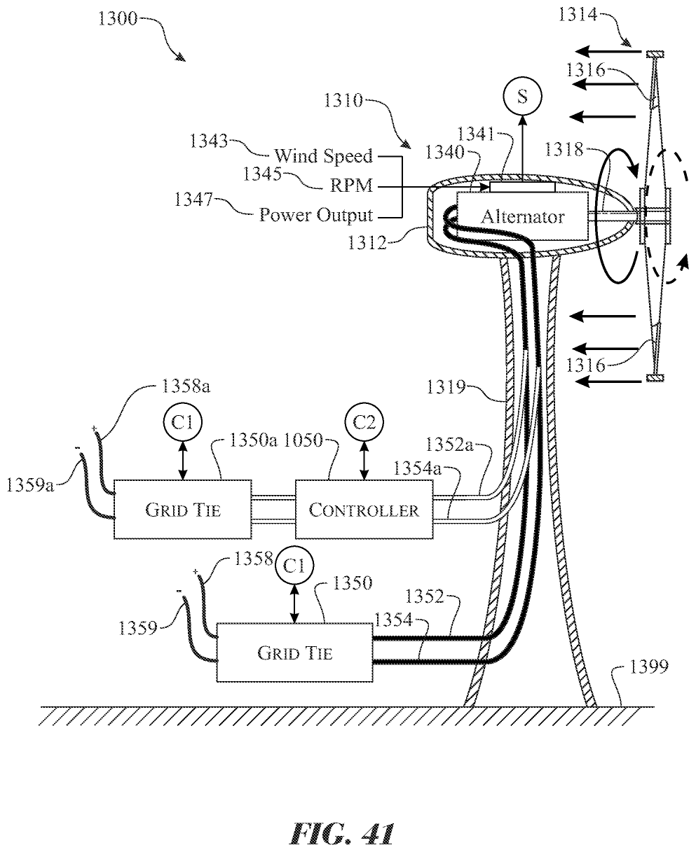

A wind operated electrical power generating system 1300, illustrated in FIG. 41, presents a more conventional arrangement of a wind operated electrical power generating system. The wind operated electrical power generating system 1300 and the wind operated electrical power generating system 1100 include a large number of like elements. Like elements of the wind operated electrical power generating system 1100 and the wind operated electrical power generating system 1300 are numbered the same, where the elements of the wind operated electrical power generating system 1100 are preceded by the numeral “11” and elements of the wind operated electrical power generating system 1300 are preceded by the numeral “13”. The distinctions between the wind operated electrical power generating system 1100 and the wind operated electrical power generating system 1300 are described below.

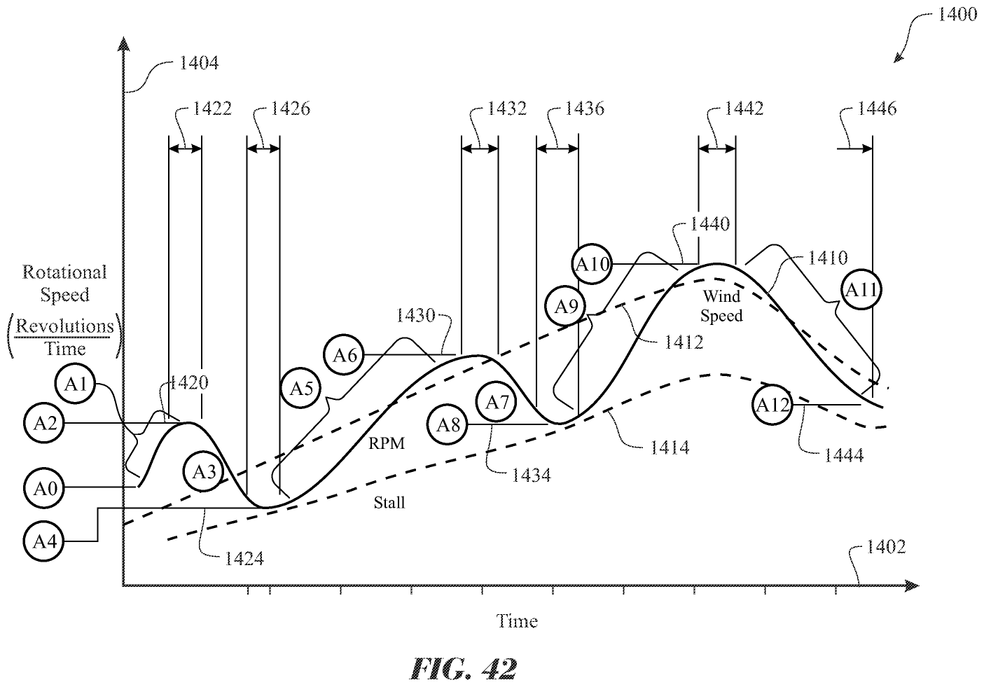

The wind operated electrical power generating system 1300 employs a turbine blade subassembly 1314 to mechanically drive an electrical power generating machine 1340. The turbine blade subassembly 1314 rotates a turbine blade subassembly shaft 1318. The rotation of the turbine blade subassembly shaft 1318 can directly rotate a like shaft of an electrical power generating machine 1340 or utilize a gear set or a transmission to drive the shaft of the electrical power generating machine 1340. A sensor system 1341 is employed to obtain various operating parameters of the wind operated electrical power generating system 1300, including but not limited to a wind speed sensor 1343, an electrical power generating machine rotational speed sensor 1345, a power output sensor 1347 and the like. The sensor system 1341 can include a communication circuit for conveying the acquired operating parameters to a wind speed—load chart for wind turbine arrangement 1400 (introduced in FIG. 42).

Electrical power generated by the electrical power generating machine 1340 is transferred to a grid via a positive electrical output cable 1352 and a negative electrical output cable 1354, which transfer the electrical power from the electrical power generating machine 1340 to a grid tie 1350. The power is then injected into the power grid via a positive power grid electrical connection 1358 and a negative power grid electrical connection 1359. Although the exemplary illustrations present a positive power grid electrical connection 1358 and a negative power grid electrical connection 1359, it is understood that any suitable electrically conductive arrangement can be utilized, including, but not limited to, a three phase arrangement.

In an alternative arrangement, electrical power generated by the electrical power generating machine 1340 is transferred to a grid via a positive electrical output cable 1352a and a negative electrical output cable 1354a, which transfer the electrical power from the electrical power generating machine 1340 to a loading controlled grid tie 1350a via an efficiency management system load management subsystem 1550 (detailed in FIG. 45). The efficiency management system load management subsystem 1550 manages a loading applied to the system, where the loading optimizes the efficiency of the turbine blade subassembly 1314 respective to wind speed. The power is then injected into the power grid via a positive power grid electrical connection 1358a and a negative power grid electrical connection 1359a.

Although the exemplary embodiments are directed towards a wind powered system, it is understood that the same power optimization system can be applied to a water driven turbine system.

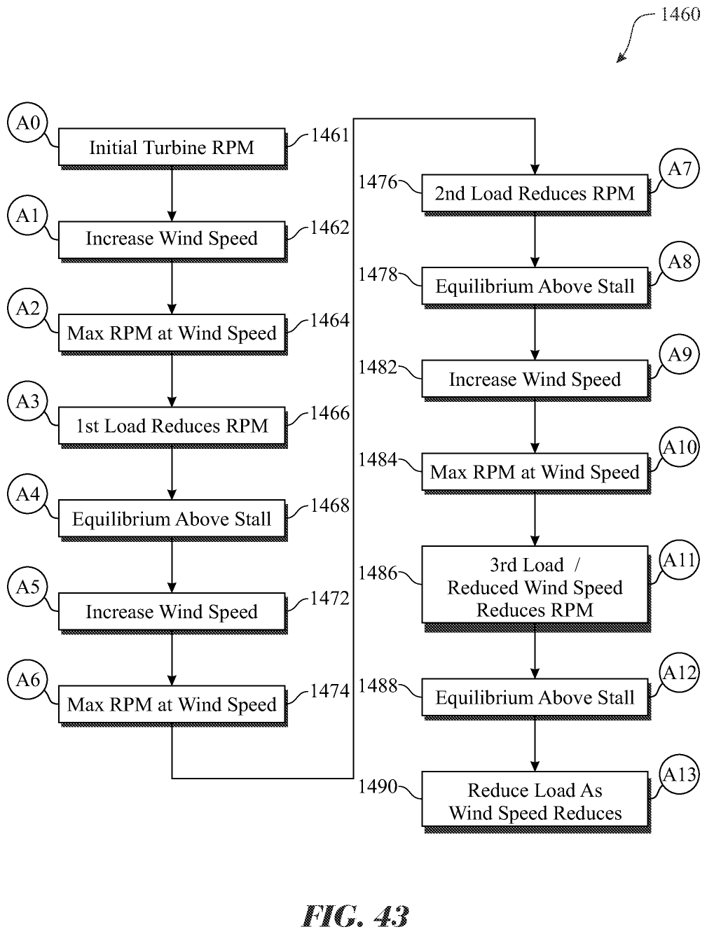

The efficiency of the wind operated electrical power generating system 1100 and the wind operated electrical power generating system 1300 can be optimized by applying and removing loads at various operating conditions, as illustrated in a wind speed—load chart for wind turbine arrangement 1400 presented in FIG. 42 in conjunction with the wind turbine optimization process 1460 illustrated in FIG. 43.

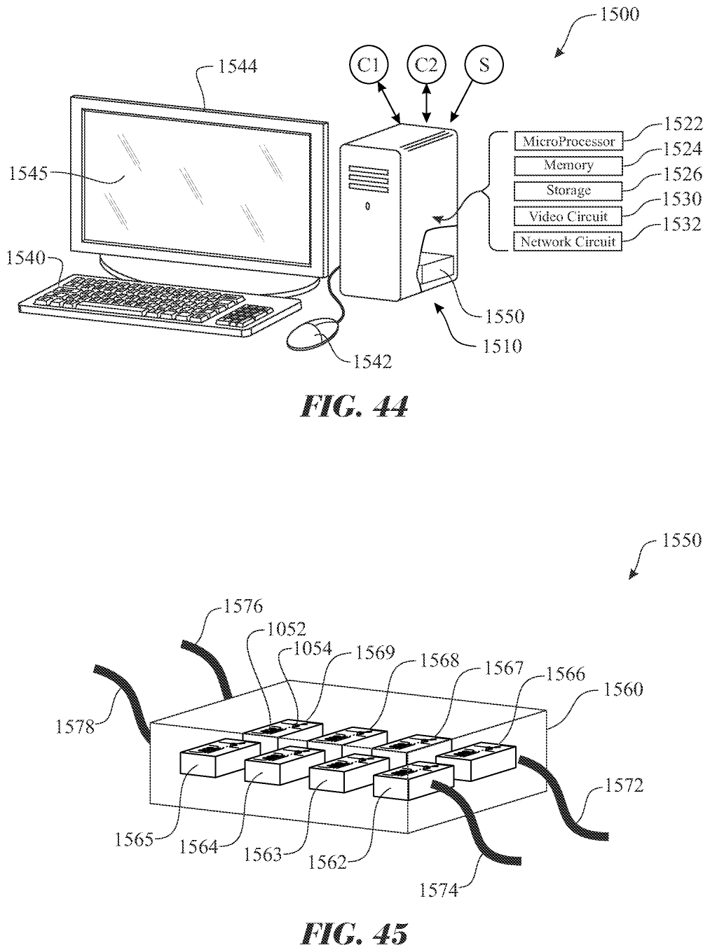

Implementation of the wind speed—load chart for wind turbine arrangement 1400 upon the wind operated electrical power generating system 1100 and the wind operated electrical power generating system 1300 is accomplished by using an efficiency management system 1500, introduced in FIG. 44. The efficiency management system 1500 includes an efficiency management system computer 1510. The efficiency management system computer 1510 can be any suitable computing device which is characterized by an inclusion of a microprocessor 1522, a memory 1524 in signal communication with the microprocessor 1522, and a digital storage device 1526 in signal communication with the microprocessor 1522. In addition to basic computing devices, the efficiency management system 1500 preferably includes a video circuit 1530 in signal communication with the microprocessor 1522, and a communication or network circuit 1534 in signal communication with the microprocessor 1522. The communication or network circuit 1534 enables communication between the efficiency management system computer 1510 and the sensor system 1341, the grid communication link C1, and the controller communication link C2. Power would be provided to the efficiency management system 1500 using any suitable power source, including power supplied from the wind speed—load chart for wind turbine arrangement 1400, the power supplied from the grid, a portable power supply (such as an uninterrupted power supply (UPS), a battery, etc.), a generator and the like.

The efficiency management system computer 1510 communicates with the user via any suitable user interface or interfaces. Examples illustrated include a keyboard 1540, a pointer device 1542, and a monitor 1544 having a monitor display 1545. The keyboard 1540 can be a wired keyboard, a wireless keyboard, or a virtual keyboard. The keyboard can be provided in any arrangement. The pointer device 1542 can be any pointer device, including a mouse, a trackball, a track pad, a pen and tablet, or any other suitable pointing device. The monitor 1544 can include a standard display or a touch screen display. In an arrangement where the monitor 1544 is a touch screen, the efficiency management system computer 1510 can include or exclude the keyboard 1540 and/or the pointer device 1542.

An efficiency management system load management subsystem 1550 is in signal communication between the efficiency management system computer 1510 and the wind operated electrical power generating system 1300. The efficiency management system load management subsystem 1550 can be arranged as a separate component or integrated into the efficiency management system computer 1510 as illustrated in FIG. 44. The efficiency management system load management subsystem 1550 includes a series of relays 1562, 1563, 1564, 1565, 1566, 1567, 1568, 1569 that provide a load. The load can be adjusted by changing the number of activated relays 1562, 1563, 1564, 1565, 1566, 1567, 1568, 1569. Each relay 1562, 1563, 1564, 1565, 1566, 1567, 1568, 1569 includes an electromagnetic coil 1552 operated by a switch 1554. Each relay may be arranged to introduce or remove a resistor or any other electrical element from the circuit, where the introduction of the electrical element would impact the rotational rate of the turbine blade subassembly 1314 as well as the electrical power generated by the electrical power generating machine 1340. In an alternative arrangement, the relay can operate a resistor. The efficiency management system load management subsystem 1550 can be integral with the efficiency management system computer 1510 (as shown in FIG. 44), packaged within an efficiency management system load management subsystem enclosure 1560 (as shown in FIG. 45), or both (where the subassembly as illustrated in FIG. 45 is installed within the efficiency management system computer 1510).

A first portion of a load circuit is provided to the efficiency management system load management subsystem 1550 via a positive input conductor 1572 and a negative input conductor 1574 (or any suitable electrically conductive arrangement). The load is introduced to the load circuit and the load circuit is completed via a positive output conductor 1576 and a negative output conductor 1578 (or any suitable electrically conductive arrangement).

The loading is determined based upon operating conditions of the wind speed—load chart for wind turbine arrangement 1400. The goal is to maintain a rotational speed of the turbine blade subassembly 1314 at a rate that is slightly above stall 1414. Stall is a condition where the turbine blade subassembly 1314 experiences a sudden reduction in the lift generated by the aerofoil shape of the turbine blade 1316 when the critical angle of attack is reached or exceeded. The angle of attack is the angle at which relative wind meets the aerofoil. The angle of attack is the angle formed by the chord CH of the aerofoil and the direction of the relative wind or the vector representing the relative motion between the turbine blade subassembly 1314 and the direction of the wind.

Details of a process of optimizing the wind operated electrical power generating system 1300 are provided by the wind speed—load chart for wind turbine arrangement 1400 illustrated in FIG. 42 and the respective wind turbine optimization process 1460 presented in FIG. 43. The wind speed—load chart for wind turbine arrangement 1400 provides a visual representation of a process for optimizing an efficiency of the wind speed—load chart for wind turbine arrangement 1400. The wind speed—load chart for wind turbine arrangement 1400 operates at optimal efficiency where the turbine blade subassembly 1314 is rotating at a rotational rate that is approximately near a stall. A load is applied to a circuit associated with the electrical power generating machine 1340, where when the load is applied to the circuit, the load causes a reduction in a rotational rate of the turbine blade subassembly 1314. When the turbine blade subassembly 1314 is subjected to an excessive load level, the wind would not be sufficient to rotate the turbine blade subassembly 1314. When the turbine blade subassembly 1314 is subjected to an insufficient load level, the turbine blade subassembly 1314 would rotate at an excessively high rotational rate, which can cause overheating of the electrical power generating machine 1340, prematurely wear bearings of the turbine blade subassembly 1314 and/or the electrical power generating machine 1340, excessive stress on the turbine blades 1316 and the remaining components of the turbine blade subassembly 1314, and the like.

The wind speed—load chart for wind turbine arrangement 1400 presents a revolutions per minute (rotational speed) 1410 of the turbine blade subassembly 1314, a wind velocity 1412 of a wind subjected to the turbine blade subassembly 1314, and a stall speed 1414 of the turbine blade subassembly 1314 based upon a respective wind velocity 1412. The curves are placed upon a chart having a time axis 1402 along a horizontal axis and a wind velocity axis 1404 along a vertical axis. It is noted that the rotational speed and the stall speed (also a rotational speed) parallel the wind velocity axis 1404, where the lower values are near the origin and the values increase as the distance from the origin increases.

Use of the wind operated electrical power generating system 1300 initiates at an initial turbine rotational speed 1461 identified by marker A0 accordingly. The turbine blade subassembly 1314 would be rotating at a constant rate that is slightly above the stall speed 1414 at a respective wind velocity 1412. The wind velocity 1412 includes a wind speed and can include a wind direction, where the wind direction may be defined by cardinal directions (referenced geographical or using true north) or respective to an orientation of the turbine blade subassembly 1314. As a wind velocity 1412 increases (increase in wind speed (step 1462)) (marker A1), the revolutions per minute (rotational speed) 1410 of the turbine blade subassembly 1314 also increases. As the revolutions per minute (rotational speed) 1410 increases, the revolutions per minute (rotational speed) 1410 reaches an undesirable revolutions per minute (rotational speed) 1410 or maximum desired rotational speed at wind speed (step 1464) (marker A2), the efficiency management system computer 1510 directs the efficiency management system load management subsystem 1550 to apply a determined quantity of a load. Marker A2 identifies a first maximum desired rotational rate at wind speed 1420. The quantity of load would be determined based upon the wind velocity 1412 and a calculated stall speed 1414 based upon the wind velocity 1412. The efficiency management system computer 1510 would calculate a quantity of load to reduce the revolutions per minute (rotational speed) 1410 of the turbine blade subassembly 1314 to a rate that is slightly above the stall speed. The calculations can be accomplished using past data, calculations, and/or artificial intelligence. As the calculated quantity of load is applied to the circuit, the rotational speed of the turbine blade subassembly 1314 exhibits a first load application transition period 1422. Once the quantity of load is applied, the rotational speed of the turbine blade subassembly 1314 is reduced in accordance with an introduced 1st load reduces rotational speed (step 1466) (marker A3). It is noted that the wind velocity 1412 remains the same, while the revolutions per minute (rotational speed) 1410 is reduced. The revolutions per minute (rotational speed) 1410 would be reduced to a rotational speed that is slightly above stall speed 1414 in accordance with rotational speed reaches equilibrium above stall (step 1468) (marker A4). Marker A4 identifies a first target minimal rotational rate at wind speed to induce load 1424. As the rotational speed of the turbine blade subassembly 1314 reaches equilibrium between the newly applied increased loading and the currently increasing wind velocity 1410 (at the rotational rate that is slightly above stall) the rotational rate of the turbine blade subassembly 1314 would transition from a braking to an acceleration (first minimum rotational rate transition period 1426), again beginning to increase the rotational rate 1410.

In the exemplary wind speed—load chart for wind turbine arrangement 1400, the wind velocity 1412 continues to increase (increase in wind speed (step 1472)) (marker A5). As a wind velocity 1412 continues to increase (increase in wind speed (step 1472)) (marker A5), the revolutions per minute (rotational speed) 1410 of the turbine blade subassembly 1314 also increases. As the revolutions per minute (rotational speed) 1410 increases, the revolutions per minute (rotational speed) 1410 (already restrained by a 1st applied load) again approaches an undesirable revolutions per minute (rotational speed) 1410 or maximum desired rotational speed at wind speed (step 1474) (marker A6), the efficiency management system computer 1510 directs the efficiency management system load management subsystem 1550 to apply an increased determined quantity of a load. Marker A6 identifies a second maximum desired rotational rate at wind speed 1430. The increased quantity (or second total) of load would be determined based upon the wind velocity 1412 and a calculated stall speed 1414 based upon the wind velocity 1412. The efficiency management system computer 1510 would calculate an increased quantity (or second total) of load to, again, reduce the revolutions per minute (rotational speed) 1410 of the turbine blade subassembly 1314 to a rate that is slightly above the stall speed based upon the current wind velocity 1412. The calculations for the new, increased load can be accomplished using past data, calculations, and/or artificial intelligence. As the calculated increasing quantity of load is applied to the circuit, the rotational speed of the turbine blade subassembly 1314 exhibits a second load application transition period 1432. Once the quantity of load is applied, the rotational speed of the turbine blade subassembly 1314 is reduced in accordance with an introduced 2nd load reduces rotational speed (step 1476) (marker A7). It is noted that the current wind velocity 1412 remains the same, while the revolutions per minute (rotational speed) 1410 is again reduced. The revolutions per minute (rotational speed) 1410 would be reduced to a rotational speed that is slightly above stall speed 1414 in accordance with rotational speed reaches equilibrium above stall (step 1478) (marker A8). Marker A8 identifies a second target minimal rotational rate at wind speed to induce load 1434. As the rotational speed of the turbine blade subassembly 1314 again reaches equilibrium between the newly applied increased loading and the continued increasing wind velocity 1410 (at the rotational rate that is slightly above stall) the rotational rate of the turbine blade subassembly 1314 would transition from a braking to an acceleration (second minimum rotational rate transition period 1436), again beginning to increase the rotational rate 1410.

The exemplary wind speed—load chart for wind turbine arrangement 1400 illustrates a scenario where the process is repeated a third time, where the wind velocity 1412 continues to increase (increase in wind speed (step 1482)) (marker A9). As a wind velocity 1412 continues to increase 1482 (marker A9), the revolutions per minute (rotational speed) 1410 of the turbine blade subassembly 1314 also increases. As the revolutions per minute (rotational speed) 1410 increases, the revolutions per minute (rotational speed) 1410 (already restrained by a 2nd applied load) again approaches an undesirable revolutions per minute (rotational speed) 1410 or maximum desired rotational speed at wind speed (step 1484) (marker A10), the efficiency management system computer 1510 directs the efficiency management system load management subsystem 1550 to apply an additional increased determined quantity of a load. Marker A10 identifies a third maximum desired rotational rate at wind speed 1440. The additional increased quantity (or second total) of load would be determined based upon the wind velocity 1412 and a calculated stall speed 1414 based upon the wind velocity 1412. The efficiency management system computer 1510 would calculate an increased quantity (or second total) of load to, again, reduce the revolutions per minute (rotational speed) 1410 of the turbine blade subassembly 1314 to a rate that is slightly above the stall speed based upon the current wind velocity 1412. The calculations additionally take into account a predicted future wind velocity 1412. The predicted future wind velocity 1412 is based upon a recent history of the wind velocity 1412.

The calculations for the new, increased load can be accomplished using past data, calculations, and/or artificial intelligence. As the calculated increasing quantity of load is applied to the circuit, the rotational speed of the turbine blade subassembly 1314 exhibits a third load application transition period 1442. During the third load application transition period 1442, the efficiency management system 1500 recognizes that the wind velocity 1412 is changing from an increasing rate to a decreasing rate. Once the quantity of load is applied, the rotational speed of the turbine blade subassembly 1314 is reduced in accordance with a third minimum rotational rate transition period 1446 (introduced 3rd load reduces rotational speed (step 1486)) (marker A11). It is noted that the current wind velocity 1412 remains the same and is presenting signs of reducing an increase in speed or actually decreasing in speed, while the revolutions per minute (rotational speed) 1410 is again reduced. This change is taken into account in the calculations used to determine an increase in loading as well as a consideration for time period before a subsequent analysis. The time period before a subsequent analysis might be reduced to ensure the proper load is provided into the circuit. In this exemplary scenario, as the rotational speed 1410 is decreasing, the wind velocity 1412 is also decreasing. The revolutions per minute (rotational speed) 1410 would be reduced to a rotational speed that is slightly above stall speed 1414 in accordance with rotational speed reaches equilibrium above stall (step 1488) (marker A12). Marker A12 identifies a third target minimal rotational rate at wind speed to induce load 1444. In the exemplary wind speed—load chart for wind turbine arrangement 1400, the wind velocity 1412 is reduced sufficiently at the rotational speed reaches equilibrium above stall (step 1488) (marker A12) where the efficiency management system 1500 would consider and reduce the applied load to the circuit by deactivating the relays 1562, 1563, 1564, 1565, 1566, 1567, 1568, 1569 of the efficiency management system load management subsystem 1550, thus reducing the load as wind speed reduces (step 1490) (marker A13). The process would continue accordingly.

When the wind velocity 1412 increases, the efficiency management system 1500 would analyze the conditions and determine whether to apply or increase a load to the circuit and when the wind velocity 1412 decreases, the efficiency management system 1500 would analyze the conditions and determine whether to decrease any load applied to the circuit.

Although the exemplary wind speed—load chart for wind turbine arrangement 1400 and respective wind turbine optimization process 1460 employs one or more loads applied to the circuit, it is understood that other implementations can be utilized. For example, the wind speed-load chart for wind turbine arrangement 1400 can modify an angle of attack of each turbine blade 1316 using any suitable method, such as those described herein.

In an alternative arrangement, the tension airfoil turbine assembly 400 can be utilized in a vertical orientation for converting wind to electrical power, wherein the tension airfoil turbine assembly 400 would replace the turbine wheel assembly 100, the crossover spoke turbine wheel assembly 300, the turbine blade subassembly 714, the turbine blade subassembly 1114, or any other similar application. In an application where the turbine airfoil assembly 100, 300, 400, 714, 1114 is used for electrical power generation, the tension airfoil turbine assembly 400 would be vertically oriented, rotating about a generally horizontal axis of rotation.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A fluid flow power system for generating electrical power, comprising:
a rotating turbine blade assembly comprising an outer rim, a tension airfoil central hub assembly, tension elements extending between the outer rim and the tension airfoil central hub assembly, and a plurality of turbine blades secured to the tension elements;
a rotating turbine blade assembly support structure, the rotating turbine blade assembly arranged to rotationally support the rotating turbine blade assembly enabling rotation of the rotating turbine blade assembly;
an electric power generator; and
an electric generator turbine rim engagement wheel,
wherein the rotating turbine blade assembly is arranged to be rotationally driven by at least one of wind and water during operation,
wherein the electric generator turbine rim engagement wheel is arranged to be rotationally driven by the outer rim of the rotating turbine blade assembly during operation,
wherein the electric generator turbine rim engagement wheel is arranged to rotationally drive the electric power generator during operation.

2. The fluid flow power system for generating electrical power as recited in claim 1, wherein the electric generator turbine rim engagement wheel is oriented to rotate about an axis that is parallel to a rotational axis of the rotating turbine blade assembly.

3. The fluid flow power system for generating electrical power as recited in claim 1, wherein the electric generator turbine rim engagement wheel additionally provides at least one of axial support and radial support to the rotating turbine blade assembly.

4. The fluid flow power system for generating electrical power as recited in claim 1, wherein the electric generator turbine rim engagement wheel is oriented to rotate about an axis that is non-parallel to a rotational axis of the rotating turbine blade assembly.

5. The fluid flow power system for generating electrical power as recited in claim 1, wherein the electric generator turbine rim engagement wheel is oriented to rotate about an axis that is substantially 90 degrees to a rotational axis of the rotating turbine blade assembly.

6. The fluid flow power system for generating electrical power as recited in claim 1, wherein the electric generator turbine rim engagement wheel is located to engage with a first position on an outer rim assembly of the rotating turbine blade assembly, the fluid flow power system further comprising a second rim engagement wheel located to engage with a second position on the outer rim assembly of the rotating turbine blade assembly, the outer rim assembly including the outer rim.

7. The fluid flow power system for generating electrical power as recited in claim 1, wherein the electric generator turbine rim engagement wheel is located to engage with a first position on an outer rim assembly of the rotating turbine blade assembly, the fluid flow power system further comprising a second rim engagement wheel located to engage with a second position on the outer rim assembly of the rotating turbine blade assembly, the outer rim assembly including the outer rim,
wherein the electric generator turbine rim engagement wheel and the second rim engagement wheel are arranged to maintain at least one of axial stability and radial stability of the rotating turbine blade assembly.

8. The fluid flow power system for generating electrical power as recited in claim 1, wherein the electric generator turbine rim engagement wheel is located to engage with a first position on an outer rim assembly of the rotating turbine blade assembly, the fluid flow power system further comprising a second rim engagement wheel located to engage with a second position on the outer rim assembly of the rotating turbine blade assembly, the outer rim assembly including the outer rim; and
a wheel compression adjusting system designed to adjust a compression applied to the outer rim assembly by each of the electric generator turbine rim engagement wheel and the second rim engagement wheel.

9. The fluid flow power system for generating electrical power as recited in claim 1, further comprising a power transfer annular ring carried by the outer rim, wherein the electric generator turbine rim engagement wheel is rotationally driven by engagement with the power transfer annular ring.

10. The fluid flow power system for generating electrical power as recited in claim 1, wherein the electric generator turbine rim engagement wheel engages one of directly or indirectly with the electric power generator.

11. A fluid flow power system for generating electrical power, comprising:
a rotating turbine blade assembly comprising an outer rim, a tension airfoil central hub assembly, tension elements extending between the outer rim and the tension airfoil central hub assembly, and a plurality of turbine blades secured to the tension elements;
a rotating turbine blade assembly support structure, the rotating turbine blade assembly arranged to rotationally support the rotating turbine blade assembly enabling rotation of the rotating turbine blade assembly;
an electric power generator; and
an electric generator turbine rim engagement wheel,
wherein the rotating turbine blade assembly is arranged to be rotationally driven by at least one of wind and water during operation,
wherein the electric generator turbine rim engagement wheel is arranged to be rotationally driven by the outer rim of the rotating turbine blade assembly during operation,
wherein the electric generator turbine rim engagement wheel is arranged to rotationally drive the electric power generator during operation,
wherein the electric generator turbine rim engagement wheel is arranged to provide support to the rotating turbine blade assembly in at least one of an axial direction and a radial direction.

12. The fluid flow power system for generating electrical power as recited in claim 11, wherein the electric generator turbine rim engagement wheel is oriented to rotate about an axis that is parallel to a rotational axis of the rotating turbine blade assembly.

13. The fluid flow power system for generating electrical power as recited in claim 11, wherein the rotating turbine blade assembly support structure enables rotation of each of the rotating turbine blade assembly and the electric generator turbine rim engagement wheel about a generally vertical axis to reposition the rotating turbine blade assembly respective to a direction of the wind.

14. The fluid flow power system for generating electrical power as recited in claim 11, wherein the electric generator turbine rim engagement wheel is oriented to rotate about an axis that is non-parallel to a rotational axis of the rotating turbine blade assembly.

15. The fluid flow power system for generating electrical power as recited in claim 11, wherein the electric generator turbine rim engagement wheel is oriented to rotate about an axis that is substantially 90 degrees to a rotational axis of the rotating turbine blade assembly.

16. The fluid flow power system for generating electrical power as recited in claim 11, wherein the electric generator turbine rim engagement wheel is located to engage with a first position on an outer rim assembly of the rotating turbine blade assembly, the fluid flow power system further comprising a second rim engagement wheel located to engage with a second position on the outer rim assembly of the rotating turbine blade assembly, the outer rim assembly including the outer rim.

17. The fluid flow power system for generating electrical power as recited in claim 11, wherein the electric generator turbine rim engagement wheel is located to engage with a first position on an outer rim assembly of the rotating turbine blade assembly, the fluid flow power system further comprising a second rim engagement wheel located to engage with a second position on the outer rim assembly of the rotating turbine blade assembly, the outer rim assembly including the outer rim,
wherein the electric generator turbine rim engagement wheel and the second rim engagement wheel are arranged to provide support to the rotating turbine blade assembly in at least one of an axial direction and a radial direction.

18. The fluid flow power system for generating electrical power as recited in claim 11, wherein the electric generator turbine rim engagement wheel is located to engage with a first position on an outer rim assembly of the rotating turbine blade assembly, the fluid flow power system further comprising a second rim engagement wheel located to engage with a second position on the outer rim assembly of the rotating turbine blade assembly, the outer rim assembly including the outer rim; and
a wheel compression adjusting system designed to adjust a compression applied to the outer rim assembly by each of the electric generator turbine rim engagement wheel and the second rim engagement wheel.

19. The fluid flow power system for generating electrical power as recited in claim 11, further comprising a power transfer annular ring carried by the outer rim, wherein the electric generator turbine rim engagement wheel is rotationally driven by engagement with the power transfer annular ring.

20. The fluid flow power system for generating electrical power as recited in claim 11, wherein the electric generator turbine rim engagement wheel engages one of directly or indirectly with the electric power generator.
